(19) United States
(12) Patent Application Publication
(10) Pub. No.: US 2022/0291078 A1
(43) Pub. Date: Sep. 15, 2022

(54) Measurement Method, Measurement Device, Measurement System, And Measurement Program

(71) Applicant: Seiko Epson Corporation, Tokyo (JP)

(72) Inventor: Yoshihiro KOBAYASHI, Komagane (JP)

(21) Appl. No.: 17/680,476

(22) Filed: Feb. 25, 2022

(30) Foreign Application Priority Data
Feb. 26, 2021 (JP) 2021-029750

(51) Int. Cl. G01M 5/00; G01D 21/02

(52) U.S. Cl. CPC G01M 5/0008; G01D 21/02; G01M 5/0041; G01M 5/0066

(57) ABSTRACT

A measurement method includes: a high-pass filter processing step of performing high-pass filter processing on observation data-based velocity data including a drift noise to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the velocity data; and a measurement data generation step of generating measurement data by adding the displacement data and the correction data.

The present application is based on, and claims priority from JP Application Serial Number 2021-029750, filed Feb. 26, 2021, the disclosure of which is hereby incorporated by reference herein in its entirety.

### BACKGROUND

### 1. Technical Field

The present disclosure relates to a measurement method, a measurement device, a measurement system, and a measurement program.

### 2. Related Art

JP-A-2009-237805 describes a displacement acquisition device including: a static component storage unit that stores a time series of a static component that is a component independent of motion of a railway vehicle in a time series of a displacement of a girder of a bridge accompanying passage of the railway vehicle; a displacement detection unit that detects a time series of a displacement of a girder of a bridge to be measured based on at least one of an acceleration measurement value and a velocity measurement value of the girder of the bridge to be measured accompanying passage of a railway vehicle to be measured; a dynamic component extraction unit that extracts a time series of a dynamic component that is a remaining component obtained by removing a static component that may include an error from the time series of the displacement detected by the displacement detection unit; a static component acquisition unit that acquires the time series of the static component from the static component storage unit; and a synthesis unit that synthesizes the time series of the dynamic component extracted by the dynamic component extraction unit and the time series of the static component acquired by the static component acquisition unit.

According to the displacement acquisition device described in JP-A-2009-237805, by removing the static component that may include an error from the time series of the displacement of the detected girder and replacing the static component with the stored static component, the time series of the displacement eliminating the error can be obtained.

However, in the displacement acquisition device described in JP-A-2009-237805, since approximability between the static component included in the time series of displacement of the detected girder and the stored static component greatly affects accuracy of the obtained time series of the displacement, when accuracy of the approximability is not sufficient, the accuracy of the time series of the displacement may decrease. In the displacement acquisition device described in JP-A-2009-237805, when a static component included in a time series of a displacement at a measurement time point changes due to a change in environment or the like, no unit is provided for recognizing a deviation between the static component and the stored static component, and it is not possible to know that there is a problem in the accuracy of the displacement. In the displacement acquisition device described in JP-A-2009-237805, it is necessary to store data of the static component for each classification of the railway vehicle and each classification of the bridge, and it is necessary to acquire and update the data, which complicates a configuration and makes it difficult to reduce a cost. Therefore, a method of reducing an error without preparing information for reducing an error such as static component data in advance is desired.

### SUMMARY

According to an aspect of the present disclosure, a measurement method includes: a high-pass filter processing step of performing high-pass filter processing on observation data-based velocity data including a drift noise to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the velocity data; and a measurement data generation step of generating measurement data by adding the displacement data and the correction data.

According to another aspect of the present disclosure, a measurement method includes: a low-pass filter processing step of performing low-pass filter processing on observation data-based velocity data including a drift noise and a vibration component to generate vibration component reduction data in which the vibration component is reduced; a high-pass filter processing step of performing high-pass filter processing on the vibration component reduction data to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the vibration component reduction data; a vibration velocity component data generation step of generating vibration velocity component data by subtracting the vibration component reduction data from the velocity data; a vibration displacement component data generation step of generating vibration displacement component data by integrating the vibration velocity component data; and a measurement data generation step of generating measurement data by adding the displacement data, the correction data, and the vibration displacement component data.

According to an aspect of the present disclosure, a measurement device includes: a high-pass filter processing unit configured to perform high-pass filter processing on observation data-based velocity data including a drift noise to generate drift noise reduction data in which the drift noise is reduced; a displacement data generation unit configured to generate displacement data by integrating the drift noise reduction data; a correction data estimation unit configured to estimate, based on the displacement data, correction data corresponding to a difference between the displacement data and data obtained by removing the drift noise from data obtained by integrating the velocity data; and a measurement data generation unit configured to generate measurement data by adding the displacement data and the correction data.

According to an aspect of the present disclosure, a measurement system includes: the measurement device according to the above aspect; and an observation device configured to observe an observation point, in which the observation data is data observed by the observation device.

According to an aspect of the present disclosure, a non-transitory computer-readable storage medium stores a measurement program, and the measurement program causes a computer to execute: a high-pass filter processing step of performing high-pass filter processing on observation data-based velocity data including a drift noise to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the velocity data; and a measurement data generation step of generating measurement data by adding the displacement data and the correction data.

### BRIEF DESCRIPTION OF THE DRAWINGS

FIG. 1 is a diagram showing a configuration example of a measurement system.

FIG. 2 is a cross-sectional view of a superstructure of FIG. 1 taken along line A-A.

FIG. 3 is a diagram illustrating an acceleration detected by an acceleration sensor.

FIG. 4 is a diagram showing a frequency characteristic F{Mₛ(k)} of displacement data Mₛ(k).

FIG. 5 is a diagram showing a relationship of frequency characteristics F{Mₛ(k)}, F{f_{HP}(Mₛ(k))}, and F{f_{LP}(Mₛ(k))}.

FIG. 6 is a diagram showing a relationship of frequency characteristics F{Mₛ(k)}, F{M(k)}, and F{e(k)}.

FIG. 7 is a diagram showing a relationship of frequency characteristics F{M′(k)}, F{f_{HP}(M(k))}, and F{f_{LP}(M(k))}.

FIG. 8 is a diagram showing displacement data Mₛ(k) which is a unit pulse waveform.

FIG. 9 is a diagram showing data f_{LP}(Mₛ(k)) obtained by performing low-pass filter processing on the displacement data Mₛ(k).

FIG. 10 is a diagram showing data f_{HP}(Mₛ(k)) obtained by performing high-pass filter processing on the displacement data Mₛ(k).

FIG. 11 is a diagram showing an example of acceleration data Aₘ(k).

FIG. 12 is a diagram showing an example of displacement data Uₘ(k).

FIG. 13 is a diagram showing an example of velocity data MV(k).

FIG. 14 is a diagram showing a power spectrum density of the velocity data MV(k).

FIG. 15 is a diagram showing an example of displacement data MU(k).

FIG. 16 is a diagram showing an example of first interval correction data M_{CC1}(k) and fifth interval correction data M_{CC5}(k).

FIG. 17 is a diagram showing an example of first line data L1(k) and second line data L2(k).

FIG. 18 is a diagram showing an example of second interval correction data M_{CC2}(k) and fourth interval correction data M_{CC4}(k).

FIG. 19 is a diagram showing an example of third line data L3(k).

FIG. 20 is a diagram showing a relationship of the first line data L1(k), the second line data L2(k), the third line data L3(k), a first intersection point p₉ and a second intersection point p₁₀.

FIG. 21 is a diagram showing an example of correction data M_{CC}(k).

FIG. 22 is a diagram showing an example of measurement data RU(k).

FIG. 23 is a diagram showing an example of a displacement waveform UO(k) and a drift noise D(k).

FIG. 24 is a diagram showing an example of an evaluation waveform U(k).

FIG. 25 is a diagram showing the measurement data RU(k).

FIG. 26 is a diagram showing the measurement data RU(k) and the displacement waveform UO(k) in an overlapping manner.

FIG. 27 is a flowchart showing an example of a procedure of a measurement method according to a first embodiment.

FIG. 28 is a flowchart showing an example of a procedure of a correction data estimation step in the first embodiment.

FIG. 29 is a flowchart showing an example of a procedure of a third interval correction data generation step in the first embodiment.

FIG. 30 is a diagram showing a configuration example of a sensor, a measurement device, and a monitoring device according to the first embodiment.

FIG. 31 is a diagram showing a relationship of frequency characteristics F{M_{d}(k)}, F{M(k)}, and F{e(k)}.

FIG. 32 is a diagram showing a relationship of frequency characteristics F{Mₛ(k)}, F{M(k)}, and F{e(k)}.

FIG. 33 is a diagram showing a frequency characteristic F{MV(k)}.

FIG. 34 is a diagram showing a relationship of frequency characteristics F{Mₛ(k)}, F{f_{HP}(Mₛ(k))}, and F{f_{LP}(Mₛ(k))}.

FIG. 35 is a diagram showing a relationship of frequency characteristics F{Mₛ′(k)}, F{f_{HP}(Mₛ(k))}, and F{A_{LP}(f_{HP}(Mₛ(k)))}.

FIG. 36 is a diagram showing a relationship of frequency characteristics F{M_{d}′(k)}, F{Mₛ′(k)}, and F{M_{V}(k)}. FIG. 37 is a diagram showing an example of velocity data MVₛ(k).

FIG. 37 is a diagram showing an example of velocity data MVₛ(k).

FIG. 38 is a diagram showing an example of vibration velocity component data M_{OSC}(k).

FIG. 39 is a diagram showing an example of vibration displacement component data U_{OSC}(k).

FIG. 40 is a diagram showing an example of the displacement data MU(k).

FIG. 41 is a diagram showing an example of the first interval correction data M_{CC1}(k).

FIG. 42 is a diagram showing an example of the fifth interval correction data M_{CC5}(k).

FIG. 43 is a diagram showing a relationship between data −MVH(k) and a first-order coefficient s₁.

FIG. 44 is a diagram showing an example of the second interval correction data M_{CC2}(k).

FIG. 45 is a diagram showing a relationship between the data −MVH(k) and a first-order coefficient s₂.

FIG. 46 is a diagram showing an example of the fourth interval correction data M_{CC4}(k).

FIG. 47 is a diagram showing an example of the third line data L3(k).

FIG. 48 is a diagram showing an example of third interval correction data M_{CC3}(k).

FIG. 49 is a diagram showing an example of the correction data M_{CC}(k).

FIG. 50 is a diagram showing an example of the displacement data RU(k).

FIG. 51 is a diagram showing an example of the displacement data RU(k) and the vibration displacement component data U_{OSC}(k).

FIG. 52 is a diagram showing an example of measurement data U′(k).

FIG. 53 is a diagram showing the measurement data U′(k).

FIG. 54 is a diagram showing the measurement data U′(k) and the displacement waveform UO(k) in an overlapping manner.

FIG. 55 is a flowchart showing an example of a procedure of a measurement method according to a second embodiment.

FIG. 56 is a flowchart showing an example of a procedure of a correction data estimation step in the second embodiment.

FIG. 57 is a flowchart showing an example of a procedure of a third interval correction data generation step in the second embodiment.

FIG. 58 is a diagram showing a configuration example of a sensor, a measurement device, and a monitoring device according to a second embodiment.

FIG. 59 shows another configuration example of the measurement system.

FIG. 60 shows another configuration example of the measurement system.

FIG. 61 shows another configuration example of the measurement system.

FIG. 62 is a cross-sectional view of a superstructure of FIG. 61 taken along line A-A.

### DESCRIPTION OF EXEMPLARY EMBODIMENTS

Hereinafter, preferred embodiments of the present disclosure will be described in detail with reference to the drawings. The embodiments to be described below do not in any way limit contents of the present disclosure described in claims. Not all configurations to be described below are necessarily essential components of the present disclosure.

### 1. First Embodiment

### 1-1. Configuration of Measurement System

Hereinafter, a measurement system for implementing a measurement method according to the present embodiment will be described by taking a case where a structure is a superstructure of a bridge and a moving object is a railway vehicle as an example.

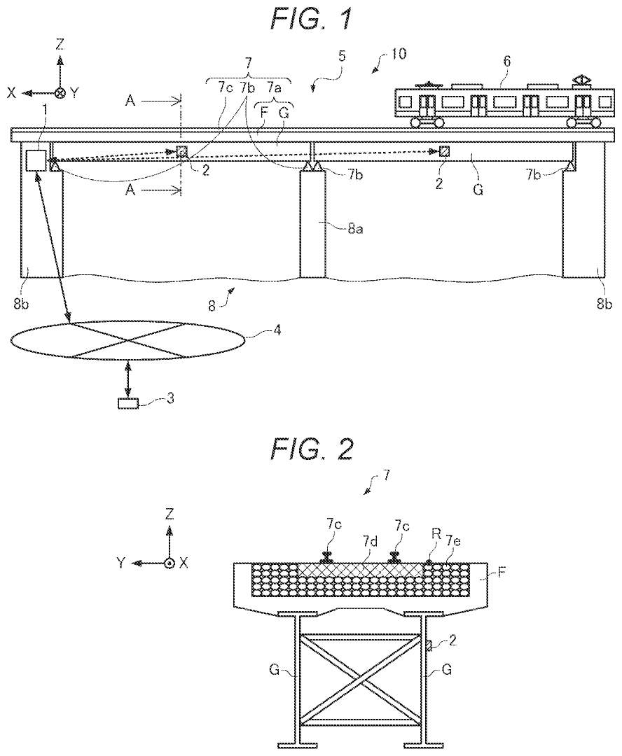

FIG. 1 is a diagram showing an example of a measurement system according to the present embodiment. As shown in FIG. 1, a measurement system 10 according to the present embodiment includes a measurement device 1, and at least one sensor 2 provided on a superstructure 7 of a bridge 5. The measurement system 10 may include a monitoring device 3.

The bridge 5 includes the superstructure 7 and a substructure 8. FIG. 2 is a cross-sectional view of the superstructure 7 taken along line A-A of FIG. 1. As shown in FIGS. 1 and 2, the superstructure 7 includes a bridge floor 7a, a support 7b, rails 7c, ties 7d, and a ballast 7e, and the bridge floor 7a includes a floor plate F, a main girder G, a cross girder which is not shown. As shown in FIG. 1, the substructure 8 includes bridge piers 8a and bridge abutments 8b. The superstructure 7 is a structure across any one of the bridge abutment 8b and the bridge pier 8a adjacent to each other, two adjacent bridge abutments 8b, and two adjacent bridge piers 8a. Both end portions of the superstructure 7 are located at positions of the bridge abutment 8b and the bridge pier 8a adjacent to each other, at positions of the two adjacent bridge abutments 8b, or at positions of the two adjacent bridge piers 8a.

The measurement device 1 and the sensors 2 are coupled by, for example, a cable which is not shown and communicate with one another via a communication network such as a CAN. CAN is an abbreviation for controller area network. Alternatively, the measurement device 1 and the sensors 2 may communicate with each other via a wireless network.

For example, each sensor 2 outputs data for calculating a displacement of the superstructure 7 caused by a movement of a railway vehicle 6 which is a moving object. In the present embodiment, each of the sensors 2 is an acceleration sensor, and may be, for example, a crystal acceleration sensor or an MEMS acceleration sensor. MEMS is an abbreviation for micro electro mechanical systems.

In the present embodiment, each sensor 2 is installed at position of a central portion of the superstructure 7 in a longitudinal direction, specifically, at a central portion of the main girder G in the longitudinal direction. Each sensor 2 is not limited to being installed at the central portion of the superstructure 7 as long as each sensor 2 can detect an acceleration for calculating the displacement of the superstructure 7. When each sensor 2 is provided on the floor plate F of the superstructure 7, the sensor 2 may be damaged due to traveling of the railway vehicle 6, and the measurement accuracy may be affected by local deformation of the bridge floor 7a, so that in the example of FIGS. 1 and 2, each sensor 2 is provided at the main girder G of the superstructure 7.

The floor plate F, the main girder G, and the like of the superstructure 7 are bent in a vertical direction due to a load of the railway vehicle 6 traveling on the superstructure 7. Each sensor 2 detects an acceleration of the bending of the floor plate F or the main girder G caused by the load of the railway vehicle 6 traveling on the superstructure 7.

The measurement device 1 calculates the bending displacement of the superstructure 7 caused by the traveling of the railway vehicle 6 based on acceleration data output from the sensors 2. The measurement device 1 is installed on, for example, the bridge abutment 8b.

The measurement device 1 and the monitoring device 3 can communicate with each other via, for example, a wireless network of a mobile phone and a communication network 4 such as the Internet. The measurement device 1 transmits information on the displacement of the superstructure 7 caused by the traveling of the railway vehicle 6 to the monitoring device 3. The monitoring device 3 may store the information in a storage device (not illustrated), and may perform, for example, processing such as monitoring of the railway vehicle 6 and abnormality determination of the superstructure 7 based on the information.

In the present embodiment, the bridge 5 is a railroad bridge, and is, for example, a steel bridge, a girder bridge, or an RC bridge. The RC is an abbreviation for reinforced-concrete.

As shown in FIG. 2, in the present embodiment, an observation point R is set in association with the sensor 2. In the example of FIG. 2, the observation point R is set at a position on a surface of the superstructure 7 located vertically above the sensor 2 provided at the main girder G. That is, the sensor 2 is an observation device for observing the observation point R. Although the sensor 2 for observing the observation point R may be provided at a position where the acceleration generated at the observation point R due to the traveling of the railway vehicle 6 can be detected, it is desirable that the sensor 23 is provided at a position close to the observation point R.

The number and installation positions of the sensors 2 are not limited to the examples shown in FIGS. 1 and 2, and various modifications can be made.

The measurement device 1 acquires an acceleration in a direction intersecting the surface of the superstructure 7 on which the railway vehicle 6 moves, based on the acceleration data output from the sensor 2. The surface of the superstructure 7 on which the railway vehicle 6 moves is defined by a direction in which the railway vehicle 6 moves, that is, an X direction which is the longitudinal direction of the superstructure 7, and a direction orthogonal to the direction in which the railway vehicle 6 moves, that is, a Y direction which is a width direction of the superstructure 7. Since the observation point R is bent in a direction orthogonal to the X direction and the Y direction due to the traveling of the railway vehicle 6, it is desirable that the measurement device 1 acquires the acceleration in a direction orthogonal to the X direction and the Y direction, that is, a Z direction which is a normal direction of the floor plate F, in order to accurately calculate a magnitude of the acceleration of the bending.

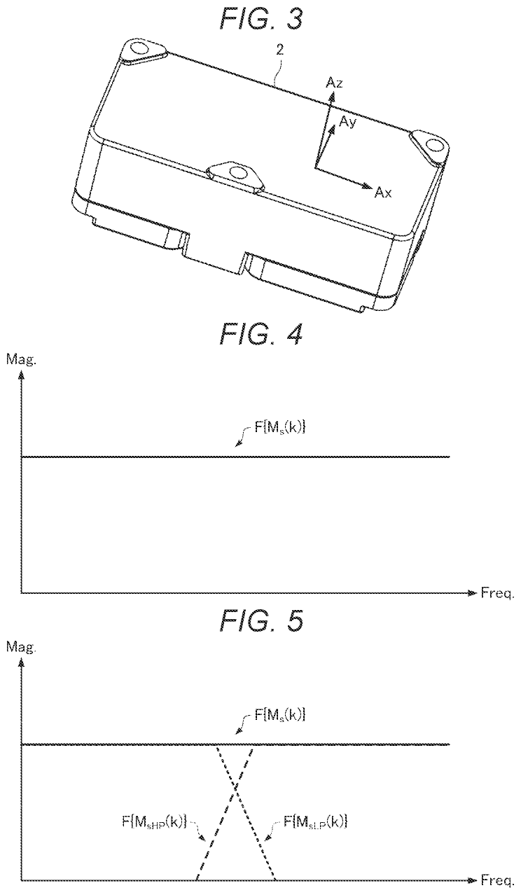

FIG. 3 is a diagram showing the acceleration detected by the sensor 2. The sensor 2 is an acceleration sensor that detects accelerations generated in three axes orthogonal to one another.

In order to detect the acceleration of the bending at the observation point R caused by the traveling of the railway vehicle 6, the sensor 2 is installed such that one of three detection axes, which are the x axis, the y axis, and the z axis, intersects the X direction and the Y direction. In FIGS. 1 and 2, the sensor 2 is installed such that one axis thereof is in a direction intersecting the X direction and the Y direction. The observation point R bends in the direction orthogonal to the X direction and the Y direction. Therefore, in order to accurately detect the acceleration of the bending, ideally, the sensor 2 is installed such that one axis thereof is in the direction orthogonal to the X direction and the Y direction, that is, the normal direction of the floor plate F.

However, when the sensor 2 is installed on the superstructure 7, an installation location may be inclined. In the measurement device 1, even if one of the three detection axes of the sensor 2 is not installed in the normal direction of the floor plate F, since the direction is substantially oriented in the normal direction, an error is small and thus can be ignored. The measurement device 1 can correct a detection error, caused by the inclination of the sensor 2, by a three-axis combined acceleration that is obtained by combining the accelerations in the x axis, the y axis, and the z axis even if one of the three detection axes of the sensor 2 is not installed in the normal direction of the floor plate F. The sensor 2 may be a one-axis acceleration sensor that detects an acceleration generated in a direction at least substantially parallel to the vertical direction or an acceleration in the normal direction of the floor plate F.

Hereinafter, first, basic concept of the measurement method according to the present embodiment executed by the measurement device 1 will be described, and then the details thereof will be described.

### 1-2. Basic Concept of Measurement Method

First, displacement data obtained based on the acceleration data output from the sensor 2 is represented by Mₛ(k), and FIG. 4 is a diagram showing a frequency characteristic F{Mₛ(k)} of the displacement data Mₛ(k). When the number of samples included in the displacement data Mₛ(k) is N, k is an integer from 0 to N−1.

When data obtained by performing high-pass filter processing on the displacement data Mₛ(k) is represented by f_{HP}(Mₛ(k)) and data obtained by performing low-pass filter processing on the displacement data Mₛ(k) is represented by f_{LP}(Mₛ(k)), a relationship of the displacement data Mₛ(k), the data f_{HP}(Mₛ(k)), and the data f_{LP}(Mₛ(k)) is expressed by Equation (1).

Mₛ(k)=f_{HP}(Mₛ(k))f_{LP}(Mₛ(k)) (1)

A relationship of the frequency characteristic F{Mₛ(k)} of the displacement data Mₛ(k), a frequency characteristic F{f_{HP}(Mₛ(k))} of the data f_{HP}(Mₛ(k)), and a frequency characteristic F{f_{LP}(Mₛ(k))} of the data f_{LP}(Mₛ(k)) is expressed by Equation (2). FIG. 5 is a diagram showing a relationship of the frequency characteristics F{Mₛ(k)}, F{f_{HP}(Mₛ(k))}, and F{f_{LP}(Mₛ(k))}.

F{Mₛ(k)}=F{f_{HP}(Mₛ(k))}+F{f_{LP}(Mₛ(k))} (2)

Here, as in Equation (3), it is assumed that the displacement data Mₛ(k) obtained based on the acceleration data includes a significant signal M(k) and a drift noise e(k).

Mₛ(k)=M(k)+e(k) (3)

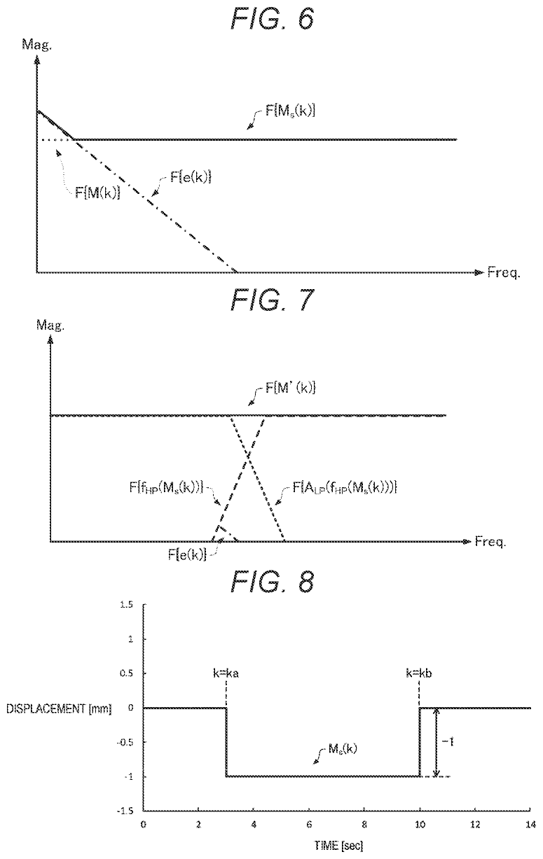

The drift noise e(k) is mainly not a signal input to the sensor 2, but an error signal generated inside the sensor 2, such as a zero-point error, a drift caused by a temperature change, or a drift caused by nonlinear sensitivity. The drift noise e(k) is a variation of a long period as compared with a signal input to the sensor 2, and has an energy distribution in a low frequency range. FIG. 6 is a diagram showing a relationship of frequency characteristics F{Mₛ(k)}, F{M(k)}, and F{e(k)}. Since the drift noise e(k) is observed as an offset error, high-pass filter processing for attenuating a signal in a low frequency range is effective in order to remove the drift noise e(k).

It is assumed that, when the high-pass filter processing is performed on the displacement data Mₛ(k), the drift noise e(k) that has an energy distribution in the low frequency range is sufficiently reduced, and the data f_{HP}(Mₛ(k)) obtained after the high-pass filter processing is substantially equal to data f_{HP}(M(k)) obtained by performing high-pass filter processing on the signal M(k), as in Equation (4).

f_{HP}(Mₛ(k))≈f_{HP}(M(k)) (4)

Since a signal component of the signal M(k) in the low frequency range is also lost due to the high-pass filter processing, in order to compensate for this signal component, the data f_{LP}(M(k)) obtained by performing low-pass filter processing on the signal M(k) is estimated based on the data f_{HP}(Mₛ(k)) obtained by performing high-pass filter processing on the displacement data Mₛ(k). As in Equation (5), it is assumed that the data f_{LP}(M(k)) obtained by performing low-pass filter processing on the signal M(k) is substantially equal to data A_{LP}(f_{HP}(Mₛ(k))) obtained by estimating the data f_{LP}(M(k)), which is obtained by performing low-pass filter processing on the signal M(k), based on the data f_{HP}(Mₛ(k)) obtained by performing high-pass filter processing on the displacement data Mₛ(k).

f_{LP}(M(k))≈A_{LP}(f_{HP}(Mₛ(k))) (5)

When it is assumed that the signal M(k) is equal to a sum of the data f_{HP}(M(k)) obtained by performing high-pass filter processing on the signal M(k) and the data f_{LP}(M(k)) obtained by performing low-pass filter processing on the signal M(k), as in Equation (6), Equation (7) is obtained based on Equation (4), Equation (5), and Equation (6). FIG. 7 shows the relationship of frequency characteristics F {M′(k)}, F{f_{HP}(Mₛ(k))}, and F{A_{LP}(f_{HP}(Mₛ(k)))}.

M(k)=f_{HP}(M(k))+f_{LP}(M(k)) (6)

M(k)≈M′(k)=f_{HP}(Mₛ(k))+A_{LP}(f_{HP}(Mₛ(k))) (7)

Since the data f_{HP}(Mₛ(k)) in which the drift noise e(k) is reduced is obtained by performing high-pass filter processing on the displacement data Mₛ(k), the data f_{LP}(M(k)) obtained by performing low-pass filter processing on the signal M(k) is estimated based on the data f_{HP}(Mₛ(k)), and the signal M(k) in which the drift noise e(k) is reduced can be obtained by adding the data f_{HP}(Mₛ(k)) and the estimated data.

Hereinafter, a procedure of estimating the data f_{LP}(M(k)), that is obtained by performing low-pass filter processing on the signal M(k), based on the data f_{HP}(Mₛ(k)) obtained by performing high-pass filter processing on the displacement data Mₛ(k) will be described.

First, a unit pulse waveform obtained by simplifying a deflection displacement of the superstructure 7 of the bridge 5 when the railway vehicle 6 passes through the superstructure 7 is assumed as the displacement data Mₛ(k), as in Equation (8). In Equation (8), k is an integer of 0 or more. FIG. 8 shows the displacement data Mₛ(k), which is a unit pulse waveform expressed by Equation (8).

$${M}_{s} ( k ) = \{ \begin{matrix}0 & k < {k}_{a} , {k}_{b} < k \\ - 1 & {k}_{a} \leq k \leq {k}_{b}\end{matrix} \qquad ( 8 )$$

It is assumed that the relationship of the displacement data Mₛ(k), the data f_{HP}(Mₛ(k)) obtained by performing high-pass filter processing on the displacement data Mₛ(k), and the data f_{LP}(Mₛ(k)) obtained by performing low-pass filter processing on the displacement data Mₛ(k) is as shown in the above Equation (1). For example, when the low-pass filter processing is moving average processing, Equation (9) is obtained based on Equation (1). At this time, data k is located at a center of a moving average interval 2p+1.

$${f}_{H P} ( {M}_{s} ( k ) ) = {M}_{s} ( k ) - {f}_{L P} ( {M}_{s} ( k ) ) = {M}_{s} ( k ) - \frac{1}{2 p + 1} {\sum }_{n = k - p}^{n = k + p} {M}_{s} ( n ) \qquad ( 9 )$$

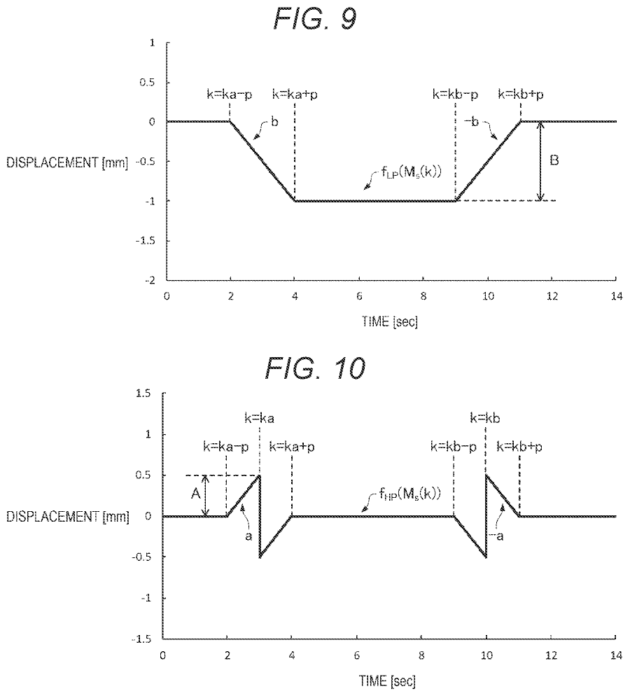

In Equation (9), p is an integer of 1 or more, and since it is desired to provide a flat portion in the data f_{LP}(Mₛ(k)) obtained by performing low-pass filter processing on the displacement data Mₛ(k), p<(kₐ−k_{b})/2 is satisfied. FIG. 9 shows the data f_{LP}(Mₛ(k)) obtained by performing low-pass filter processing, which is moving average processing, on the displacement data Mₛ(k) which is a unit pulse waveform represented by Equation (8). FIG. 10 shows the data f_{HP}(Mₛ(k)) obtained by performing high-pass filter processing on the displacement data Mₛ(k) which is a unit pulse waveform represented by Equation (8).

With reference to FIGS. 9 and 10, the data f_{HP}(Mₛ(k)) obtained by performing high-pass filter processing on the displacement data Mₛ(k) which is a unit pulse waveform is compared with the data f_{LP}(Mₛ(k)) obtained by performing low-pass filter processing on the displacement data Mₛ(k).

As shown in FIG. 9, a slope b of an interval from kₐ−p to kₐ+p of the data f_{LP}(Mₛ(k)) obtained by performing low-pass filter processing on the displacement data Mₛ(k) is calculated by Equation (10).

$$b = {f}_{L P} ( {M}_{s} ( {k}_{a} + 1 ) ) - {f}_{L P} ( {M}_{s} ( {k}_{a} ) ) = \frac{1}{2 p + 1} {\sum }_{n = {k}_{a} + 1 - p}^{n = {k}_{a} + 1 + p} {M}_{s} ( n ) - \frac{1}{2 p + 1} {\sum }_{n = {k}_{a} - p}^{n = {k}_{a} + p} {M}_{s} ( n ) = \frac{- 1}{2 p + 1} \qquad ( 10 )$$

A slope of an interval from k_{b}−p to k_{b}+p of the data f_{LP}(Mₛ(k)) is −b, and an amplitude B of an interval from kₐ+p to k_{b}−p is −1.

On the other hand, as shown in FIG. 10, a slope a of an interval from kₐ−p to kₐ of the data F_{HP}(Mₛ(k)) obtained by performing high-pass filter processing on the displacement data Mₛ(k) is calculated by Equation (11).

$$a = {f}_{H P} ( {M}_{s} ( k ) ) = {M}_{s} ( k ) - {f}_{L ρ} ( {M}_{s} ( k ) ) = \frac{1}{2 p + 1} \qquad ( 11 )$$

A slope of an interval from k_{b} to k_{b}+p of the data f_{HP}(Mₛ(k)) is −a, and an amplitude A of k=kₐ−1 is calculated by Equation (12).

$$A = {f}_{H P} ( {M}_{s} ( {k}_{a} - 1 ) ) = {M}_{s} ( {k}_{a} - 1 ) - {f}_{L P} ( {M}_{s} ( {k}_{a} - 1 ) ) = {M}_{s} ( {k}_{a} - 1 ) - \frac{1}{2 p + 1} {\sum }_{n = {k}_{a} - 1 - p}^{n = {k}_{a} - 1 + p} {M}_{s} ( n ) \qquad ( 12 )$$

By substituting Equation (8) into Equation (12), the amplitude A is calculated as in Equation (13).

$$A = 0 - \frac{1}{2 p + 1} ( {\sum }_{n = {k}_{a} - 1 - p}^{n} {M}_{s} ( n ) + {\sum }_{n = {k}_{a}}^{n = {k}_{a} - 1 + p} {M}_{s} ( n ) ) = - \frac{1}{2 p + 1} ( 0 + ( p ) ( - 1 ) ) = \frac{p}{2 p + 1} \qquad ( 13 )$$

According to Equation (13), when p is sufficiently large, the amplitude A is ½.

Here, the unit pulse waveform represented by Equation (8) and assumed as the displacement data Mₛ(k) does not include the drift noise e(k). Therefore, the data f_{LP}(Mₛ(k)) obtained by performing low-pass filter processing on the displacement data Mₛ(k) is equal to the data f_{LP}(M(k)) obtained by performing low-pass filter processing on the signal M(k), according to Equation (3). Therefore, a comparison between the data f_{HP}(Mₛ(k)) and the data f_{LP}(Mₛ(k)) is a comparison between the data f_{HP}(Mₛ(k)) and the data f_{LP}(M(k)), and by measuring the slope a and the amplitude A of the data f_{HP}(Mₛ(k)), the data f_{LP}(M(k)) obtained by performing low-pass filter processing on the signal M(k) in which the drift noise e(k) is removed can be estimated based on the displacement data Mₛ(k).

### 1-3. Details of Measurement Method

Actually, the displacement data of the deflection when the railway vehicle 6 passes through the superstructure 7 of the bridge 5 includes data of a waveform that projects in a positive direction or a negative direction and is different from the unit pulse waveform, but the data f_{LP}(M(k)) obtained by performing low-pass filter processing on the signal M(k) can be estimated based on the estimation method described above. For example, the waveform that projects in the positive direction or the negative direction is a rectangular waveform, a trapezoidal waveform, or a sine half-wave waveform.

First, the measurement device 1 generates velocity data MV(k) based on observation data observed by the observation device. In the present embodiment, the sensor 2, which is an acceleration sensor, is the observation device, and the observation data is acceleration data Aₘ(k) output from the sensor 2. In this case, the measurement device 1 integrates the acceleration data Aₘ(k), which is the observation data, to generate the velocity data MV(k), as in Equation (14).

MV(k)=Aₘ(k)ΔT+MV(k−1) (14)

However, the observation device may be a device other than the acceleration sensor, and may be, for example, a displacement meter or a velocity sensor. When the observation device is a displacement meter, the measurement device 1 differentiates displacement data Uₘ(k), which is observation data, to generate the velocity data MV(k), as in Equation (15).

$$M V ( k ) = \frac{\{ {U}_{m} ( k ) - {U}_{m} ( k - 1 ) \}}{Δ T} \qquad ( 15 )$$

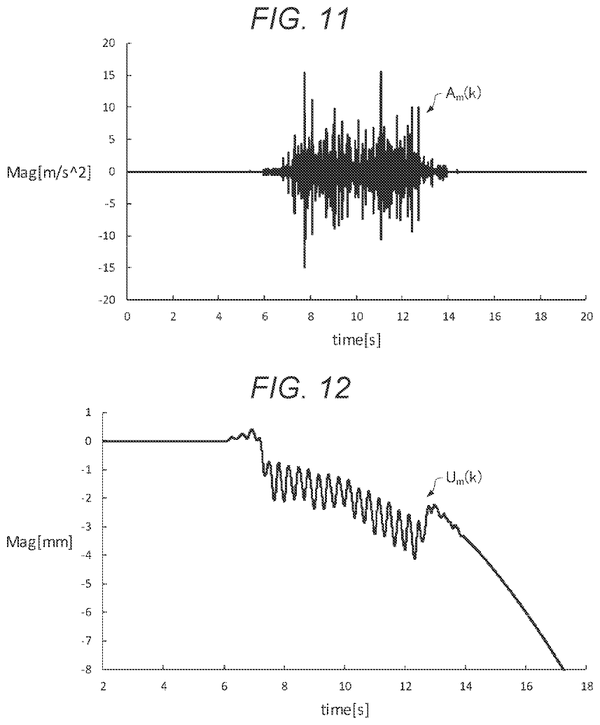

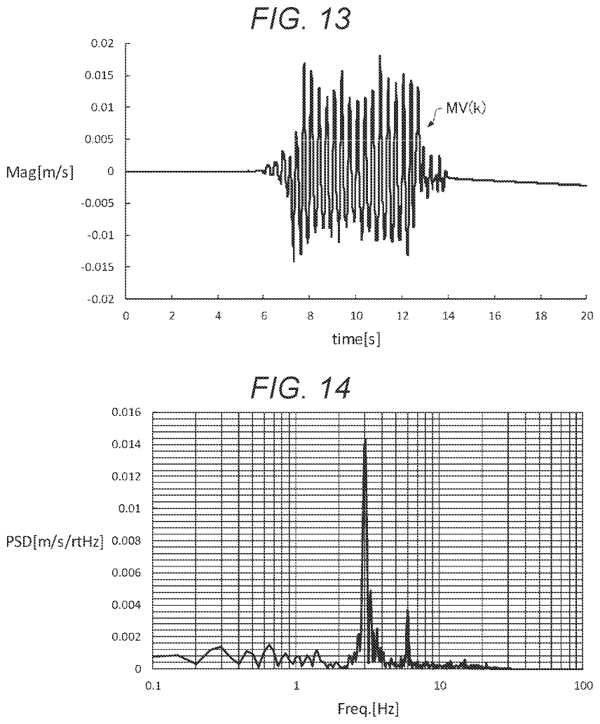

In Equation (14) and Equation (15), ΔT is a time interval of data. FIG. 11 shows an example of the acceleration data Aₘ(k). FIG. 12 shows an example of the displacement data Uₘ(k). FIG. 13 shows an example of the velocity data MV(k) obtained by Equation (14) or (15). When the observation device is a velocity sensor, the measurement device 1 sets velocity data output from the velocity sensor as the velocity data MV(k).

Next, the measurement device 1 generates velocity data MVH(k) by performing high-pass filter processing on the velocity data MV(k) in order to reduce the drift noise, as in Equation (16).

MVH(k)=f_{HP}(MV(k)) (16)

Since the velocity data MV(k) includes a significant vibration component generated by the traveling of the railway vehicle 6, it is necessary to set a cutoff frequency of the high-pass filter processing to be a frequency lower than a frequency of the vibration component. In the present embodiment, first, the measurement device 1 calculates a power spectrum density by performing fast Fourier transform processing on the velocity data MV(k), and calculates a peak of the power spectrum density as a fundamental frequency Ff. FIG. 14 shows the power spectrum density obtained by performing fast Fourier transform processing on the velocity data MV(k) of FIG. 13. In the example of FIG. 14, the fundamental frequency F_{f} is calculated as about 3 Hz. Then, the measurement device 1 performs the high-pass filter processing using a frequency lower than the fundamental frequency F_{f} as the cutoff frequency. By the high-pass filter processing, the velocity data MVH(k) in which drift noise of a frequency lower than the fundamental frequency F_{f} is reduced is obtained.

Next, the measurement device 1 integrates the velocity data MVH(k) to generate the displacement data MU(k) as in Equation (17). FIG. 15 shows an example of the displacement data MU(k).

MU(k)=MVH(k)ΔT+MU(k−1) (17)

In the present embodiment, the displacement data MU(k) is generated by integrating the velocity data MVH(k), that is obtained by performing high-pass filter processing on the velocity data MV(k), instead of generating the displacement data MU(k) by performing high-pass filter processing on the displacement data obtained by integrating the velocity data MV(k) for the following reason. That is, since an f⁻¹ waveform of the power spectrum density of the displacement data obtained by integrating the velocity data MV(k) is rotated as compared with the velocity data MV(k), the signal component of the fundamental frequency is likely to be masked by the drift noise or the signal component. Therefore, it is easier to calculate the fundamental frequency F_{f} based on the power spectrum density of the velocity data MV(k). In addition, since the drift noise in the velocity data MV(k) has a variation amount smaller than that of the drift noise in the displacement data obtained by integrating the velocity data MV(k), it is easy to sufficiently reduce the drift noise by performing high-pass filter processing on the velocity data MV(k).

Next, based on the displacement data MU(k), the measurement device 1 estimates data f_{LP}(M(k)) obtained by performing low-pass filter processing on the significant signal M(k) included in the displacement data obtained by virtually integrating the velocity data MV(k), that is, correction data M_{CC}(k) corresponding to a difference between data obtained by removing the drift noise from data obtained by integrating the velocity data MV(k) and the displacement data MU(k).

As shown in FIG. 15, in the present embodiment, the measurement device 1 specifies a first interval T1, a second interval T2, a third interval T3, a fourth interval T4, and a fifth interval T5 based on the displacement data MU(k), and generates correction data M_{CC}(k) by dividing the correction data M_{CC}(k) into these five intervals. In order to specify the first interval T1, the second interval T2, the third interval T3, the fourth interval T4, and the fifth interval T5, the measurement device 1 calculates a first peak p₁=(k₁, mu₁), a second peak p₂=(k₂, mu₂), a third peak p₃=(k₃, mu₃), and a fourth peak p₄=(k₄, mu₄) of the displacement data MU(k). As shown in FIG. 15, the first peak p₁ is a head peak near a time point when the railway vehicle 6 enters the superstructure 7, and the fourth peak p₄ is a tail peak near a time point when the railway vehicle 6 exits the superstructure 7. The second peak p₂ is a second peak following the head, and the third peak p₃ is a second peak prior to the tail.

The first interval T1 is an interval before the first peak p₁, that is, an interval of k≤k₁. The second interval T2 is an interval between the first peak p₁ and the second peak p₂, that is, an interval of k₁<k<k₂. The third interval T3 is an interval between the second peak p₂ and the third peak p₃, that is, an interval of k₂≤k≤k₃. The fourth interval T4 is an interval between the third peak p₃ and the fourth peak p₄, that is, an interval of k₃<k<k₄.

As in Equation (18), the correction data M_{CC}(k) is obtained as a sum of first interval correction data M_{CC1}(k) which is correction data of the first interval T1, second interval correction data M_{CC2}(k) which is correction data of the second interval T2, third interval correction data M_{CC3}(k) which is correction data of the third interval T3, fourth interval correction data M_{CC4}(k) which is correction data of the fourth interval T4, and fifth interval correction data M_{CC5}(k) which is correction data of the fifth interval T5.

M_{CC}(k)=M_{CC1}(k)+M_{CC2}(k)+M_{CC3}(k)+M_{CC4}(k)+M_{CC5}(k) (18)

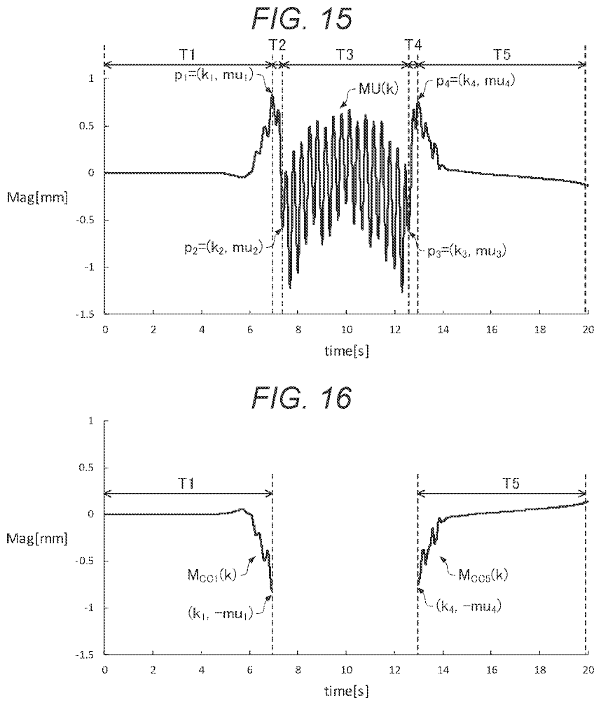

The first interval correction data M_{CC1}(k) is obtained according to Equation (19) using data MU′(k) obtained by inverting a sign of the displacement data MU(k). Similarly, the fifth interval correction data M_{CC5}(k) is obtained according to Equation (20) using the data MU′(k) obtained by inverting the sign of the displacement data MU(k). FIG. 16 shows an example of the first interval correction data M_{CC1}(k) and the fifth interval correction data M_{CC5}(k).

$${M}_{C C 1} ( k ) = \{ \begin{matrix}k \leq {k}_{1} & {MU}^{′} ( k ) \\ {k}_{1} < k & 0\end{matrix} = \{ \begin{matrix}k \leq {k}_{1} & - MU ( k ) \\ {k}_{1} < k & 0\end{matrix} \qquad ( 19 )$$

$${M}_{C C 5} ( k ) = \{ \begin{matrix}k < {k}_{4} & 0 \\ {k}_{4} \leq k & {MU}^{′} ( k )\end{matrix} = \{ \begin{matrix}k < {k}_{4} & 0 \\ {k}_{4} \leq k & - MU ( k )\end{matrix} \qquad ( 20 )$$

The second interval correction data M_{CC2}(k) is obtained as follows. First, the measurement device 1 generates a line L1′(k) obtained by approximating the first interval correction data M_{CC1}(k) smaller than a product −mu₁c_{TH} of a coefficient c_{TH} and a value −mu₁ obtained by inverting a sign of an amplitude mu₁ of the first peak p₁=(k₁, mu₁). Here, since an optimum value of the coefficient c_{TH} varies depending on the superstructure 7, the structure of the railway vehicle 6, and the like, the coefficient c_{TH} is determined in advance in a range of 0<c_{TH}<1 by performing evaluation before measurement, for example.

A line L1′(k) obtained by approximating the first interval correction data M_{CC1}(k) from k=kₐ to k₁ with respect to kₐ satisfying Equation (21) is represented by Equation (22).

M_{CC1}(kₐ)≅−mu₁c_{Th} (21)

L1′(k)=s₁k (22)

In Equation (22), the first-order coefficient s₁ at which an error between the line L1′(k) and the first interval correction data M_{CC1}(k) is minimized is obtained by Equation (23) using a least-squares method.

$${s}_{1} = \frac{{\sum }_{k = {k}_{a}}^{{k}_{1}} 1 {\sum }_{k = {k}_{a}}^{{k}_{1}} k {M}_{CC 1} ( k ) - {\sum }_{k = {k}_{a}}^{{k}_{1}} k {\sum }_{k = {k}_{a}}^{{k}_{1}} {M}_{C C 1} ( k )}{{\sum }_{k = {k}_{𝔞}}^{{k}_{1}} 1 {\sum }_{k = {k}_{a}}^{{k}_{1}} {k}^{2} - {\sum }_{k = {k}_{a}}^{{k}_{1}} k {\sum }_{k = {k}_{a}}^{{k}_{1}} k} \qquad ( 23 )$$

A zero-order coefficient i₁ of first line data L1(k) that is the same as the first-order coefficient s₁ of the line L1′(k) and passes through a point (k₁, −mu₁) obtained by inverting a sign of an amplitude of the first peak p₁=(k₁, mu₁) at k=k₁ is obtained by Equation (24).

iₜ=−mu₁−s₁k₁ (24)

The first line data L1(k) is obtained by Equation (25).

L1(k)=s₁k+i₁=s₁k−mu₁−s₁k₁ (25)

The second interval correction data M_{CC2}(k) is obtained, as the first line data L1(k) in the second interval T2, as in Equation (26).

$${M}_{CC 2} ( k ) = \{ \begin{matrix}k \leq {k}_{1} & 0 \\ {k}_{1} < k < {k}_{2} & L 1 ( k ) \\ {k}_{2} \leq k & 0\end{matrix} = \{ \begin{matrix}k \leq {k}_{1} & 0 \\ {k}_{1} < k < {k}_{2} & {s}_{1} k - {mu}_{1} - {s}_{1} {k}_{1} \\ {k}_{2} \leq k & 0\end{matrix} \qquad ( 26 )$$

The fourth interval correction data M_{CC4}(k) is obtained as follows. First, the measurement device 1 generates a line L2′(k) obtained by approximating the fifth interval correction data M_{CC5}(k) smaller than a product −mu₄c_{TH} of a coefficient c_{TH} and a value −mu₄ obtained by inverting a sign of an amplitude mu₄ of the fourth peak p₄=(k₄, mu₄).

A line L2′(k) obtained by approximating the fifth interval correction data M_{CC5}(k) from k=k₄ to k_{b} with respect to kₐ satisfying Equation (27) is represented by Equation (28).

M_{CC5}(k_{b})≅−mu₄c_{Th} (27)

L2′(k)=s₂k (28)

In Equation (28), a first-order coefficient s₂ at which the error between the line L2′(k) and the fifth interval correction data M_{CC5}(k) is minimized is obtained by Equation (29) using a least-squares method.

$${s}_{2} = \frac{{\sum }_{k = {k}_{2}}^{{k}_{b}} 1 {\sum }_{k = {k}_{2}}^{{k}_{b}} k {M}_{CC 3} ( k ) - {\sum }_{k = {k}_{2}}^{{k}_{b}} k {\sum }_{k = {k}_{2}}^{{k}_{b}} {M}_{C C 3} ( k )}{{Σ}_{k = {k}_{2}}^{{k}_{b}} 1 {Σ}_{k = {k}_{2}}^{{k}_{b}} {k}^{2} - {\sum }_{k = {k}_{2}}^{{k}_{b}} k {\sum }_{k = {k}_{2}}^{{k}_{b}} k} \qquad ( 29 )$$

A zero-order coefficient i₂ of the second line data L2(k) that is the same as the first-order coefficient s₂ of the line L2′(k) and passes through a point (k₄, −mu₄) obtained by inverting a sign of an amplitude of the fourth peak p₄=(k₄, mu₄) at k=k₄ is obtained by Equation (30).

i₂=−mu₄−s₂k₄ (30)

The second line data L2(k) is obtained by Equation (31).

L2(k)=s₂k+i₂=s₂k−mu₄−s₂k₄ (31)

The fourth interval correction data M_{CC4}(k) is obtained, as the second line data L2(k) in the fourth interval T4, as in Equation (32).

$${M}_{C C 4} ( k ) = \{ \begin{matrix}k \leq {k}_{3} & 0 \\ {k}_{3} < k < {k}_{4} & L 2 ( k ) \\ {k}_{4} \leq k & 0\end{matrix} = \{ \begin{matrix}k \leq {k}_{3} & 0 \\ {k}_{3} < k < {k}_{4} & {s}_{2} k - {mu}_{4} - {s}_{2} {k}_{4} \\ {k}_{4} \leq k & 0\end{matrix} \qquad ( 32 )$$

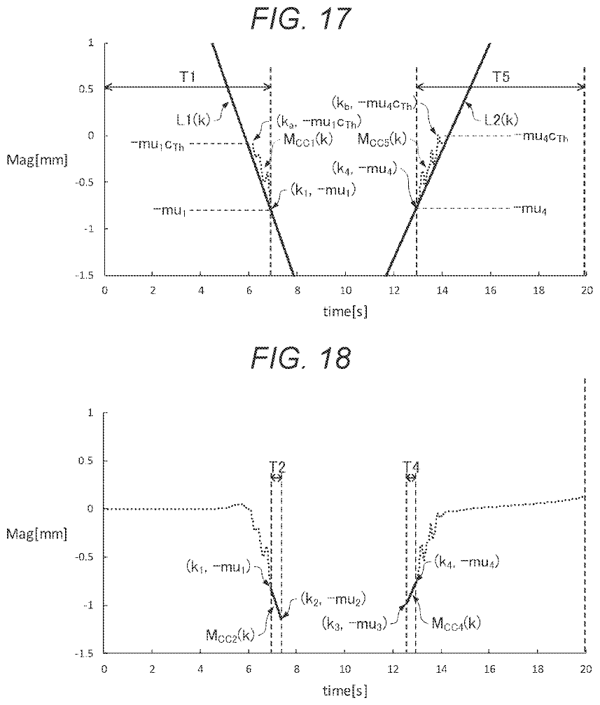

FIG. 17 shows an example of the first line data L1(k) and the second line data L2(k). FIG. 18 shows an example of the second interval correction data M_{CC2}(k) and the fourth interval correction data M_{CC4}(k).

The third interval correction data M_{CC3}(k) is obtained as follows. First, the measurement device 1 generates third line data L3(k) passing through a point p₇ having an amplitude that is a sum of an amplitude of the first line data L1(k) and an amplitude of the displacement data MU(k) at a time point of the second peak p₂, that is, k=k₂, and a point p₈ having an amplitude that is a sum of an amplitude of the second line data L2(k) and an amplitude of the displacement data MU(k) at a time point of the third peak p₃, that is, k=k₃.

The point p₇ corresponds to a sum of an amplitude L1(k₂) of a point p₅=(k₂, L1(k₂)) on the first line data L1(k) and an amplitude mu₂ of the second peak p₂=(k₂, mu₂) of the displacement data MU(k) at k=k₂, and is obtained as in Equation (33).

p₇(k₂,mu₂+L1(k₂))=(k₂,mu₂+s₁k₂−mu₁−s₁k₁) (33)

The point p₈ corresponds to a sum of an amplitude L2(k₃) of a point p₆=(k₃, L2(k₃)) on the second line data L2(k) and an amplitude mu₃ of the third peak p₃=(k₃, mu₃) of the displacement data MU(k) at k=k₃, and is obtained as in Equation (34).

p₈=(k₃,mu₃+L2(k₃))=(k₃,mu₃+s₂k₃−mu₄−s₂k₄) (34)

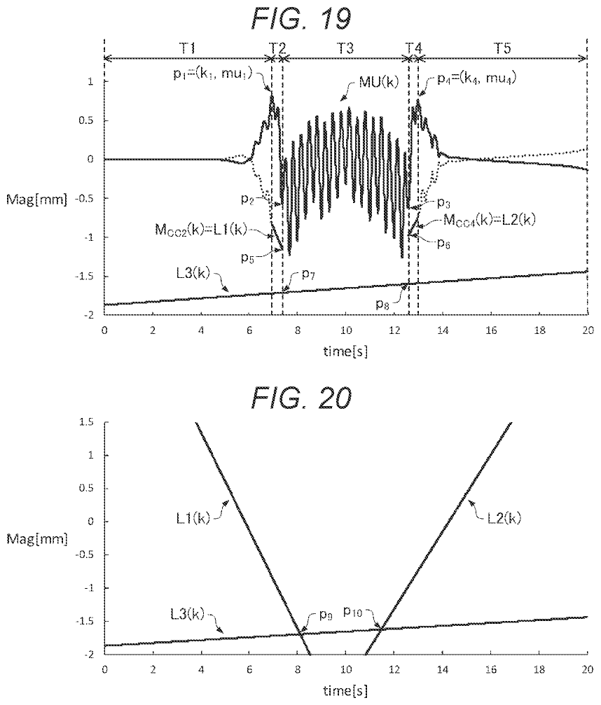

The third line data L3(k) passing through the point p₇ and the point p₈ is obtained by Equation (35). FIG. 19 shows an example of the third line data L3(k).

$$L 3 ( k ) = \frac{- m {u}_{3} + L 2 ( {k}_{3} ) + m {u}_{2} - L 1 ( {k}_{2} )}{{k}_{3} - {k}_{2}} k + m {u}_{2} - L 1 ( {k}_{2} ) - \frac{- m {u}_{3} + L 2 ( {k}_{3} ) + m {u}_{2} - L 1 ( {k}_{2} )}{{k}_{3} - {k}_{2}} {k}_{2} \qquad ( 35 )$$

As shown in FIG. 20, a first intersection point of the first line data L1(k) and the third line data L3(k) is p₉=(k₅, L3(k₅)), and a second intersection point of the second line data L2(k) and the third line data L3(k) is p₁₀=(k₆, L3(k₆)) As in Equation (36), the measurement device 1 generates the third interval correction data M_{CC3}(k) in the third interval T3 by using data before the first intersection point p₉ as the first line data L1(k), data from the first intersection point p₉ to the second intersection point p₁₀ as the third line data L3(k), and data after the second intersection point p₁₀ as the second line data L2(k).

$${M}_{C C 3} ( k ) = \{ \begin{matrix}k \leq {k}_{2} & 0 \\ {k}_{2} < k < {k}_{s} & L 1 ( k ) \\ {k}_{5} \leq k \leq {k}_{6} & L 3 ( k ) \\ {k}_{6} < k < {k}_{3} & L 2 ( k ) \\ {k}_{3} \leq k & 0\end{matrix} \qquad ( 36 )$$

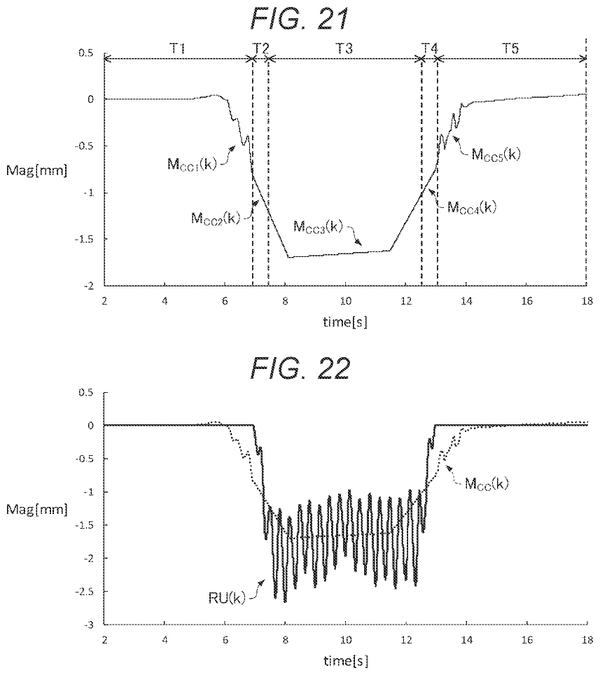

The correction data M_{CC}(k) is obtained as in Equation (37) by substituting Equation (19), Equation (20), Equation (26), Equation (32), and Equation (36) into Equation (18). FIG. 21 shows an example of the correction data M_{CC}(k).

$${M}_{C C} ( k ) = \{ \begin{matrix}k \leq {k}_{1} & {M}_{C C 1} ( k ) \\ {k}_{1} < k < {k}_{2} & {M}_{C C 2} ( k ) \\ {k}_{2} \leq k \leq {k}_{3} & {M}_{C C 3} ( k ) \\ {k}_{3} < k < {k}_{4} & {M}_{C C 4} ( k ) \\ {k}_{4} \leq k & {M}_{C C 5} ( k )\end{matrix} = \qquad ( 37 )$$

$$\{ \begin{matrix}k \leq {k}_{1} & {M}_{C C 1} ( k ) \\ {k}_{1} < k < {k}_{2} & L 1 ( k ) \\ {k}_{2} < k < {k}_{5} & L 1 ( k ) \\ {k}_{5} \leq k \leq {k}_{6} & L 3 ( k ) \\ {k}_{6} < k < {k}_{3} & L 2 ( k ) \\ {k}_{3} < k < {k}_{4} & L 2 ( k ) \\ {k}_{4} \leq k & {M}_{CC 5} ( k )\end{matrix} = \{ \begin{matrix}k \leq {k}_{1} & - MU ( k ) \\ {k}_{1} < k < {k}_{5} & L 1 ( k ) \\ {k}_{5} \leq k \leq {k}_{6} & L 3 ( k ) \\ {k}_{6} < k < {k}_{4} & L 2 ( k ) \\ {k}_{4} \leq k & - MU ( k\end{matrix}$$

Then, as in Equation (38), the displacement data MU(k) and the correction data M_{CC}(k) are added to obtain the measurement data RU(k) which is the displacement data in which the drift noise is reduced.

RU(k)=MU(k)+M_{CC}(k) (38)

Equation (39) is obtained by substituting Equation (37) into Equation (38).

$$R U ( k ) = \{ \begin{matrix}k \leq {k}_{1} & 0 \\ {k}_{1} < k < {k}_{5} & L 1 ( k ) \\ {k}_{5} \leq k \leq {k}_{6} & L 3 ( k ) \\ {k}_{6} < k < {k}_{4} & L 2 ( k ) \\ {k}_{4} \leq k & 0\end{matrix} \qquad ( 39 )$$

From Equation (39), the measurement data RU(k) is 0 in an interval of k≤k₁ which is the first interval T1 and an interval of k₄≤k which is the fifth interval T5, and the measurement data RU(k) from which the drift noise is removed is obtained. FIG. 22 shows an example of the measurement data RU(k).

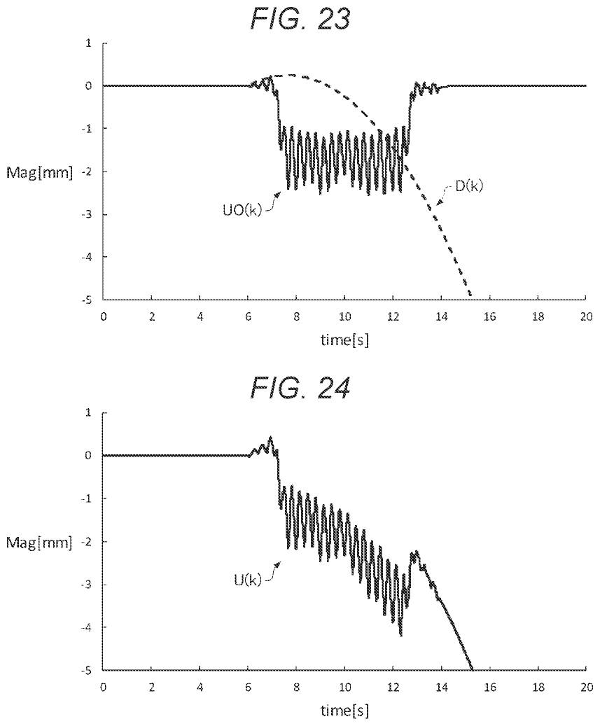

In order to confirm an effect of removing the drift noise by the measurement method of the present embodiment, a waveform obtained by adding the drift noise D(k) to a displacement waveform UO(k) as in Equation (40) is used as an evaluation waveform U(k). FIG. 23 shows an example of the displacement waveform UO(k) and the drift noise D(k). FIG. 24 shows an example of the evaluation waveform U(k).

U(k)=UO(k)+D(k) (40)

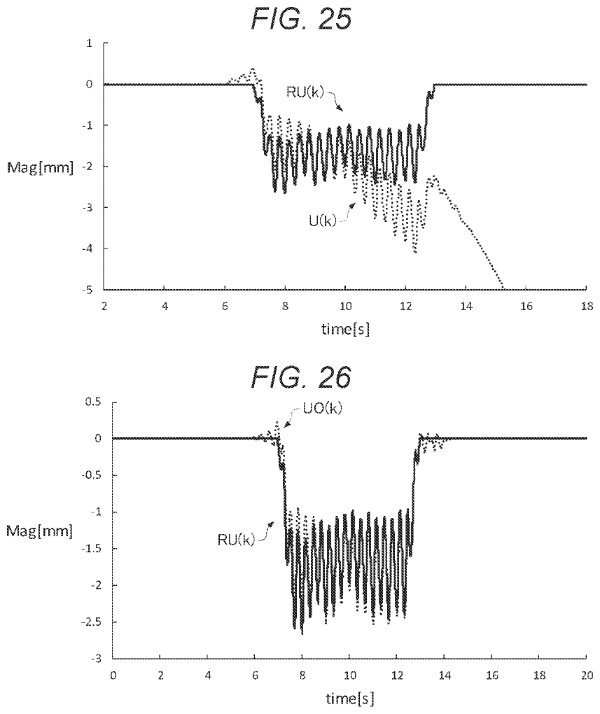

Data obtained by differentiating the evaluation waveform U(k) is defined as the velocity data MV(k), and the measurement data RU(k) obtained by Equations (16) to (39) is compared with the displacement waveform UO(k). FIG. 25 shows the measurement data RU(k). FIG. 26 shows the measurement data RU(k) and the displacement waveform UO(k) in an overlapping manner. As shown in FIGS. 25 and 26, it can be confirmed that the measurement data RU(k) in which the drift noise is removed and the displacement waveform is restored is obtained by the measurement method according to the present embodiment.

### 1-4. Procedure of Measurement Method

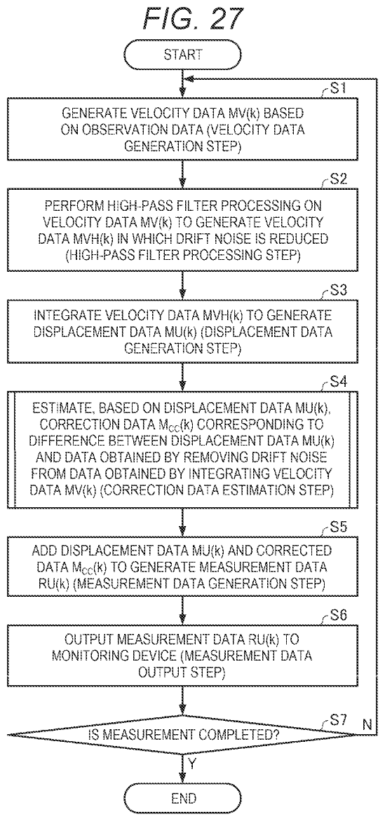

FIG. 27 is a flowchart showing an example of a procedure of the measurement method of the first embodiment for measuring the displacement of the superstructure 7 of the bridge 5. In the present embodiment, the measurement device 1 executes the procedure shown in FIG. 27.

As shown in FIG. 27, first, in a velocity data generation step S1, the measurement device 1 generates the velocity data MV(k) based on the observation data. The velocity data MV(k) is data based on the observation data observed by the observation device. Specifically, when the observation data is acceleration data, the measurement device integrates the observation data to generate the velocity data MV(k) as in Equation (14), when the observation data is displacement data, the measurement device 1 differentiates the observation data to generate the velocity data MV(k) as in Equation (15), and when the observation data is velocity data, the measurement device 1 sets the observation data as the velocity data MV(k). In the present embodiment, the velocity data MV(k) is data of a displacement velocity of the superstructure 7 caused by the railway vehicle 6 which is a moving object moving on the superstructure 7 which is a structure.

Next, in a high-pass filter processing step S2, the measurement device 1 performs high-pass filter processing on the velocity data MV(k) including the drift noise and generated in step S1, so as to generate the velocity data MVH(k) as drift noise reduction data in which the drift noise is reduced, as in Equation (16). Specifically, the measurement device 1 performs fast Fourier transform processing on the velocity data MV(k) to calculate a fundamental frequency F_{f}, and performs high-pass filter processing using a frequency lower than the fundamental frequency F_{f} as the cutoff frequency. The high-pass filter processing of the velocity data MV(k) may be processing of subtracting data, that is obtained by performing low-pass filter processing on the velocity data MV(k), from the velocity data MV(k). The low-pass filter processing may be moving average processing or FIR filter processing. The FIR is an abbreviation for finite impulse response. That is, the high-pass filter processing of the velocity data MV(k) may be processing of subtracting data, that is obtained by performing moving average processing or FIR filter processing on the velocity data MV(k), from the velocity data MV(k). In the present embodiment, the frequency of the drift noise included in the velocity data MV(k) is lower than a minimum value of a natural vibration frequency of the superstructure 7. The minimum value of the natural vibration frequency of the superstructure 7 is, for example, a frequency of the superstructure 7 of a first-order vibration mode in the longitudinal direction. By setting the cutoff frequency of the high-pass filter processing to be higher than the frequency of the drift noise of the superstructure 7 and lower than the minimum value of the natural vibration frequency, the drift noise in the generated velocity data MVH(k) is reduced without reducing a signal component and a harmonic component of the natural vibration frequency of the superstructure 7. For example, the frequency of the drift noise may be less than Hz, and the cutoff frequency of the high-pass filter processing may be 1 Hz or more.

Next, in a displacement data generation step S3, the measurement device 1 integrates the velocity data MVH(k) generated in step S2 to generate the displacement data MU(k), as in Equation (17). In the present embodiment, the displacement data MU(k) is data of the displacement of the superstructure 7 caused by the railway vehicle 6 moving on the superstructure 7, and includes data of a waveform that projects in the positive direction or the negative direction, specifically, data of a rectangular waveform, a trapezoidal waveform, or a sine half-wave waveform. The rectangular waveform includes not only an accurate rectangular waveform but also a waveform approximate to the rectangular waveform. Similarly, the trapezoidal waveform includes not only an accurate trapezoidal waveform but also a waveform approximate to the trapezoidal waveform. Similarly, the sine half-wave waveform includes not only an accurate sine half-wave waveform but also a waveform approximate to the sine half-wave waveform.

Next, in a correction data estimation step S4, the measurement device 1 estimates, based on the displacement data MU(k) generated in step S3, the correction data M_{CC}(k) corresponding to the difference between the displacement data MU(k) and the data obtained by removing the drift noise from the data obtained by integrating the velocity data MV(k). Specifically, the measurement device 1 generates the correction data M_{CC}(k) by performing calculations of Equations (18) to (37).

Next, in a measurement data generation step S5, the measurement device 1 adds the displacement data MU(k) generated in step S3 and the correction data M_{CC}(k) generated in step S4 to generate the measurement data RU(k), as in Equation (38).

Next, in a measurement data output step S6, the measurement device 1 outputs the measurement data RU(k) generated in step S5 to the monitoring device 3. Specifically, the measurement device 1 transmits the measurement data RU(k) to the monitoring device 3 via the communication network 4.

Then, in step S7, the measurement device 1 repeats the processing of steps S1 to S6 until the measurement of the displacement of the superstructure 7 of the bridge 5 is completed.

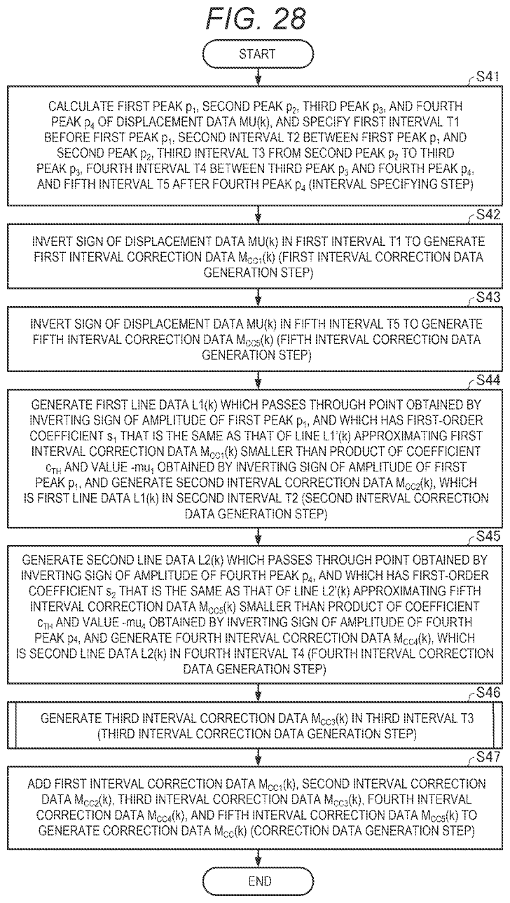

FIG. 28 is a flowchart showing an example of a procedure of the correction data estimation step S4 in FIG. 27.

As shown in FIG. 28, first, in an interval specifying step S41, the measurement device 1 calculates a first peak p₁=(k₁, mu₁), a second peak p₂=(k₂, mu₂), a third peak p₃=(k₃, mu₃), and a fourth peak p₄=(k₄, mu₄) of the displacement data MU(k), and specifies a first interval T1 before the first peak p₁, a second interval T2 between the first peak p₁ and the second peak p₂, a third interval T3 from the second peak p₂ to the third peak p₃, a fourth interval T4 between the third peak p₃ and the fourth peak p₄, and a fifth interval T5 after the fourth peak p₄. That is, the first interval T1 is an interval of k≤k₁, the second interval T2 is an interval of k₁<k<k₂, the third interval T3 is an interval of k₂≤k≤k₃, the fourth interval T4 is an interval of k₃<k<k₄, and the fifth interval T5 is an interval of k₄≤k. In the present embodiment, the first peak p₁ is the head peak near the time point when the railway vehicle 6 enters the superstructure 7, and the fourth peak p₄ is the tail peak near the time point when the railway vehicle 6 exits the superstructure 7. The second peak p₂ is a second peak following the head, and the third peak p₃ is a second peak prior to the tail.

Next, in a first interval correction data generation step S42, the measurement device 1 inverts a sign of the displacement data MU(k) in the first interval T1 to generate the first interval correction data M_{CC1}(k), as in Equation (19).

Next, in a fifth interval correction data generation step S43, the measurement device 1 inverts a sign of the displacement data MU(k) in the fifth interval T5 to generate the fifth interval correction data M_{CC5}(k), as in Equation (20).

Next, in a second interval correction data generation step S44, the measurement device 1 uses Equations (23), (24), and (25) to generate the first line data L1(k) which passes through the point (k₁, −mu₁) obtained by inverting the sign of the amplitude of the first peak p₁, and which has the first-order coefficient s₁ that is the same as that of the line L1′(k) approximating the first interval correction data M_{CC1}(k) smaller than the product −mu₁c_{TH} of the coefficient c_{TH} and the value −mu₁ obtained by inverting the sign of the amplitude mu₁ of the first peak p₁=(k₁, mu₁), and the measurement device 1 generates the second interval correction data M_{CC2}(k), which is the first line data L1(k) in the second interval T2, as in Equation (26).

Next, in a fourth interval correction data generation step S45, the measurement device 1 uses Equations (29), (30), and (31) to generate the second line data L2(k) which passes through the point (k₄, −mu₄) obtained by inverting the sign of the amplitude of the fourth peak p₄, and which has the first-order coefficient s₂ that is the same as that of the line L2′(k) approximating the fifth interval correction data M_{CC5}(k) smaller than the product −mu₄c_{TH} of the coefficient c_{TH} and the value −mu₄ obtained by inverting the sign of the amplitude mu₄ of the fourth peak p₄=(k₄, mu₄), and the measurement device 1 generates the fourth interval correction data M_{CC4}(k), which is the second line data L2(k) in the fourth interval T4, as in Equation (32).

Next, in the third interval correction data generation step S46, the measurement device 1 generates the third interval correction data M_{CC3}(k) in the third interval T3.

Finally, in a correction data generation step S47, the measurement device 1 adds the first interval correction data M_{CC1}(k) generated in step S42, the second interval correction data M_{CC2}(k) generated in step S44, the third interval correction data M_{CC3}(k) generated in step S46, the fourth interval correction data M_{CC4}(k) generated in step S45, and the fifth interval correction data M_{CC 5}(k) generated in step S43 to generate the correction data M_{CC}(k), as in Equation (18).

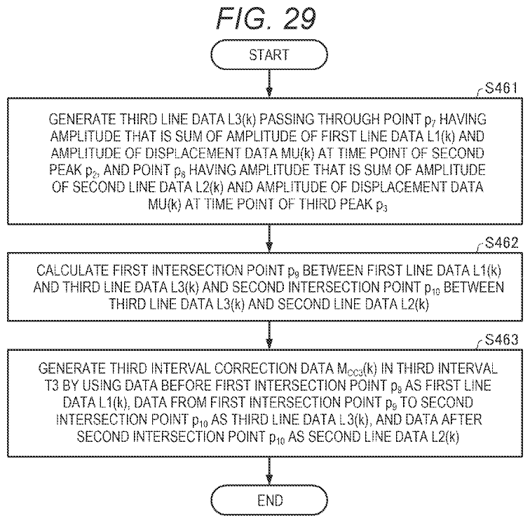

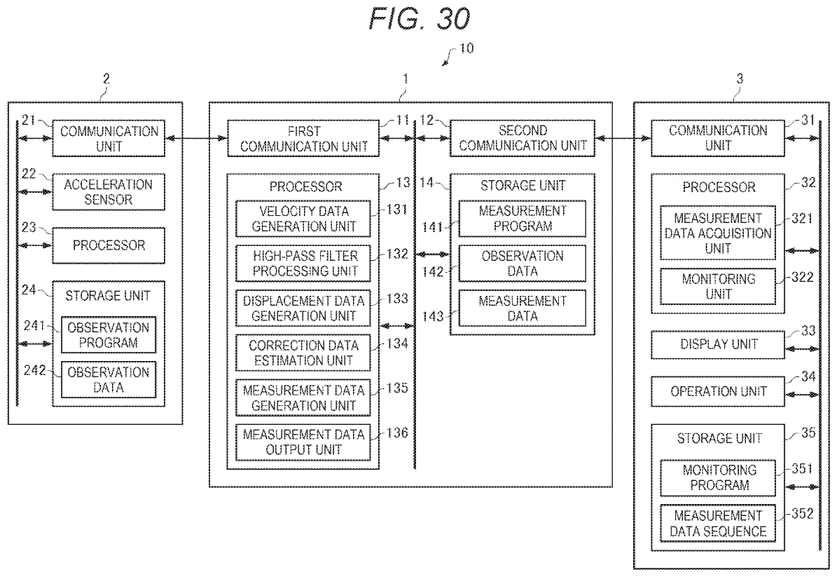

FIG. 29 is a flowchart showing an example of a procedure of the third interval correction data generation step S46 in FIG. 28.

As shown in FIG. 29, first, in step S461, the measurement device 1 generates, according to Equation (35), the third line data L3(k) passing through the point p₇=(k₂, mu₂+L1(k₂)) having an amplitude that is the sum of the amplitude L1(k₂) of the first line data L1(k) and the amplitude mu₂ of the displacement data MU(k) at the time point of the second peak p₂=(k₂, mu₂), and the point p₈=(k₃, mu₃+L2(k₃)) having an amplitude that is the sum of the amplitude L2(k₃) of the second line data L2(k) and the amplitude mu₃ of the displacement data MU(k) at the time point of the third peak p₃=(k₃, mu₃).

Next, in step S462, the measurement device 1 calculates the first intersection point p₉=(k₅, L3(k₅)) between the first line data L1(k) and the third line data L3(k) and the second intersection point p₁₀=(k₆, L3(k₆)) between the third line data L3(k) and the second line data L2(k).

Finally, in step S463, as in Equation (36), the measurement device 1 generates the third interval correction data M_{CC3}(k) in the third interval T3 by using data before the first intersection point p₉ as the first line data L1(k), data from the first intersection point p₉ to the second intersection point p₁₀ as the third line data L3(k), and data after the second intersection point p₁₀ as the second line data L2(k).

### 1-5. Configuration of Observation Device, Measurement Device, and Monitoring Device

FIG. 30 is a diagram showing a configuration example of the sensor 2 which is the observation device, the measurement device 1, and the monitoring device 3.

As shown in FIG. 30, the sensor 2 includes a communication unit 21, an acceleration sensor 22, a processor 23, and a storage unit 24.

The storage unit 24 is a memory that stores various programs, data, and the like for the processor 23 to perform calculation processing and control processing. The storage unit 24 stores programs, data, and the like for the processor 23 to implement predetermined application functions.

The acceleration sensor 22 detects an acceleration generated in each axial direction of the three axes.

The processor 23 controls the acceleration sensor 22 by executing an observation program 241 stored in the storage unit 24, generates observation data 242 based on the acceleration detected by the acceleration sensor 22, and stores the generated observation data 242 in the storage unit 24. In the present embodiment, the observation data 242 is the acceleration data Aₘ(k).

The communication unit 21 transmits the observation data 242 stored in the storage unit 24 to the measurement device 1 under the control of the processor 23.

As shown in FIG. 30, the measurement device 1 includes a first communication unit 11, a second communication unit 12, a processor 13, and a storage unit 14.

The first communication unit 11 receives the observation data 242 from the sensor 2, and outputs the received observation data 242 to the processor 13. As described above, the observation data 242 is the acceleration data Aₘ(k).

The storage unit 14 is a memory that stores programs, data, and the like for the processor 13 to perform the calculation processing and the control processing. The storage unit 14 stores programs, data, and the like for the processor 13 to implement predetermined application functions. The processor 13 may receive various programs, data, and the like via the communication network 4 and store the programs, data, and the like in the storage unit 14.

The processor 13 acquires the observation data 242 received by the first communication unit 11, and stores the observation data 242 in the storage unit 14 as observation data 142. Then, the processor 13 generates measurement data 143 based on the observation data 142 stored in the storage unit 14, and stores a generated measurement data 143 in the storage unit 14. In the present embodiment, the measurement data 143 is the measurement data RU(k).

In the present embodiment, the processor 13 functions as a velocity data generation unit 131, a high-pass filter processing unit 132, a displacement data generation unit 133, a correction data estimation unit 134, a measurement data generation unit 135, and a measurement data output unit 136 by executing a measurement program 141 stored in the storage unit 14. That is, the processor 13 includes the velocity data generation unit 131, the high-pass filter processing unit 132, the correction data estimation unit 134, the measurement data generation unit 135, and the measurement data output unit 136.

The velocity data generation unit 131 acquires the observation data 142 stored in the storage unit 14, and generates velocity data MV(k) based on the observation data 142. In the example of FIG. 30, the observation data 142 is acceleration data, but the observation data 142 may be displacement data or velocity data. When the observation data 142 is acceleration data, the velocity data generation unit 131 integrates the acceleration data to generate the velocity data MV(k) as in Equation (14), when the observation data 142 is displacement data, the velocity data generation unit 131 differentiates the displacement data to generate the velocity data MV(k) as in Equation (15), and when the observation data 142 is velocity data, the velocity data generation unit 131 sets the observation data 142 as the velocity data MV(k). That is, the velocity data generation unit 131 performs the processing of the velocity data generation step S1 in FIG. 27.

The high-pass filter processing unit 132 performs high-pass filter processing on the velocity data MV(k), that includes the drift noise and is generated by the velocity data generation unit 131, to generate the velocity data MVH(k) as drift noise reduction data in which the drift noise is reduced, as in Equation (16). That is, the high-pass filter processing unit 132 performs the processing of the high-pass filter processing step S2 in FIG. 27.

The displacement data generation unit 133 integrates the velocity data MVH(k) generated by the high-pass filter processing unit 132 to generate the displacement data MU(k), as in Equation (17). That is, the displacement data generation unit 133 performs the processing of the displacement data generation step S3 in FIG. 27.

The correction data estimation unit 134 estimates, based on the displacement data MU(k) generated by the displacement data generation unit 133, the correction data M_{CC}(k) corresponding to the difference between the displacement data MU(k) and the data obtained by removing the drift noise from the data obtained by integrating the velocity data MV(k). The correction data estimation unit 134 generates the correction data M_{CC}(k) by performing calculations of Equations (18) to (37).

Specifically, first, the correction data estimation unit 134 calculates the first peak p₁=(k₁, mu₁), the second peak p₂=(k₂, mu₂), the third peak p₃=(k₃, mu₃), and the fourth peak p₄=(k₄, mu₄) of the displacement data MU(k), and specifies the first interval T1 before the first peak p₁, the second interval T2 between the first peak p₁ and the second peak p₂, the third interval T₃ from the second peak p₂ to the third peak p₃, the fourth interval T4 between the third peak p₃ and the fourth peak p₄, and the fifth interval T5 after the fourth peak p₄. That is, the correction data estimation unit 134 performs the processing of the interval specifying step S41 in FIG. 28.

Next, the correction data estimation unit 134 inverts the sign of the displacement data MU(k) in the first interval T1 to generate the first interval correction data M_{CC1}(k), as in Equation (19). That is, the correction data estimation unit 134 performs the processing of the first interval correction data generation step S42 in FIG. 28.

Next, the correction data estimation unit 134 inverts the sign of the displacement data MU(k) in the fifth interval T5 to generate the fifth interval correction data M_{CC5}(k), as in Equation (20). That is, the correction data estimation unit 134 performs the processing of the fifth interval correction data generation step S43 in FIG. 28.

Next, the correction data estimation unit 134 uses Equations (23), (24), and (25) to generate the first line data L1(k) which passes through the point (k₁, −mu₁) obtained by inverting the sign of the amplitude of the first peak p₁, and which has the first-order coefficient s₁ that is the same as that of the line L1′(k) approximating the first interval correction data M_{CC1}(k) smaller than the product −mu₁c_{TH} of the coefficient c_{TH} and the value −mu₁ obtained by inverting the sign of the amplitude mu₁ of the first peak p₁=(k₁, mu₁), and the correction data estimation unit 134 generates the second interval correction data M_{CC2}(k), which is the first line data L1(k) in the second interval T2, as in Equation (26). That is, the correction data estimation unit 134 performs the processing of the second interval correction data generation step S44 in FIG. 28.

Next, the correction data estimation unit 134 uses Equations (29), (30), and (31) to generate the second line data L2(k) which passes through the point (k₄, −mu₄) obtained by inverting the sign of the amplitude of the fourth peak p₄, and which has the first-order coefficient s₂ that is the same as that of the line L2′(k) approximating the fifth interval correction data M_{CC5}(k) smaller than the product −mu₄c_{TH} of the coefficient c_{TH} and the value −mu₄ obtained by inverting the sign of the amplitude mu₄ of the fourth peak p₄=(k₄, mu₄), and the correction data estimation unit 134 generates the fourth interval correction data M_{CC4}(k), which is the second line data L2(k) in the fourth interval T4, as in Equation (32). That is, the correction data estimation unit 134 performs the processing of the fourth interval correction data generation step S45 in FIG. 28.

Next, the correction data estimation unit 134 generates, according to Equation (35), the third line data L3(k) passing through the point p₇=(k₂, mu₂+L1(k₂)) having an amplitude that is the sum of the amplitude L1(k₂) of the first line data L1(k) and the amplitude mu₂ of the displacement data MU(k) at the time point of the second peak p₂=(k₂, mu₂), and the point p₈=(k₃, mu₃+L2(k₃)) having an amplitude that is the sum of the amplitude L2(k₃) of the second line data L2(k) and the amplitude mu₃ of the displacement data MU(k) at the time point of the third peak p₃=(k₃, mu₃). That is, the correction data estimation unit 134 performs the processing of step S461 in FIG. 29.

Next, the correction data estimation unit 134 calculates the first intersection point p₉=(k₅, L3(k₅)) between the first line data L1(k) and the third line data L3(k) and the second intersection point p₁₀=(k₆, L3(k₆)) between the third line data L3(k) and the second line data L2(k). That is, the correction data estimation unit 134 performs the processing of step S462 in FIG. 29.

Next, as in Equation (36), the correction data estimation unit 134 generates the third interval correction data M_{CC3}(k) in the third interval T3 by using data before the first intersection point p₉ as the first line data L1(k), data from the first intersection point p₉ to the second intersection point p₁₀ as the third line data L3(k), and data after the second intersection point p₁₀ as the second line data L2(k). That is, the correction data estimation unit 134 performs the processing of step S463 in FIG. 29.

Finally, the correction data estimation unit 134 adds the first interval correction data M_{CC1}(k) the second interval correction data M_{CC2}(k) the third interval correction data M_{CC3}(k) the fourth interval correction data M_{CC4}(k), and the fifth interval correction data M_{CC5}(k) to generate the correction data M_{CC}(k), as in Equation (18). That is, the correction data estimation unit 134 performs the processing of the correction data generation step S47 in FIG. 28.

As described above, the correction data estimation unit 134 performs the processing of the correction data estimation step S4 in FIG. 27, specifically, the processing of steps S41 to S47 in FIG. 28 and the processing of steps S461 to S463 in FIG. 29.

The measurement data generation unit 135 generates the measurement data RU(k) by adding the displacement data MU(k) generated by the displacement data generation unit 133 and the correction data M_{CC}(k) generated by the correction data estimation unit 134, as in Equation (38). That is, the measurement data generation unit 135 performs the processing of the measurement data generation step S5 in FIG. 27. The measurement data RU(k) generated by the measurement data generation unit 135 is stored in the storage unit 14 as the measurement data 143.

The measurement data output unit 136 reads the measurement data 143 stored in the storage unit 14 and outputs the measurement data 143 to the monitoring device 3. Then, the second communication unit 12 transmits the measurement data 143 stored in the storage unit 14 to the monitoring device 3 via the communication network 4 under the control of the measurement data output unit 136. That is, the measurement data output unit 136 performs the processing of the measurement data output step S6 in FIG. 27.

As described above, the measurement program 141 is a program that causes the measurement device 1, which is a computer, to execute each procedure of the flowchart shown in FIG. 27.

As shown in FIG. 30, the monitoring device 3 includes a communication unit 31, a processor 32, a display unit 33, an operation unit 34, and a storage unit 35.

The communication unit 31 receives the measurement data 143 from the measurement device 1 and outputs the received measurement data 143 to the processor 32. As described above, the measurement data 143 is the measurement data RU(k).

The display unit 33 displays various types of information under the control of the processor 32. The display unit 33 may be, for example, a liquid crystal display or an organic EL display. The EL is an abbreviation for Electro Luminescence.

The operation unit 34 outputs operation data corresponding to an operation of a user to the processor 32. The operation unit 34 may be, for example, an input device such as a mouse, a keyboard, or a microphone.

The storage unit 35 is a memory that stores various programs, data, and the like for the processor 32 to perform calculation processing and control processing. The storage unit 35 stores programs, data, and the like for the processor 32 to implement predetermined application functions.

The processor 32 acquires the measurement data 143 received by the communication unit 31, generates evaluation information by evaluating a temporal change in the displacement of the superstructure 7 based on the acquired measurement data 143, and displays the generated evaluation information on the display unit 33.

In the present embodiment, the processor 32 functions as a measurement data acquisition unit 321 and a monitoring unit 322 by executing a monitoring program 351 stored in the storage unit 35. That is, the processor 32 includes the measurement data acquisition unit 321 and the monitoring unit 322.

The measurement data acquisition unit 321 acquires the measurement data 143 received by the communication unit 31, and adds the acquired measurement data 143 to a measurement data sequence 352 stored in the storage unit 35.

The monitoring unit 322 statistically evaluates the temporal change in the displacement of the superstructure 7 based on the measurement data sequence 352 stored in the storage unit 35. Then, the monitoring unit 322 generates evaluation information indicating the evaluation result, and displays the generated evaluation information on the display unit 33. The user can monitor a state of the superstructure 7 based on the evaluation information displayed on the display unit 33.

The monitoring unit 322 may perform processing such as monitoring of the railway vehicle 6 and abnormality determination of the superstructure 7 based on the measurement data sequence 352 stored in the storage unit 35.

The processor 32 transmits, based on the operation data output from the operation unit 34, information for adjusting operation states of the measurement device 1 and the sensor 2 to the measurement device 1 via the communication unit 31. The operation state of the measurement device 1 is adjusted according to the information received via the second communication unit 12. In addition, the measurement device 1 transmits information for adjusting the operation state of the sensor 2 received via the second communication unit 12 to the sensor 2 via the first communication unit 11. The operation state of the sensor 2 is adjusted according to the information received via the communication unit 21.

In the processors 13, 23, and 32, for example, the functions of the respective units may be implemented by individual hardware, or the functions of the respective units may be implemented by integrated hardware. For example, the processors 13, 23, and 32 include hardware, and the hardware may include at least one of a circuit that processes a digital signal and a circuit that processes an analog signal. The processors 13, 23, and 32 may be a CPU, a GPU, a DSP, or the like. The CPU is an abbreviation for central processing unit, the GPU is an abbreviation for graphics processing unit, and the DSP is an abbreviation for digital signal processor. The processors 13, 23, and 32 may be configured as custom ICs such as ASICs so as to implement the functions of the respective units, or may implement the functions of the respective units by a CPU and an ASIC. The ASIC is an abbreviation for application specific integrated circuit, and the IC is an abbreviation for integrated circuit.

The storage units 14, 24, and 35 are configured by, for example, various IC memories such as a ROM, a flash ROM, and a RAM, and a recording medium such as a hard disk, a memory card, and the like. ROM is an abbreviation for read only memory, RAM is an abbreviation for random access memory, and IC is an abbreviation for integrated circuit. The storage units 14, 24, and 35 include a non-volatile information storage device that is a computer-readable device or a medium, and various programs, data, and the like may be stored in the information storage device. The information storage device may be an optical disk such as an optical disk DVD or a CD, a hard disk drive, or various memories such as a card type memory or a ROM.

Although only one sensor 2 is shown in FIG. 30, a plurality of sensors 2 may generate the observation data 242 and transmit the observation data 242 to the measurement device 1. In this case, the measurement device 1 receives a plurality of pieces of the observation data 242 transmitted from the plurality of sensors 2, generates a plurality of pieces of measurement data 143, and transmits the plurality of pieces of measurement data 143 to the monitoring device 3. The monitoring device 3 receives the plurality of pieces of measurement data 143 transmitted from the measurement device 1, and monitors a plurality of states of the superstructures 7 based on the plurality of pieces of received measurement data 143.

### 1-6. Operation and Effect

In the measurement method of the first embodiment described above, the measurement device 1 generates the velocity data MVH(k), in which the drift noise is reduced, using the velocity data MV(k) to be processed, and estimates the correction data M_{CC}(k) based on the displacement data MU(k) obtained by integrating the velocity data MVH(k). Since the correction data M_{CC}(k) corresponds to the difference between the displacement data MU(k) and the data obtained by removing the drift noise from the data obtained by integrating the velocity data MV(k), the correction data M_{CC}(k) includes the significant signal component removed by the high-pass filter processing. Therefore, according to the measurement method of the first embodiment, the measurement device 1 can generate the measurement data RU(k), in which drift noise is reduced, by adding the displacement data MU(k) and the correction data M_{CC}(k). According to the measurement method of the first embodiment, the measurement device 1 generates the displacement data MU(k) and the correction data M_{CC}(k) using the velocity data MV(k) to be processed, adds the displacement data MU(k) and the correction data M_{CC}(k), and thereby the measurement device 1 can generate the measurement data RU(k), in which the drift noise is reduced, without preparing information for reducing the drift noise in advance. Therefore, by using the measurement method of the first embodiment, accurate measurement data RU(k) can be obtained regardless of a change in the environment, and cost reduction can be achieved.

In the measurement method of the first embodiment, the measurement device 1 generates the displacement data MU(k) by performing high-pass filter processing on the velocity data MV(k) and then integrating the velocity data MV(k), instead of generating the displacement data MU(k) by integrating the velocity data MV(k) and then performing high-pass filter processing on the velocity data MV(k). Since the drift noise in the velocity data MV(k) has a variation amount smaller than that of the drift noise in the data obtained by integrating the velocity data MV(k), the drift noise is more likely to be sufficiently reduced when the displacement data MU(k) is generated by performing high-pass filter processing on the velocity data MV(k) and then integrating the velocity data MV(k) as compared with when the displacement data MU(k) is generated by integrating the velocity data MV(k) and then performing high-pass filter processing on the velocity data MV(k). Therefore, according to the measurement method of the first embodiment, the measurement device 1 can generate the accurate correction data M_{CC}(k) based on the displacement data MU(k) in which the drift noise is sufficiently reduced.

According to the measurement method of the first embodiment, since the measurement device 1 can specify the first interval T1, the second interval T2, the third interval T3, the fourth interval T4, and the fifth interval T5, and can generate the appropriate first interval correction data M_{CC1}(k), second interval correction data M_{CC2}(k), third interval correction data M_{CC3}(k), fourth interval correction data M_{CC4}(k), and fifth interval correction data M_{CC5}(k) based on a feature of the displacement data MU(k) in which the drift noise is reduced, it is possible to improve the estimation accuracy of the correction data M_{CC}(k) generated by adding the first interval correction data M_{CC1}(k), the second interval correction data M_{CC2}(k), the third interval correction data M_{CC3}(k), the fourth interval correction data M_{CC4}(k), and the fifth interval correction data M_{CC5}(k). In particular, since the measurement device 1 can generate the first line data L1(k), the second line data L2(k), and the third line data L3(k) with high accuracy by setting the coefficient c_{TH} to an appropriate value, the measurement device 1 can generate the second interval correction data M_{CC2}(k), the third interval correction data M_{CC3}(k), and the fourth interval correction data M_{CC4}(k) with high accuracy based on the first line data L1(k), the second line data L2(k), and the third line data L3(k).

According to the measurement method of the first embodiment, the measurement device 1 calculates the fundamental frequency F_{f} by performing fast Fourier transform processing on the velocity data MV(k), and performs high-pass filter processing on the velocity data MV(k) by using a frequency lower than the fundamental frequency F_{f} as the cutoff frequency, so that the drift noise can be reduced without reducing the signal component and the harmonic component of the fundamental frequency F_{f} included in the velocity data MV(k).

According to the measurement method of the first embodiment, the measurement device 1 performs processing of subtracting the data, that is obtained by performing the moving average processing or the FIR filter processing on the velocity data MV(k), from the velocity data MV(k) as the high-pass filter processing to be performed on the velocity data MV(k), and thus the high-pass filter processing can be easily performed. Further, in the moving average processing or the FIR filter processing, since a group delay of each signal component included in the velocity data MV(k) is constant, the correction data M_{CC}(k) can be estimated with high accuracy.

In the measurement method of the first embodiment, the velocity data MV(k) to be processed is data of the displacement velocity of the superstructure 7 caused by the railway vehicle 6 moving on the superstructure 7 of the bridge 5. Therefore, according to the measurement method of the first embodiment, since the measurement device 1 generates the measurement data RU(k) which is the data of the displacement of the superstructure 7 caused by the movement of the railway vehicle 6 and in which the drift noise is reduced, it is possible to accurately measure the displacement of the superstructure 7 of the bridge 5.

According to the measurement method of the first embodiment, since the measurement device 1 generates the measurement data RU(k) based on the velocity data MV(k) obtained by integrating the acceleration in the direction intersecting the surface of the superstructure 7 detected by the sensor 2 installed in the superstructure 7, it is possible to accurately measure the displacement of the superstructure 7.

In the measurement method of the first embodiment, since the frequency of the drift noise included in the velocity data MV(k) is lower than the minimum value of the natural vibration frequency of the superstructure 7, the cutoff frequency of the high-pass filter processing for the velocity data MV(k) can be set higher than the frequency of the drift noise of the superstructure 7 and lower than the minimum value of the natural vibration frequency. Therefore, according to the measurement method of the first embodiment, the drift noise can be reduced without reducing the signal component and the harmonic component of the natural vibration frequency of the superstructure 7 in the generated measurement data RU(k).

In the measurement method of the first embodiment, since the displacement data MU(k) includes data of a waveform that projects in the positive direction or the negative direction, for example, data of a rectangular waveform, a trapezoidal waveform, or a sine half-wave waveform, the measurement device 1 can generate more appropriate correction data M_{CC}(k) based on features of these waveforms, so that it is possible to improve the estimation accuracy of the generated correction data M_{CC}(k).

### 2. Second Embodiment

Hereinafter, in a second embodiment, the same components as those in the first embodiment will be denoted by the same reference numerals, repetitive description as that in the first embodiment will be omitted or simplified, and contents different from those in the first embodiment will be mainly described.

### 2-1. Configuration of Measurement System

Hereinafter, a measurement system for implementing a measurement method according to the present embodiment will be described by taking a case where the structure is a superstructure of a bridge and the moving object is a railway vehicle as an example.

The configuration of the measurement system according to the second embodiment is the same as that in the first embodiment, and thus illustration and description thereof will be omitted.

Hereinafter, first, basic concept of the measurement method according to the second embodiment executed by the measurement device 1 will be described, and then the details thereof will be described.

### 2-2. Basic Concept of Measurement Method

First, it is assumed that displacement data obtained based on acceleration data output from the sensor 2 is M_{d}(k), and the displacement data M_{d}(k) includes the significant signal M(k) including the vibration component and the drift noise e(k) as in Equation (41). When the number of samples included in the displacement data M_{d}(k) is N, k is an integer from 0 to N−1.

M_{d}(k)=M(k)+e(k) (41)

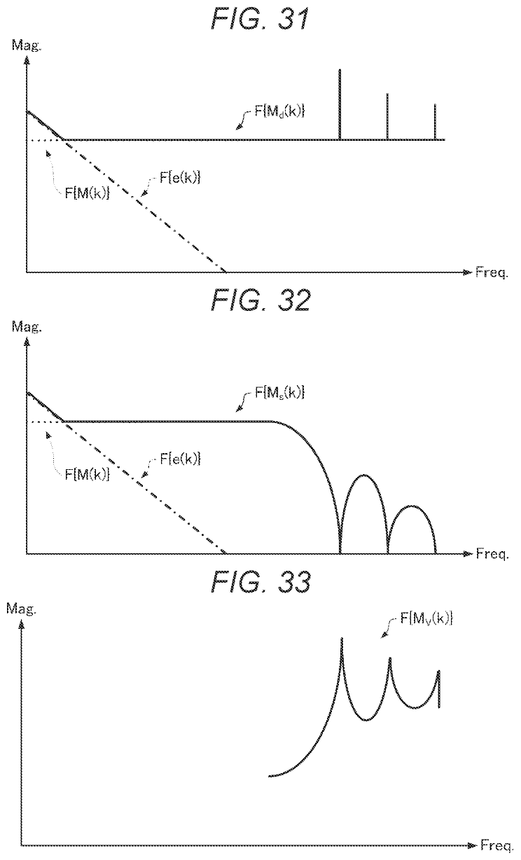

The drift noise e(k) is mainly not a signal input to the sensor 2, but an error signal generated inside the sensor 2, such as a zero-point error, a drift caused by a temperature change, or a drift caused by nonlinear sensitivity. The drift noise e(k) is a variation of a long period as compared with a signal input to the sensor 2, and has an energy distribution in a low frequency range. FIG. 31 shows a relationship of a frequency characteristic F{M_{d}(k)} of the displacement data M_{d}(k), the frequency characteristic F{M(k)} of the signal M(k), and the frequency characteristic F{e(k)} of the drift noise e(k).

The vibration component included in the signal M(k) is, for example, a signal component and a harmonic component of a fundamental frequency generated by natural vibration of the bridge 5, and generally has an energy distribution in a frequency range higher than that of the drift noise e(k). Therefore, as in Equation (42), the displacement data Mₛ(k) in which the vibration component is reduced is obtained by performing low-pass filter processing on the displacement data M_{d}(k).

Mₛ(k)=f_{LP}{M_{d}(k)} (42)

The low-pass filter processing for reducing the vibration component may be processing for performing moving average on the displacement data M_{d}(k) in a cycle corresponding to the fundamental frequency calculated based on the frequency characteristic F{M_{d}(k)}, or may be FIR filter processing for attenuating a signal component of a frequency equal to or higher than the fundamental frequency. The FIR is an abbreviation for finite impulse response. FIG. 32 shows a relationship of a frequency characteristic F{Mₛ(k)} of the displacement data Mₛ(k) which is obtained by performing moving average processing on the displacement data M_{d}(k), the frequency characteristic F{M(k)} of the signal M(k), and the frequency characteristic F{e(k)} of the drift noise e(k).

By subtracting the displacement data Mₛ(k) from the displacement data M_{d}(k) as in Equation (43), data M_{V}(k) including the vibration component is obtained. FIG. 33 shows a frequency characteristic F{MV(k)} of the data M_{V}(k) including the vibration component.

M_{V}(k)=M_{d}(k)−Mₛ(k) (43)

When data obtained by performing high-pass filter processing on the displacement data Mₛ(k) is represented by f_{HP}(Mₛ(k)) and data obtained by performing low-pass filter processing on the displacement data Mₛ(k) is represented by f_{LP}(Mₛ(k)), a relationship of the displacement data Mₛ(k), the data f_{HP}(Mₛ(k)), and the data f_{LP}(Mₛ(k)) is expressed by Equation (44).

Mₛ(k)=f_{HP}(Mₛ(k))+f_{LP}(Mₛ(k)) (44)

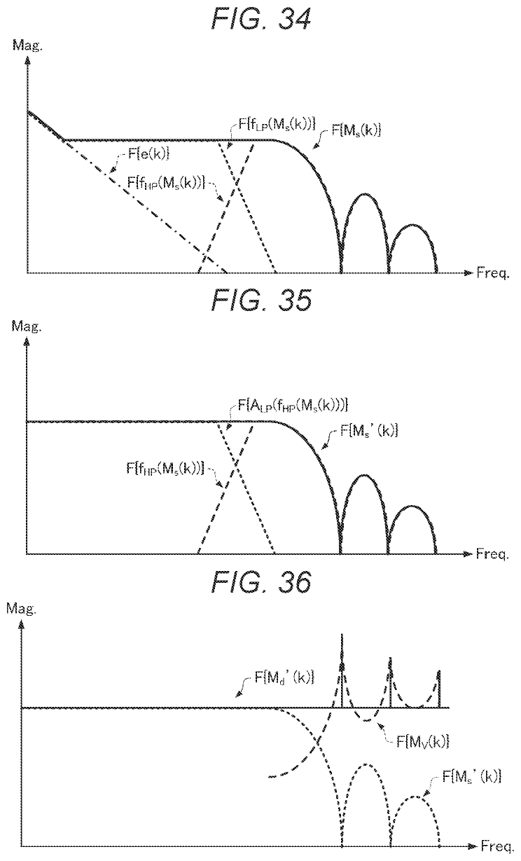

The relationship of the frequency characteristic F{Mₛ(k)} of the displacement data Mₛ(k), the frequency characteristic F{f_{HP}(Mₛ(k))} of the data f_{HP}(Mₛ(k)), and the frequency characteristic F{f_{LP}(Mₛ(k))} of the data f_{LP}(Mₛ(k)) is expressed by Equation (45). FIG. 34 is a diagram showing the relationship of the frequency characteristics F{Mₛ(k)}, F{f_{HP}(Mₛ(k))}, and F{f_{LP}(Mₛ(k))}.

F{Mₛ(k)}=F{f_{HP}(Mₛ(k))}+F{f_{LP}(Mₛ(k))} (45)

Since the drift noise e(k) is observed as an offset error, high-pass filter processing for attenuating a signal in a low frequency range is effective in order to remove the drift noise e(k). It is assumed that, when high-pass filter processing is performed on the displacement data Mₛ(k), the drift noise e(k) having an energy distribution in the low frequency range is sufficiently reduced, and the data f_{HP}(Mₛ(k)) after the high-pass filter processing is substantially equal to the data f_{HP}(M(k)) obtained by performing high-pass filter processing on the signal M(k), as in Equation (46).

f_{HP}(Mₛ(k))≈f_{HP}(M(k)) (46)

Since a signal component in the low frequency range of the signal M(k) is also lost due to the high-pass filter processing, in order to compensate for this signal component, the data f_{LP}(M(k)) obtained by performing low-pass filter processing on the signal M(k) is estimated based on the data f_{HP}(Mₛ(k)) obtained by performing high-pass filter processing on the displacement data Mₛ(k). As in Equation (47), it is assumed that the data f_{LP}(M(k)) obtained by performing low-pass filter processing on the signal M(k) is substantially equal to the data A_{LP}(f_{HP}(Mₛ(k))) obtained by estimating the data f_{LP}(M(k)), that is obtained by performing low-pass filter processing on the signal M(k), based on the data f_{HP}(Mₛ(k)) obtained by performing high-pass filter processing on the displacement data Mₛ(k).

f_{LP}(M(k))≈A_{LP}(f_{HP}(Mₛ(k))) (47)

When it is assumed that, as in Equation (48), the data obtained by removing the drift noise e(k) from the displacement data Mₛ(k) is equal to the sum of the data f_{HP}(Mₛ(k)) obtained by performing high-pass filter processing on the displacement data Mₛ(k) and the data f_{LP}(M(k)) obtained by performing low-pass filter processing on the signal M(k), Equation (49) is obtained based on Equation (46), Equation (47), and Equation (48).

Mₛ(k)−e(k)=f_{HP}(Mₛ(k))+f_{LP}(M(k)) (48)

Mₛ(k)−e(k)≈Mₛ′(k)=f_{HP}(Mₛ(k))+A_{LP}(f_{HP}(Mₛ(k))) (49)

According to Equation (49), a relationship of a frequency characteristic F{Mₛ′(k)} of the data Mₛ′(k) the frequency characteristic F{f_{HP}(Mₛ(k))} of the data f_{HP}(Mₛ(k)), and a frequency characteristic F{A_{LP}(f_{HP}(Mₛ(k)))} of the data A_{LP}(f_{HP}(Mₛ(k))) is expressed by Equation (50). FIG. 35 shows a relationship of the frequency characteristics F{Mₛ′(k)}, F{f_{HP}(Mₛ(k))}, and F{A_{LP}(f_{HP}(Mₛ(k)))}.

F{Mₛ′(k))}=F{f_{HP}(Mₛ(k))}+F{A_{LP}(f_{HP}(Mₛ(k)))} (50)

As in Equation (51), data M_{d}′(k) approximate to the signal M(s) is obtained by adding the data Mₛ′(k) obtained by Equation (49) and the data M_{V}(k) including the vibration component. FIG. 36 shows a relationship of the frequency characteristics F{M_{d}′(k)}, F{Mₛ′(k)}, and F{M_{V}(k)}.

M(k)≈M_{d}′(k)=Mₛ′(k)+M_{V}(k) (51)

Since the data f_{HP}(Mₛ(k)) in which the drift noise e(k) is reduced is obtained by performing high-pass filter processing on the displacement data Mₛ(k) the data f_{LP}(M(k)) obtained by performing low-pass filter processing on the signal M(k) is estimated based on the data f_{HP}(Mₛ(k)) and the signal M(k) in which the drift noise e(k) is reduced can be obtained by adding the data f_{HP}(Mₛ(k)) the estimated data, and the data M_{V}(k) including the vibration component. When a unit pulse waveform obtained by simplifying a deflection displacement when the railway vehicle 6 passes through the superstructure 7 of the bridge 5 is assumed as the displacement data Mₛ(k), as described above, the data f_{LP}(M(k)) obtained by performing low-pass filter processing on the signal M(k) can be estimated by comparing the data f_{HP}(Mₛ(k)) obtained by performing high-pass filter processing on the displacement data Mₛ(k) with the data f_{LP}(Mₛ(k)) obtained by performing low-pass filter processing on the displacement data Mₛ(k).

### 2-3. Details of Measurement Method

Actually, the displacement data of the deflection when the railway vehicle 6 passes through the superstructure 7 of the bridge 5 includes data of a waveform that projects in a positive direction or a negative direction and is different from the unit pulse waveform, but the data f_{LP}(M(k)) obtained by performing low-pass filter processing on the signal M(k) can be estimated based on the estimation method described above. For example, the waveform that projects in the positive direction or the negative direction is a rectangular waveform, a trapezoidal waveform, or a sine half-wave waveform.

First, the measurement device 1 generates velocity data MV(k) based on observation data observed by the observation device. In the present embodiment, the sensor 2, which is an acceleration sensor, is the observation device, and the observation data is acceleration data Aₘ(k) output from the sensor 2. In this case, the measurement device 1 integrates the acceleration data Aₘ(k), which is the observation data, to generate the velocity data MV(k), as in Equation (14). However, the observation device may be a device other than the acceleration sensor, and may be, for example, a displacement meter or a velocity sensor. When the observation device is a displacement meter, the measurement device 1 differentiates the displacement data Uₘ(k), which is observation data, to generate the velocity data MV(k), as in Equation (15). When the observation device is a velocity sensor, the measurement device 1 sets velocity data output from the velocity sensor as the velocity data MV(k). The velocity data MV(k) is, for example, similar as that in FIG. 13, and thus illustration thereof is omitted.

Next, in order to reduce the vibration component and the harmonic component of the fundamental frequency F_{f} included in the velocity data MV(k), the measurement device 1 generates velocity data MVₛ(k) obtained by performing low-pass filter processing on the velocity data MV(k).

Specifically, first, the measurement device 1 calculates a power spectrum density by performing fast Fourier transform processing on the velocity data MV(k), and calculates a peak of the power spectrum density as the fundamental frequency F_{f}. The power spectrum density of the velocity data MV(k) is, for example, similar to that in FIG. 14, and thus illustration thereof is omitted. Then, the measurement device 1 calculates a basic cycle T_{f} based on the fundamental frequency F_{f} according to Equation (52), and calculates a moving average interval k_{mf} adjusted to a time resolution of the data by dividing the basic cycle T_{f} by ΔT as in Equation (53). The basic cycle T_{f} is a cycle corresponding to the fundamental frequency F_{f}, and T_{f}>2ΔT.

$${T}_{f} = \frac{1}{{F}_{f}} \qquad ( 52 )$$

$${k}_{m f} = 2 ⌊ \frac{{T}_{f}}{2 Δ T} ⌋ + 1 \qquad ( 53 )$$

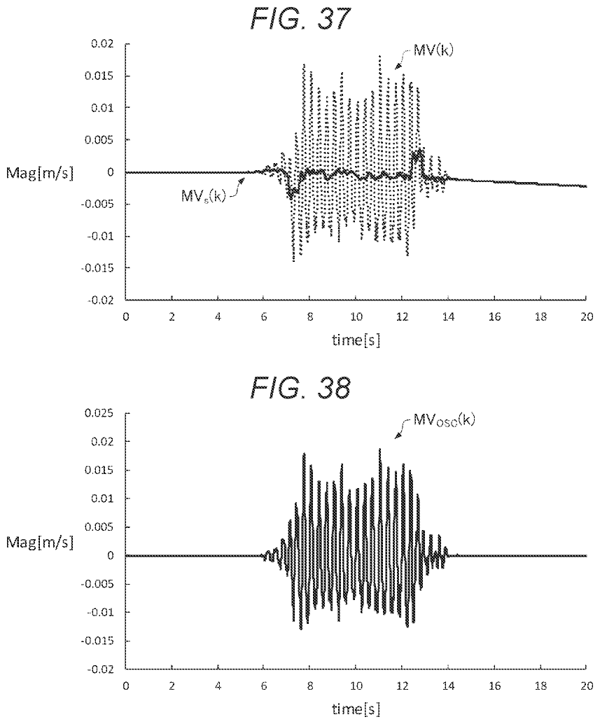

Then, the measurement device 1 performs, as low-pass filter processing, moving average processing on the velocity data MV(k) in the basic cycle T_{f} according to Equation (54), and generates the velocity data MVₛ(k) as vibration component reduction data in which the vibration component is reduced. In the moving average processing, not only the necessary calculation amount is small, but also an attenuation amount of the signal component and the harmonic component of the fundamental frequency F_{f} is very large, so that the velocity data MVₛ(k) in which the vibration component is effectively reduced is obtained. FIG. 37 shows an example of the velocity data MVₛ(k). As shown in FIG. 37, the velocity data MVₛ(k) from which almost all vibration components included in the velocity data MV(k) are removed is obtained.

$$M {V}_{s} ( k ) = \frac{1}{{k}_{m f}} {\sum }_{n = k - \frac{{k}_{m f} - 1}{2}}^{k + \frac{{k}_{m f} - 1}{{2}^{}}} M V ( n ) \qquad ( 54 )$$

The measurement device 1 may generate the velocity data MVₛ(k) by performing, as the low-pass filter processing, FIR filter processing for attenuating a signal component having a frequency equal to or higher than the basic cycle T_{f} with respect to the velocity data MV(k). The FIR is an abbreviation for finite impulse response. Although the FIR filter processing has a larger calculation amount than the moving average processing, all signal components of a frequency equal to or higher than the fundamental frequency F_{f} can be attenuated.

Next, the measurement device 1 subtracts the velocity data MVₛ(k) in which the vibration component is reduced from the velocity data MV(k) according to Equation (55) to generate vibration velocity component data MV_{OSC}(k) including the vibration component. FIG. 38 shows an example of vibration velocity component data MV_{OSC}(k).

MV_{osc}(k)=MV(k)—MVₛ(k) (55)

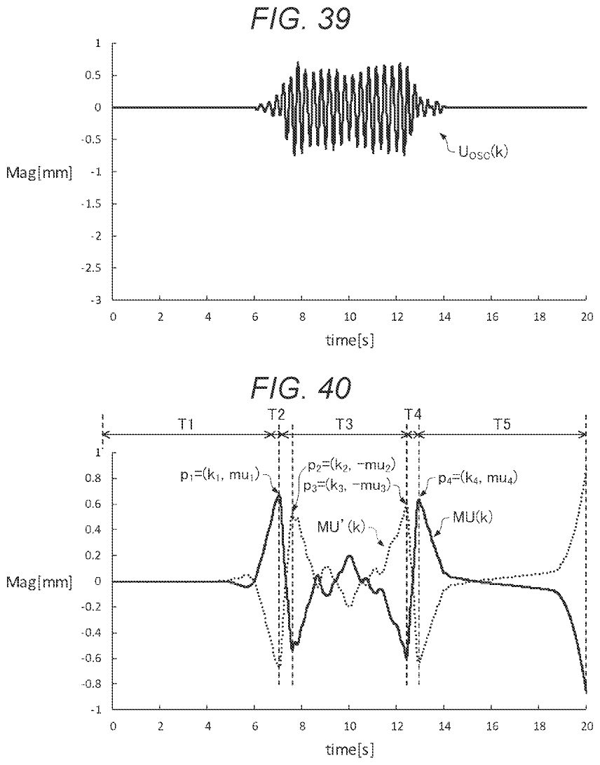

The measurement device 1 integrates the vibration velocity component data MV_{OSC}(k) to generate vibration displacement component data U_{OSC}(k) according to Equation (56). In Equation (56), ΔT is a time interval of data. FIG. 39 shows an example of the vibration displacement component data U_{OSC}(k).

U_{osc}(k)=MV_{osc}(k)ΔT+U_{osc}(k−1) (56)

Next, the measurement device 1 generates the velocity data MVH(k), that is obtained by performing high-pass filter processing on the velocity data MVₛ(k) in order to reduce the drift noise, as in Equation (57). The measurement device 1 performs the high-pass filter processing using a frequency lower than the fundamental frequency F_{f} as a cutoff frequency.

MVH(k)=f_{HP}(MVₛ(k)) (57)

Next, the measurement device 1 integrates the velocity data MVH(k) to generate the displacement data MU(k) as in Equation (58). FIG. 40 shows an example of the displacement data MU(k).

MU(k)=MVH(k)ΔT+MU(k−1) (58)

In the present embodiment, as described above, the displacement data MU(k) is generated by integrating the velocity data MVH(k) obtained by performing high-pass filter processing on the velocity data MVₛ(k) instead of being generated by performing high-pass filter processing on the displacement data obtained by integrating the velocity data MVₛ(k).

Next, based on the displacement data MU(k), the measurement device 1 estimates data f_{LP}(M(k)) obtained by performing low-pass filter processing on the significant signal M(k) included in displacement data obtained when the velocity data MVₛ(k) is virtually integrated, that is, correction data M_{CC}(k) corresponding to a difference between the displacement data MU(k) and data obtained by subtracting drift noise from data obtained by integrating the velocity data MVₛ(k).

As shown in FIG. 40, in the present embodiment, the measurement device 1 specifies the first interval T1, the second interval T2, the third interval T3, the fourth interval T4, and the fifth interval T5 based on the displacement data MU(k), and generates the correction data M_{CC}(k) by dividing correction data M_{CC}(k) into these five intervals. In order to specify the first interval T1, the second interval T2, the third interval T3, the fourth interval T4, and the fifth interval T5, the measurement device 1 calculates the first peak p₁=(k₁, mu₁) and the fourth peak p₄=(k₄, mu₄) of the displacement data MU(k) and the second peak p₂=(k₂, −mu₂) and the third peak p₃=(k₃, −mu₃) of the data MU′(k) obtained by inverting a sign of the displacement data MU(k). As shown in FIG. 40, the first peak p₁ is a head peak near a time point when the railway vehicle 6 enters the superstructure 7, and the fourth peak p₄ is a tail peak near a time point when the railway vehicle 6 exits the superstructure 7. The second peak p₂ is a second peak following the head, and the third peak p₃ is a second peak prior to the tail.

The first interval T1 is an interval before the first peak p₁, that is, an interval of k≤k₁. The second interval T2 is an interval between the first peak p₁ and the second peak p₂, that is, an interval of k₁<k<k₂. The third interval T3 is an interval between the second peak p₂ and the third peak p₃, that is, an interval of k₂≤k≤k₃. The fourth interval T4 is an interval between the third peak p₃ and the fourth peak p₄, that is, an interval of k₃<k<k₄.

As in Equation (59), the correction data M_{CC}(k) is obtained as a sum of first interval correction data M_{CC1}(k) which is correction data of the first interval T1, second interval correction data M_{CC2}(k) which is correction data of the second interval T2, third interval correction data M_{CC3}(k) which is correction data of the third interval T3, fourth interval correction data M_{CC4}(k) which is correction data of the fourth interval T4, and fifth interval correction data M_{CC5}(k) which is correction data of the fifth interval T5.

M_{CC}(k)=M_{CC1}(k)+M_{CC2}(k)+M_{CC3}(k)+M_{CC4}(k)+M_{CC5}(k) (59)

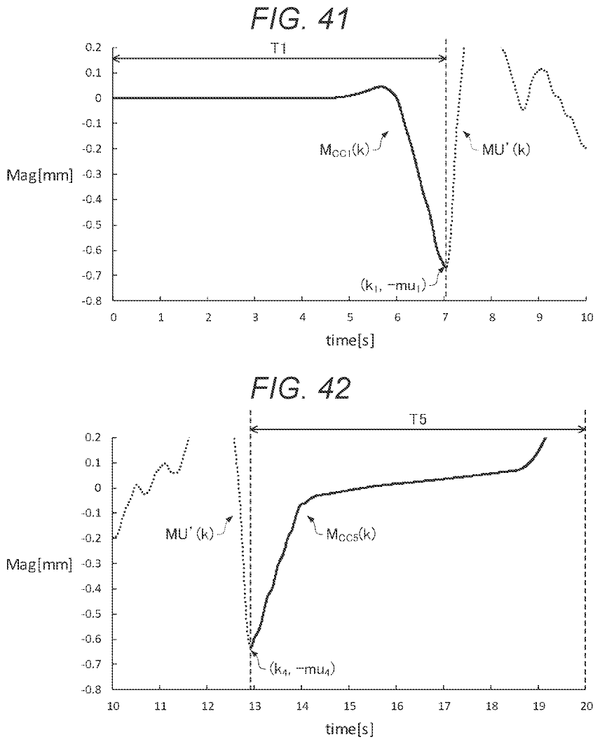

The first interval correction data M_{CC1}(k) is obtained according to Equation (60) using data MU′(k) obtained by inverting a sign of the displacement data MU(k). Similarly, the fifth interval correction data M_{CC5}(k) is obtained according to Equation (61) using the data MU′(k) obtained by inverting the sign of the displacement data MU(k). FIG. 41 shows an example of the first interval correction data M_{CC1}(k). FIG. 42 shows an example of the fifth interval correction data M_{CC5}(k).

$${M}_{C C 1} ( k ) = \{ \begin{matrix}k \leq {k}_{1} & M {U}^{′} ( k ) \\ {k}_{1} < k & 0\end{matrix} = \{ \begin{matrix}k \leq {k}_{1} & - M U ( k ) \\ {k}_{1} < k & 0\end{matrix} \qquad ( 60 )$$

$${M}_{C C 5} ( k ) = \{ \begin{matrix}k < {k}_{4} & 0 \\ {k}_{4} \leq k & M {U}^{′} ( k )\end{matrix} = \{ \begin{matrix}k < {k}_{4} & 0 \\ {k}_{4} \leq k & - MU ( k )\end{matrix} \qquad ( 61 )$$

The second interval correction data M_{CC2}(k) is obtained as follows. First, the measurement device 1 sets a minimum value of the data −MVH(k) obtained by inverting a sign of the velocity data MVH(k) in the first interval T1 as a first-order coefficient s₁, and generates first line data L1(k) passing through a point (k₁, −mu₁) obtained by inverting a sign of an amplitude of the first peak p₁=(k₁, mu₁). The first line data L1(k) is expressed by Equation (62). The first-order coefficient s₁ is expressed by Equation (63).

L1(k)=s₁k+i₁ (62)

s₁={k≤k₁ min{−MVH(k)} (63)

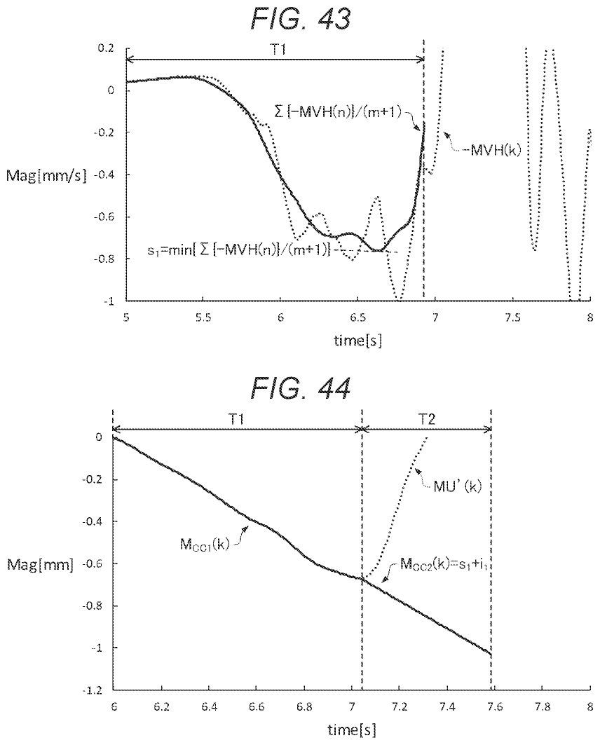

When the data −MVH(k) fluctuates in the first interval T1, moving average processing may be performed on the data −MVH(k) and the minimum value of the data −MVH(k) in the first interval T1 may be set as the first-order coefficient s₁, as in Equation (64). FIG. 43 shows a relationship between the data −MVH(k) and the first-order coefficient s₁.

$${s}_{1} = \{ k \leq {k}_{1} min \{ \frac{1}{m + 1} {\sum }_{n = k - \frac{m}{2}}^{k + \frac{m}{2}} - MVH ( n ) \} \qquad ( 64 )$$

At k=k₁, the first line data L1(k) passes through a point (k₁, −mu₁) obtained by inverting the sign of the amplitude of the first peak p₁=(k₁, mu₁), so that a coefficient i₁ of Equation (62) is obtained according to Equation (65).

i₁=−s₁k₁−mu₁ (65)

Equation (66) is obtained by substituting Equation (62) into Equation (65).

L1(k)=s₁k−s₁k₁−mu₁ (66)

The second interval correction data M_{CC2}(k) is obtained as the first line data L1(k) in the second interval T2 as in Equation (67). FIG. 44 shows an example of the second interval correction data M_{CC2}(k).

$${M}_{C C 2} ( k ) = \{ \begin{matrix}k \leq {k}_{1} & 0 \\ {k}_{1} < k < {k}_{2} & L 1 ( k ) \\ {k}_{2} \leq k & 0\end{matrix} = \{ \begin{matrix}k \leq {k}_{1} & 0 \\ {k}_{1} < k < {k}_{2} & {s}_{1} k - {s}_{1} {k}_{1} - m {u}_{1} \\ {k}_{2} \leq k & 0\end{matrix} \qquad ( 67 )$$

The fourth interval correction data M_{CC4}(k) is obtained as follows. First, the measurement device 1 sets a maximum value of the data −MVH(k) obtained by inverting the sign of the velocity data MVH(k) in the fifth interval T5 as a first-order coefficient s₂, and generates the second line data L2(k) passing through a point (k₄, −mu₄) obtained by inverting a sign of an amplitude of the fourth peak p₄=(k₄, mu₄). The second line data L2(k) is expressed by Equation (68). The first-order coefficient s₂ is expressed by Equation (69).

L2(k)=s₂k+i₂ (68)

s₂={k₄≤k max{−MVH(k)} (69)

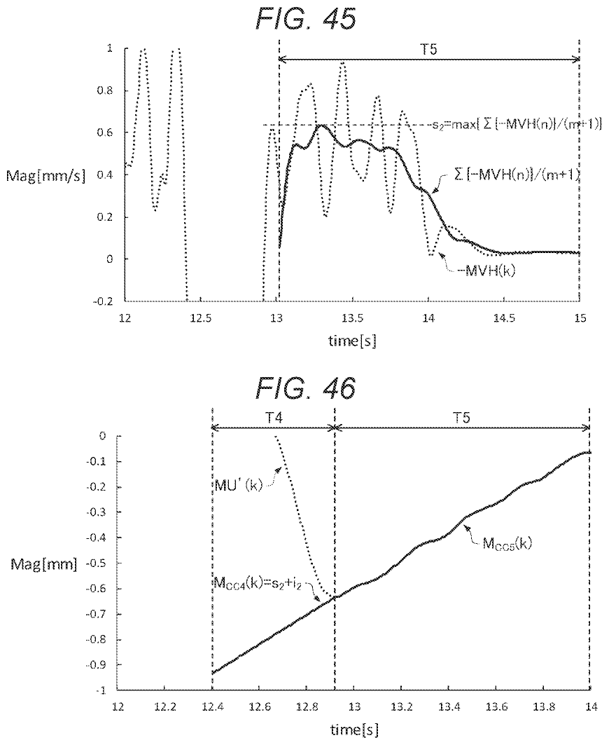

When the data −MVH(k) fluctuates in the fifth interval T5, moving average processing may be performed on the data −MVH(k) and a maximum value of the data −MVH(k) in the fifth interval T5 may be set as the first-order coefficient s₂, as in Equation (70). FIG. 45 shows a relationship between the data −MVH(k) and the first-order coefficient s₂.

$${s}_{2} = \{ {k}_{4} \leq k max \{ \frac{1}{m + 1} {\sum }_{n = k - \frac{m}{2}}^{k + \frac{m}{2}} - M V H ( n ) \} \qquad ( 70 )$$

At k=k₄, the second line data L2(k) passes through a point (k₄, −mu₄) obtained by inverting a sign of an amplitude of the fourth peak p₄=(k₄, mu₄), so that the coefficient i₂ of Equation (68) is obtained according to Equation (71).

i₂=−s₂k₄−mu₄ (71)

Equation (72) is obtained by substituting Equation (71) into Equation (68).

L2(k)=s₂k−s₂k₄−mu₄ (72)

The fourth interval correction data M_{CC4}(k) is obtained as the second line data L2(k) in the fourth interval T4 as in Equation (73). FIG. 46 shows an example of the fourth interval correction data M_{CC4}(k).

$${M}_{C C 4} ( k ) = \{ \begin{matrix}k \leq {k}_{3} & 0 \\ {k}_{3} < k < {k}_{4} & L 2 ( k ) \\ {k}_{4} \leq k & 0\end{matrix} = \{ \begin{matrix}k \leq {k}_{3} & 0 \\ {k}_{3} < k < {k}_{4} & {s}_{2} k - {s}_{2} {k}_{4} - {mu}_{4} \\ {k}_{4} \leq k & 0\end{matrix} \qquad ( 73 )$$

The third interval correction data M_{CC3}(k) is obtained as follows. First, the measurement device 1 generates third line data L3(k) passing through a point p₇ having an amplitude that is a difference between the amplitude of the first line data L1(k) and the amplitude of the data MU′(k) obtained by inverting the sign of the displacement data MU(k) at the time point of the second peak p₂, that is, k=k₂, and a point p₈ having an amplitude that is a difference between the amplitude of the second line data L2(k) and the amplitude of the data MU′(k) obtained by inverting the sign of the displacement data MU(k) at the time point of the third peak p₃, that is, k=k₃.

The point p₇ corresponds to a difference between an amplitude L1(k₂) of a point p₅ (k₂, L1(k₂)) on the first line data L1(k) and an amplitude −mu₂ of the second peak p₂=(k₂, −mu₂) of the data MU′(k) at k=k₂, and is obtained as in Equation (74).

p₇=(k₂,L1(k₂)+mu₂)=(k₂,s₁k₂−s₁k₁−mu₁+mu₂) (74)

The point p₈ corresponds to a difference between an amplitude L2(k₃) of a point p₆(k₃, L2(k₃)) on the second line data L2(k) and an amplitude −mu₃ of the third peak p₃=(k₃, mu₃) of the data MU′(k) at k=k₃, and is obtained as in Equation (75).

p₈=(k₃,L2(k₃)+mu₃)=(k₃,s₂k₃−s₂k₄−mu₄+mu₃) (75)

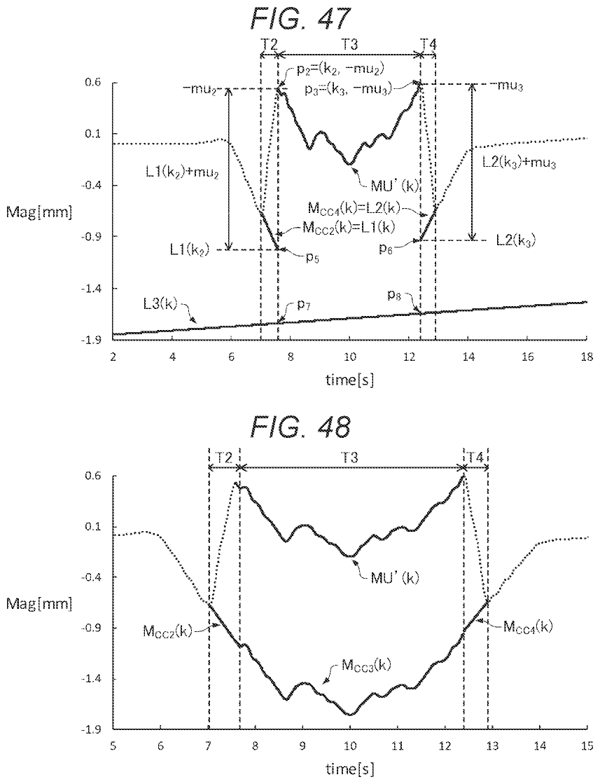

The third line data L3(k) passing through the point p₇ and the point p₈ is obtained according to Equation (76). FIG. 47 shows an example of the third line data L3(k).

$$L 3 ( k ) = \frac{L 2 ( {k}_{3} ) + m {u}_{3} - ( L 1 ( {k}_{2} ) + m {u}_{2} )}{{k}_{3} - {k}_{2}} k + L 1 ( {k}_{2} ) + m {u}_{2} - \frac{L 2 ( {k}_{3} ) + m {u}_{3} - ( L 1 ( {k}_{2} ) + m {u}_{2} )}{{k}_{3} - {k}_{2}} {k}_{2} \qquad ( 76 )$$

As in Equation (77), the measurement device 1 adds the data MU′(k) obtained by inverting the sign of the displacement data MU(k) and the third line data L3(k) in the third interval T3 to generate the third interval correction data M_{CC3}(k). FIG. 48 shows an example of the third interval correction data M_{CC3}(k).

$${M}_{C C 3} ( k ) = \{ \begin{matrix}k < {k}_{2} & 0 \\ {k}_{2} \leq k \leq {k}_{3} & M {U}^{′} ( k ) + L 3 ( k ) \\ {k}_{3} < k & 0\end{matrix} = \{ \begin{matrix}k < {k}_{2} & 0 \\ {k}_{2} \leq k \leq {k}_{3} & - MU ( k ) + L 3 ( k ) \\ {k}_{3} < k & 0\end{matrix} \qquad ( 77 )$$

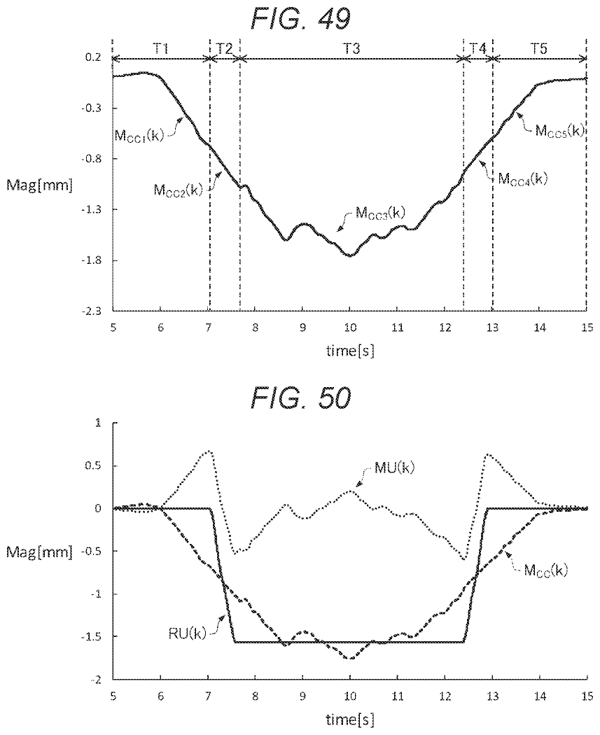

The correction data M_{CC}(k) is obtained as in Equation (78) by substituting Equation (60), Equation (61), Equation (67), Equation (73), and Equation (77) into Equation (59). FIG. 49 shows an example of correction data M_{CC}(k).

$${M}_{C C} ( k ) = \{ \begin{matrix}k \leq {k}_{1} & {M}_{C C 1} ( k ) \\ {k}_{1} < k < {k}_{2} & {M}_{C C 2} ( k ) \\ {k}_{2} \leq k \leq {k}_{3} & {M}_{C C 3} ( k ) \\ {k}_{3} < k < {k}_{4} & {M}_{C C 4} ( k ) \\ {k}_{4} \leq k & {M}_{C C 5} ( k )\end{matrix} = \{ \begin{matrix}k \leq {k}_{1} & - MU ( k ) \\ {k}_{1} < k < {k}_{2} & {s}_{1} k - {s}_{1} {k}_{1} - m {u}_{1} \\ {k}_{2} \leq k \leq {k}_{3} & - MU ( k ) + L 3 ( k ) \\ {k}_{3} < k < {k}_{4} & {s}_{2} k - {s}_{2} {k}_{4} - m {u}_{4} \\ {k}_{4} \leq k & - MU ( k )\end{matrix} \qquad ( 78 )$$

Then, as in Equation (79), the displacement data MU(k) and the correction data M_{CC}(k) are added to obtain the displacement data RU(k) in which the vibration component and the drift noise are reduced.

RU(k)=MU(k)+M_{CC}(k) (79)

Equation (80) is obtained by substituting Equation (78) into Equation (79).

$$R U ( k ) = \{ \begin{matrix}k \leq {k}_{1} & 0 \\ {k}_{1} < k < {k}_{2} & MU ( k ) + {s}_{1} k - {s}_{1} {k}_{1} - m {u}_{1} \\ {k}_{2} \leq k \leq {k}_{3} & L 3 ( k ) \\ {k}_{3} < k < {k}_{4} & MU ( k ) + {s}_{2} k - {s}_{2} {k}_{4} - m {u}_{4} \\ {k}_{4} \leq k & 0\end{matrix} \qquad ( 80 )$$

According to Equation (80), the displacement data RU(k) is 0 in the interval of k≤k₁ which is the first interval T1 and the interval of k₂≤k which is the fifth interval T5, and the displacement data RU(k) from which the vibration component and the drift noise is removed is obtained. FIG. 50 shows an example of the displacement data RU(k).

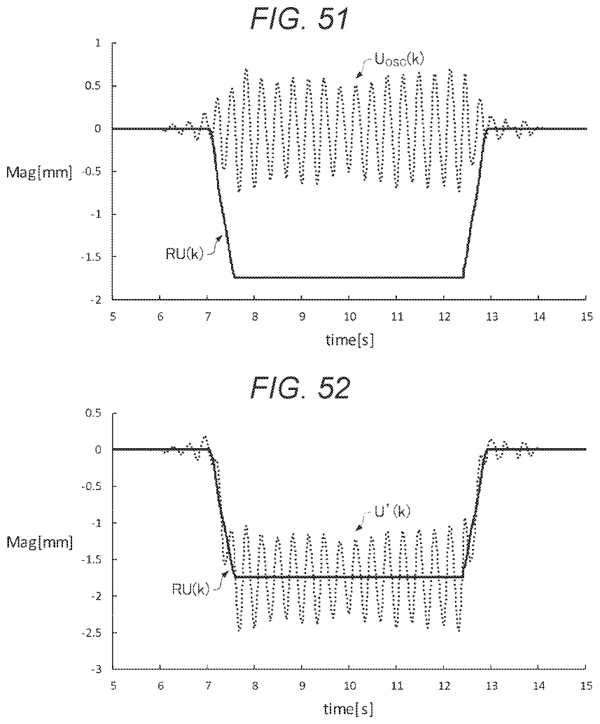

Then, as in Equation (81), the displacement data RU(k) and the vibration displacement component data U_{OSC}(k) are added to obtain the measurement data U′(k) which is the displacement data in which the drift noise is reduced. FIG. 51 shows an example of the displacement data RU(k) and the vibration displacement component data U_{OSC}(k). FIG. 52 shows an example of the measurement data U′(k).

U′(k)=RU(k)+U_{osc}(k) (81)

Equation (82) is obtained by substituting Equation (80) into Equation (81).

$${U}^{′} ( k ) = \{ \begin{matrix}k \leq {k}_{1} & {U}_{o s c} ( k ) \\ {k}_{1} < k < {k}_{2} & MU ( k ) + {s}_{1} k - {s}_{1} {k}_{1} - m {u}_{1} + {U}_{o s c} ( k ) \\ {k}_{2} \leq k \leq {k}_{3} & L 3 ( k ) + {U}_{o s c} ( k ) \\ {k}_{3} < k < {k}_{4} & MU ( k ) + {s}_{2} k - {s}_{2} {k}_{4} - m {u}_{4} + {U}_{o s c} ( k ) \\ {k}_{4} \leq k & {U}_{o s c} ( k )\end{matrix} \qquad ( 82 )$$

In order to confirm an effect of removing the drift noise by the measurement method of the present embodiment, a waveform obtained by adding the drift noise D(k) to the displacement waveform UO(k) as in Equation (40) is used as the evaluation waveform U(k). An example of the displacement waveform UO(k) and the drift noise D(k) is similar to that in FIG. 23, and thus illustration thereof is omitted. An example of the evaluation waveform U(k) is similar to that in FIG. 24, and thus illustration thereof is omitted.

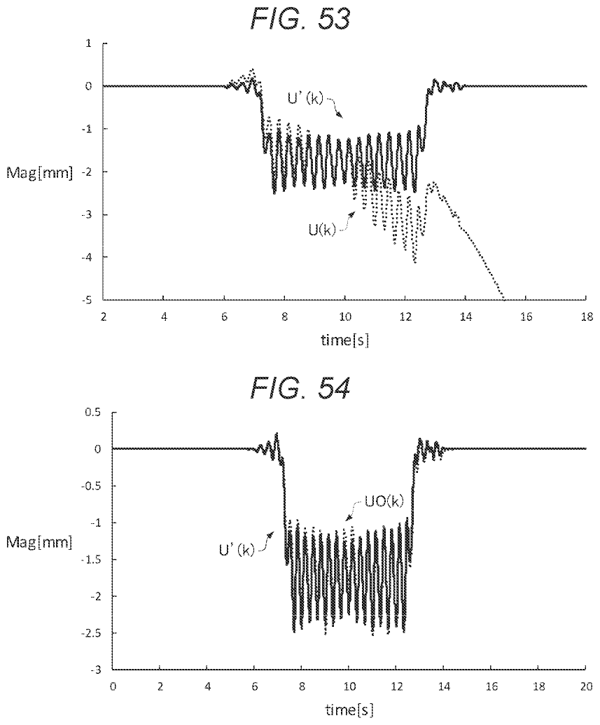

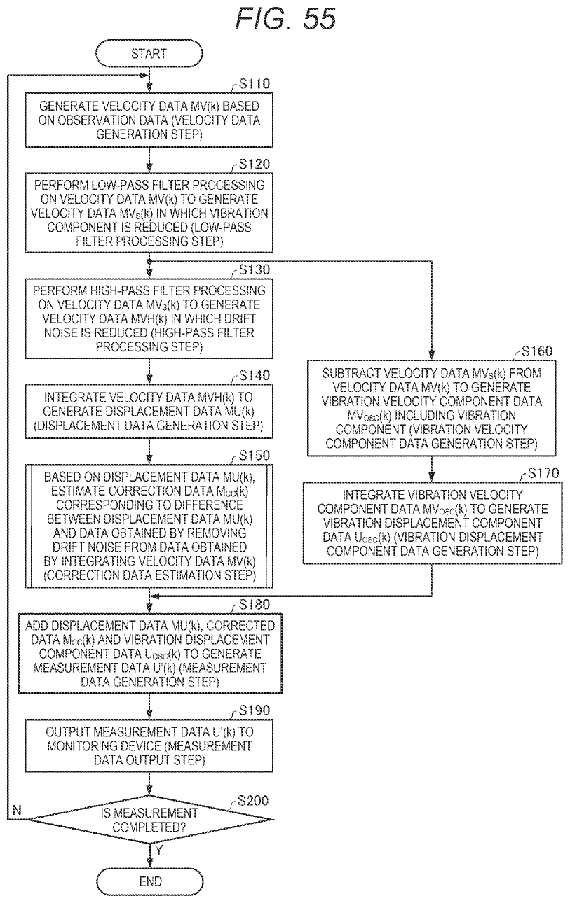

Data obtained by differentiating the evaluation waveform U(k) is defined as velocity data MV(k), and the measurement data U′(k) obtained according to Equations (52) to (80) is compared with the displacement waveform UO(k). FIG. 53 shows the measurement data U′(k). FIG. 54 shows the measurement data U′(k) and the displacement waveform UO(k) in an overlapping manner. As shown in FIGS. 53 and 54, it can be confirmed that the measurement data U′(k) in which the drift noise is removed and the displacement waveform is restored is obtained by the measurement method according to the present embodiment.

### 2-4. Procedure of Measurement Method

FIG. 55 is a flowchart showing an example of a procedure of the measurement method of the second embodiment for measuring the displacement of the superstructure 7 of the bridge 5. In the present embodiment, the measurement device 1 executes the procedure shown in FIG. 55.

As shown in FIG. 55, first, in a velocity data generation step S110, the measurement device 1 generates the velocity data MV(k) based on the observation data. The velocity data MV(k) is data based on the observation data observed by the observation device. Specifically, when the observation data is acceleration data, the measurement device integrates the observation data to generate the velocity data MV(k) as in Equation (14), when the observation data is displacement data, the measurement device 1 differentiates the observation data to generate the velocity data MV(k) as in Equation (15), and when the observation data is velocity data, the measurement device 1 sets the observation data as the velocity data MV(k). In the present embodiment, the velocity data MV(k) is data of a displacement velocity of the superstructure 7 caused by the railway vehicle 6 which is the moving object moving on the superstructure 7 which is the structure.

Next, in a low-pass filter processing step S120, the measurement device 1 performs low-pass filter processing on the velocity data MV(k) including the drift noise and the vibration component generated in step S110 to generate the velocity data MVₛ(k) as vibration component reduction data in which the vibration component is reduced. For example, the measurement device 1 may calculate the fundamental frequency F_{f} by performing fast Fourier transform processing on the velocity data MV(k), and may generate the velocity data MVₛ(k) by performing moving average processing, as the low-pass filter processing, on the velocity data MV(k) in the basic cycle T_{f} corresponding to the fundamental frequency F_{f}, as in Equation (54). For example, the measurement device 1 may calculate the fundamental frequency F_{f} by performing fast Fourier transform processing on the velocity data MV(k), and may generate the velocity data MVₛ(k) by performing FIR filter processing, as the low-pass filter processing, for attenuating a signal component having a frequency equal to or higher than the fundamental frequency F_{f} on the velocity data MV(k).

Next, in a high-pass filter processing step S130, the measurement device 1 performs high-pass filter processing on the velocity data MVₛ(k) including the drift noise and generated in step S120, so as to generate the velocity data MVH(k) as drift noise reduction data in which the drift noise is reduced, as in Equation (57). Specifically, the measurement device 1 performs the high-pass filter processing using a frequency lower than the fundamental frequency F_{f} as the cutoff frequency. The high-pass filter processing of the velocity data MVₛ(k) may be processing of subtracting data, that is obtained by performing low-pass filter processing on the velocity data MVₛ(k), from the velocity data MVₛ(k). The low-pass filter processing may be moving average processing or FIR filter processing. The FIR is an abbreviation for finite impulse response. That is, the high-pass filter processing of the velocity data MVₛ(k) may be processing of subtracting data, that is obtained by performing moving average processing or FIR filter processing on the velocity data MVₛ(k), from the velocity data MVₛ(k).

Next, in a displacement data generation step S140, the measurement device 1 integrates the velocity data MVH(k) generated in step S130 to generate the displacement data MU(k), as in Equation (58). In the present embodiment, the displacement data MU(k) is data of the displacement of the superstructure 7 caused by the railway vehicle 6 moving on the superstructure 7, and includes data of a waveform that projects in the positive direction or the negative direction, specifically, data of a rectangular waveform, a trapezoidal waveform, or a sine half-wave waveform. The rectangular waveform includes not only an accurate rectangular waveform but also a waveform approximate to the rectangular waveform. Similarly, the trapezoidal waveform includes not only an accurate trapezoidal waveform but also a waveform approximate to the trapezoidal waveform. Similarly, the sine half-wave waveform includes not only an accurate sine half-wave waveform but also a waveform approximate to the sine half-wave waveform.

Next, in a correction data estimation step S150, the measurement device 1 estimates, based on the displacement data MU(k) generated in step S140, the correction data M_{CC}(k) corresponding to the difference between the displacement data MU(k) and the data obtained by removing the drift noise from the data obtained by integrating the velocity data MVₛ(k). Specifically, the measurement device 1 generates the correction data M_{CC}(k) by performing calculations of Equations (59) to (78).

In a vibration velocity component data generation step S160, the measurement device 1 subtracts the velocity data MVₛ(k) generated in step S120 from the velocity data MV(k) generated in step S110, so as to generate the vibration velocity component data MV_{OSC}(k) including the vibration component, as in Equation (55). In the present embodiment, a frequency of the drift noise included in the velocity data MVₛ(k) is lower than a minimum value of the natural vibration frequency of the superstructure 7. The minimum value of the natural vibration frequency of the superstructure 7 is, for example, a frequency of a first-order vibration mode in a longitudinal direction of the superstructure 7. By setting the cutoff frequency of low-pass filter processing in step S120 and the cutoff frequency of high-pass filter processing in step S130 to be higher than the frequency of the drift noise of the superstructure 7 and lower than the minimum value of the natural vibration frequency, the drift noise in the vibration velocity component data MV_{OSC}(k) generated in step S160 is reduced without reducing the signal component and the harmonic component of the natural vibration frequency of the superstructure 7. For example, the frequency of the drift noise may be less than 1 Hz, and the cutoff frequency of the low-pass filter processing and the cutoff frequency of the high-pass filter processing may be 1 Hz or more.

Next, in a vibration displacement component data generation step S170, the measurement device 1 integrates the vibration velocity component data MV_{OSC}(k) generated in step S160 to generate the vibration displacement component data U_{OSC}(k) as in Equation (56).

Next, in a measurement data generation step S180, the measurement device 1 generates the measurement data U′(k) by adding the displacement data MU(k) generated in step S140, the correction data M_{CC}(k) generated in step S150, and the vibration displacement component data U_{OSC}(k) generated in step S170, as in Equations (79) and (81).

Next, in a measurement data output step S190, the measurement device 1 outputs the measurement data U′(k) generated in step S180 to the monitoring device 3. Specifically, the measurement device 1 transmits the measurement data U′(k) to the monitoring device 3 via the communication network 4.

Then, in step S200, the measurement device 1 repeats the processing of steps S110 to S190 until the measurement of the displacement of the superstructure 7 of the bridge 5 is completed.

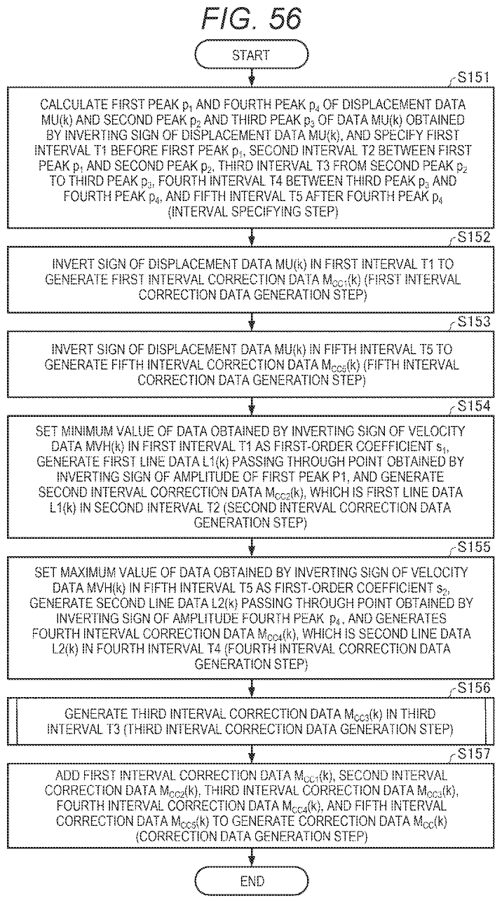

FIG. 56 is a flowchart showing an example of a procedure of the correction data estimation step S150 in FIG. 55.

As shown in FIG. 56, first, in an interval specifying step S151, the measurement device 1 calculates the first peak p₁=(k₁, mu₁) and the fourth peak p₄=(k₄, mu₄) of the displacement data MU(k) and the second peak p₂=(k₂, mu₂) and the third peak p₃=(k₃, mu₃) of the data MU′(k) obtained by inverting the sign of the displacement data MU(k), and specifies the first interval T1 before the first peak p₁, the second interval T2 between the first peak p₁ and the second peak p₂, the third interval T3 from the second peak p₂ to the third peak p₃, the fourth interval T4 between the third peak p₃ and the fourth peak p₄, and the fifth interval T5 after the fourth peak p₄. That is, the first interval T1 is an interval of k≤k₁, the second interval T2 is an interval of k₁<k<k₂, the third interval T3 is an interval of k₂≤k≤k₃, the fourth interval T4 is an interval of k₃<k<k₄, and the fifth interval T5 is an interval of k₄≤k. In the present embodiment, the first peak p₁ is the head peak near the time point when the railway vehicle 6 enters the superstructure 7, and the fourth peak p₄ is the tail peak near the time point when the railway vehicle 6 exits the superstructure 7. The second peak p₂ is a second peak following the head, and the third peak p₃ is a second peak prior to the tail.

Next, in a first interval correction data generation step S152, the measurement device 1 inverts the sign of the displacement data MU(k) in the first interval T1 to generate the first interval correction data M_{CC1}(k), as in Equation (60).

Next, in a fifth interval correction data generation step S153, the measurement device 1 inverts the sign of the displacement data MU(k) in the fifth interval T5 to generate the fifth interval correction data M_{CC5}(k), as in Equation (61).

Next, in a second interval correction data generation step S154, according to Equation (62) to Equation (67), the measurement device 1 sets the minimum value of the data −MVH(k) obtained by inverting the sign of the velocity data MVH(k) in the first interval T1 as the first-order coefficient s₁, generates the first line data L1(k) passing through the point (k₁, −mu₁) obtained by inverting the sign of the amplitude of the first peak p₁=(k₁, mu₁), and generates the second interval correction data M_{CC2}(k), which is the first line data L1(k) in the second interval T2.

Next, in a fourth interval correction data generation step S155, according to Equation (68) to Equation (73), the measurement device 1 sets the maximum value of the data −MVH(k) obtained by inverting the sign of the velocity data MVH(k) in the fifth interval T5 as the first-order coefficient s₂, generates the second line data L2(k) passing through the point (k₄, −mu₄) obtained by inverting the sign of the amplitude of the fourth peak p₄=(k₄, mu₄), and generates the fourth interval correction data M_{CC4}(k), which is the second line data L2(k) in the fourth interval T4.

Next, in a third interval correction data generation step S156, the measurement device 1 generates the third interval correction data M_{CC3}(k) in the third interval T3.

Finally, in a correction data generation step S157, the measurement device 1 adds the first interval correction data M_{cc1}(k) generated in step S152, the second interval correction data M_{CC2}(k) generated in step S154, the third interval correction data M_{CC3}(k) generated in step S156, the fourth interval correction data M_{CC4}(k) generated in step S155, and the fifth interval correction data M_{CC5}(k) generated in step S153 to generate the correction data M_{CC}(k), as in Equation (59).

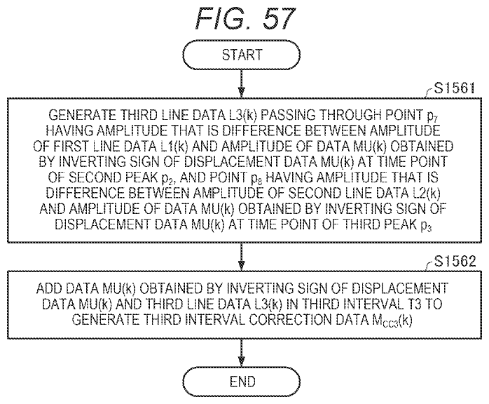

FIG. 57 is a flowchart showing an example of a procedure of the third interval correction data generation step S156 in FIG. 56.

As shown in FIG. 57, first, in step S1561, the measurement device 1 generates the third line data L3(k) passing through the point p₇=(k₂, L1(k₂)+mu₂) having an amplitude that is the difference between the amplitude L1(k₂) of the first line data L1(k) and the amplitude −mu₂ of the data MU′(k) obtained by inverting the sign of the displacement data MU(k) at the time point of the second peak p₂=(k₂, mu₂), and the point p₈=(k₃, L2(k₃)+mu₃) having an amplitude that is the difference between the amplitude L2(k₃) of the second line data L2(k) and the amplitude −mu₃ of the data MU′(k) obtained by inverting the sign of the displacement data MU(k) at the time point of the third peak p₃=(k₃, −mu₃), according to Equation (76).

Finally, in step S1562, as in Equation (77), the measurement device 1 adds the data MU′(k) obtained by inverting the sign of the displacement data MU(k) and the third line data L3(k) in the third interval T3 to generate the third interval correction data M_{CC3}(k).

2-5. Configuration of Observation device, Measurement Device, and Monitoring Device

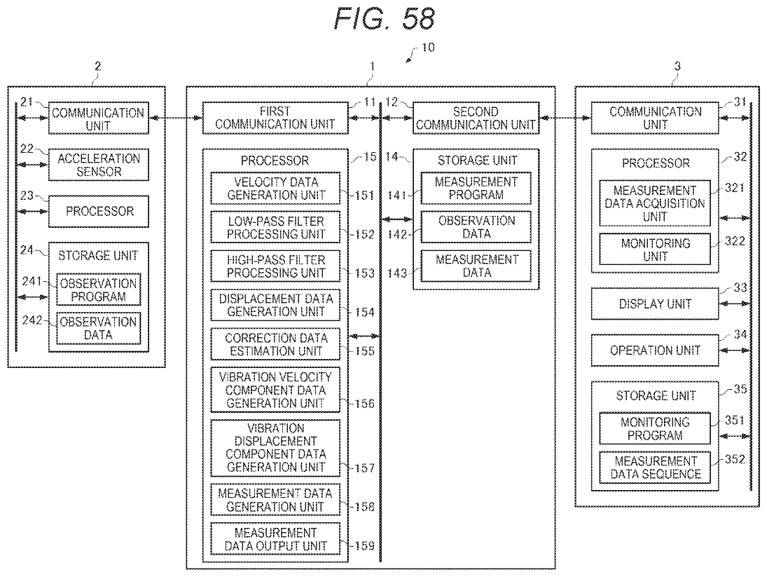

FIG. 58 is a diagram showing a configuration example of the sensor 2 which is the observation device, the measurement device 1, and the monitoring device 3.

As shown in FIG. 58, as in the first embodiment, the sensor 2 in the second embodiment includes the communication unit 21, the acceleration sensor 22, the processor 23, and the storage unit 24. Since a function of the sensor 2 is similar to that of the first embodiment, description thereof will be omitted.

As shown in FIG. 58, as in the first embodiment, the monitoring device 3 in the second embodiment includes the communication unit 31, the processor 32, the display unit 33, the operation unit 34, and the storage unit 35. Since a function of the monitoring device 3 is similar to that of the first embodiment, description thereof will be omitted.

As shown in FIG. 58, the measurement device 1 according to the second embodiment includes the first communication unit 11, the second communication unit 12, the storage unit 14, and a processor 15. Since functions of the first communication unit 11, the second communication unit 12, and the storage unit 14 are similar to those in the first embodiment, description thereof will be omitted.

The processor 15 acquires the observation data 242 received by the first communication unit 11, and stores the observation data 242 in the storage unit 14 as the observation data 142. Then, the processor 15 generates the measurement data 143 based on the observation data 142 stored in the storage unit 14, and stores the generated measurement data 143 in the storage unit 14. In the present embodiment, the measurement data 143 is the measurement data RU(k).

In the present embodiment, the processor 15 functions as a velocity data generation unit 151, a low-pass filter processing unit 152, a high-pass filter processing unit 153, a displacement data generation unit 154, a correction data estimation unit 155, a vibration velocity component data generation unit 156, a vibration displacement component data generation unit 157, a measurement data generation unit 158, and a measurement data output unit 159 by executing the measurement program 141 stored in the storage unit 14. That is, the processor 15 includes as the velocity data generation unit 151, the low-pass filter processing unit 152, the high-pass filter processing unit 153, the displacement data generation unit 154, the correction data estimation unit 155, the vibration velocity component data generation unit 156, the vibration displacement component data generation unit 157, the measurement data generation unit 158, and the measurement data output unit 159.

The velocity data generation unit 151 acquires the observation data 142 stored in the storage unit 14, and generates the velocity data MV(k) based on the observation data 142. In the example of FIG. 58, the observation data 142 is acceleration data, but the observation data 142 may be displacement data or velocity data. When the observation data 142 is acceleration data, the velocity data generation unit 151 integrates the acceleration data to generate the velocity data MV(k) as in Equation (14), when the observation data 142 is displacement data, the velocity data generation unit 151 differentiates the displacement data to generate the velocity data MV(k) as in Equation (15), and when the observation data 142 is velocity data, the velocity data generation unit 151 sets the observation data 142 as the velocity data MV(k). That is, the velocity data generation unit 151 performs the processing of the velocity data generation step S110 in FIG. 55.

The low-pass filter processing unit 152 performs low-pass filter processing on the velocity data MV(k) including the drift noise and the vibration component and generated by the velocity data generation unit 151, so as to generate the velocity data MVₛ(k) as the vibration component reduction data in which the vibration component is reduced. That is, the low-pass filter processing unit 152 performs the processing of the low-pass filter processing step S120 in FIG. 55.

The high-pass filter processing unit 153 performs high-pass filter processing on the velocity data MVₛ(k) including the drift noise and generated by the low-pass filter processing unit 152, so as to generate the velocity data MVH(k) as the drift noise reduction data in which the drift noise is reduced, as in Equation (57). That is, the high-pass filter processing unit 153 performs the processing of the high-pass filter processing step S130 in FIG. 55.

The displacement data generation unit 154 integrates the velocity data MVH(k) generated by the high-pass filter processing unit 153 to generate the displacement data MU(k), as in Equation (58). That is, the displacement data generation unit 154 performs the processing of the displacement data generation step S140 in FIG. 55.

The correction data estimation unit 155 estimates, based on the displacement data MU(k) generated by the displacement data generation unit 154, the correction data M_{CC}(k) corresponding to the difference between the displacement data MU(k) and the data obtained by removing the drift noise from the data obtained by integrating the velocity data MVₛ(k). The correction data estimation unit 155 generates the correction data M_{CC}(k) by performing calculations of Equations (59) to (78).

Specifically, first, the correction data estimation unit 155 calculates the first peak p₁=(k₁, mu₁) and the fourth peak p₄=(k₄, mu₄) of the displacement data MU(k) and the second peak p₂=(k₂, mu₂) and the third peak p₃=(k₃, mu₃) of the data MU′(k) obtained by inverting the sign of the displacement data MU(k), and specifies the first interval T1 before the first peak p₁, the second interval T2 between the first peak p₁ and the second peak p₂, the third interval T3 from the second peak p₂ to the third peak p₃, the fourth interval T4 between the third peak p₃ and the fourth peak p₄, and the fifth interval T5 after the fourth peak p₄. That is, the correction data estimation unit 155 performs the processing of the interval specifying step S151 in FIG. 56.

Next, the correction data estimation unit 155 inverts the sign of the displacement data MU(k) in the first interval T1 to generate the first interval correction data M_{CC1}(k), as in Equation (60). That is, the correction data estimation unit 155 performs the processing of the first interval correction data generation step S152 in FIG. 56.

Next, the correction data estimation unit 155 inverts the sign of the displacement data MU(k) in the fifth interval T5 to generate the fifth interval correction data M_{CC5}(k), as in Equation (61). That is, the correction data estimation unit 155 performs the processing of the fifth interval correction data generation step S153 in FIG. 56.

Next, according to Equation (62) to Equation (67), the correction data estimation unit 155 sets the minimum value of the data −MVH(k) obtained by inverting the sign of the velocity data MVH(k) in the first interval T1 as the first-order coefficient s₁, generates the first line data L1(k) passing through the point (k₁, −mu₁) obtained by inverting the sign of the amplitude of the first peak p₁=(k₁, mu₁), and generates the second interval correction data M_{CC2}(k), which is the first line data L1(k) in the second interval T2. That is, the correction data estimation unit 155 performs the processing of the second interval correction data generation step S154 in FIG. 56.

Next, according to Equation (68) to Equation (73), the correction data estimation unit 155 sets the maximum value of the data −MVH(k) obtained by inverting the sign of the velocity data MVH(k) in the fifth interval T5 as the first-order coefficient s₂, generates the second line data L2(k) passing through the point (k₄, −mu₄) obtained by inverting the sign of the amplitude of the fourth peak p₄=(k₄, mu₄), and generates the fourth interval correction data M_{CC4}(k), which is the second line data L2(k) in the fourth interval T4. That is, the correction data estimation unit 155 performs the processing of the fourth interval correction data generation step S155 in FIG. 56.

Next, the correction data estimation unit 155 generates the third line data L3(k) passing through the point p₇=(k₂, L1(k₂)+mu₂) having an amplitude that is the difference between the amplitude L1(k₂) of the first line data L1(k) and the amplitude −mu₂ of the data MU′(k) obtained by inverting the sign of the displacement data MU(k) at the time point of the second peak p₂=(k₂, −mu₂), and the point p₈=(k₃, L2 (k₃)+mu₃) having an amplitude that is the difference between the amplitude L2(k₃) of the second line data L2(k) and the amplitude −mu₃ of the data MU′(k) obtained by inverting the sign of the displacement data MU(k) at the time point of the third peak p₃=(k₃, −mu₃), according to Equation (76). That is, the correction data estimation unit 155 performs the processing of step S1561 in FIG. 57.

Next, as in Equation (77), the correction data estimation unit 155 adds the data MU′(k) obtained by inverting the sign of the displacement data MU(k) and the third line data L3(k) in the third interval T3 to generate the third interval correction data M_{CC3}(k). That is, the correction data estimation unit 155 performs the processing of step S1562 in FIG. 57.

Finally, in the correction data generation step S157, in the measurement device 1, the correction data estimation unit 155 adds the first interval correction data M_{CC1}(k), the second interval correction data M_{CC2}(k), the third interval correction data M_{CC3}(k), the fourth interval correction data M_{CC4}(k), and the fifth interval correction data M_{CC5}(k) to generate the correction data M_{CC}(k), as in Equation (59). That is, the correction data estimation unit 155 performs the processing of the correction data generation step S157 in FIG. 56.

As described above, the correction data estimation unit 155 performs the processing of the correction data estimation step S150 in FIG. 55, specifically, the processing of steps S151 to S157 in FIG. 56 and the processing of steps S1561 and S1562 in FIG. 57.

The vibration velocity component data generation unit 156 subtracts the velocity data MVₛ(k) generated in step S120 from the velocity data MV(k) generated in step S110 to generate the vibration velocity component data MV_{OSC}(k) including the vibration component, as in Equation (55). That is, the vibration velocity component data generation unit 156 performs the processing of the vibration velocity component data generation step S160 in FIG. 55.

The vibration displacement component data generation unit 157 integrates the vibration velocity component data MV_{OSC}(k) generated in step S160 to generate the vibration displacement component data U_{OSC}(k) as in Equation (56). That is, the vibration displacement component data generation unit 157 performs the processing of the vibration displacement component data generation step S170 in FIG. 55.

The measurement data generation unit 158 generates the measurement data U′(k) by adding the displacement data MU(k) generated by the displacement data generation unit 154, the correction data M_{CC}(k) generated by the correction data estimation unit 155, and the vibration displacement component data U_{OSC}(k) generated by the vibration displacement component data generation unit 157 as in Equation (79) and Equation (81). That is, the measurement data generation unit 158 performs the processing of the measurement data generation step S180 in FIG. 55. The measurement data U′(k) generated by the measurement data generation unit 158 is stored in the storage unit 14 as the measurement data 143.

The measurement data output unit 159 reads the measurement data 143 stored in the storage unit 14 and outputs the measurement data 143 to the monitoring device 3. Then, the second communication unit 12 transmits the measurement data 143 stored in the storage unit 14 to the monitoring device 3 via the communication network 4 under the control of the measurement data output unit 159. That is, the measurement data output unit 159 performs the processing of the measurement data output step S190 in FIG. 55.

As described above, the measurement program 141 is a program that causes the measurement device 1, which is a computer, to execute each procedure of the flowchart shown in FIG. 55.

In the processor 15, for example, the functions of the respective units may be implemented by individual hardware, or the functions of the respective units may be implemented by integrated hardware. For example, the processors 15 include hardware, and the hardware may include at least one of a circuit that processes a digital signal and a circuit that processes an analog signal. The processors 15 may be a CPU, a GPU, a DSP, or the like. The CPU is an abbreviation for central processing unit, the GPU is an abbreviation for graphics processing unit, and the DSP is an abbreviation for digital signal processor. The processor 15 is configured as a custom IC such as an ASIC, and may implement the functions of the respective units, or may implement the functions of the respective units by a CPU and an ASIC. The ASIC is an abbreviation for application specific integrated circuit, and the IC is an abbreviation for integrated circuit.

Although only one sensor 2 is shown in FIG. 58, a plurality of sensors 2 may generate the observation data 242 and transmit the observation data 242 to the measurement device 1. In this case, the measurement device 1 receives a plurality of pieces of the observation data 242 transmitted from the plurality of sensors 2, generates a plurality of pieces of measurement data 143, and transmits the plurality of pieces of measurement data 143 to the monitoring device 3. The monitoring device 3 receives the plurality of pieces of measurement data 143 transmitted from the measurement device 1, and monitors a plurality of states of the superstructures 7 based on the plurality of pieces of received measurement data 143.

### 2-6. Operation and Effect

In the measurement method of the second embodiment described above, the measurement device 1 generates the velocity data Vₛ(k) in which the vibration component is reduced and the vibration velocity component data MV_{OSC}(k) including the vibration component, using the velocity data MV(k), generates the MVH(k) in which the drift noise is reduced from the velocity data V₃(k), and estimates the correction data M_{CC}(k) based on the displacement data MU(k) obtained by integrating the MVH(k). Since the vibration component of the displacement data MU(k) is reduced, the correction data M_{CC}(k) estimated with high accuracy is obtained. Further, since the correction data M_{CC}(k) corresponds to the difference between the displacement data MU(k) and the data obtained by subtracting the drift noise from the data obtained by integrating the velocity data V₃(k), the correction data M_{CC}(k) includes the significant signal component removed by high-pass filter processing. Therefore, according to the measurement method of the second embodiment, the measurement device 1 can generate the measurement data U′(k), in which the drift noise is reduced, by adding the displacement data MU(k), the correction data M_{CC}(k), and the vibration displacement component data U_{OSC}(k) obtained by integrating the vibration velocity component data MV_{OSC}(k). According to the measurement method of the second embodiment, the measurement device 1 generates the displacement data MU(k), the correction data M_{CC}(k) and the vibration displacement component data U_{OSC}(k) using the velocity data MV(k) to be processed, adds the displacement data MU(k), the correction data M_{CC}(k) and the vibration displacement component data U_{OSC}(k), and thereby the measurement device 1 can generate the measurement data U′(k), in which the drift noise is reduced, without preparing information for reducing the drift noise in advance. Therefore, by using the measurement method of the second embodiment, accurate measurement data U′(k) can be obtained regardless of a change in the environment, and cost reduction can be achieved.

In the measurement method of the second embodiment, the measurement device 1 generates the displacement data MU(k) by performing high-pass filter processing on the velocity data MV(k) and then integrating the velocity data MV(k), instead of generating the displacement data MU(k) by integrating the velocity data MV(k) and then performing high-pass filter processing on the velocity data MV(k). Since the drift noise in the velocity data MV(k) has a variation amount smaller than that of the drift noise in the data obtained by integrating the velocity data MV(k), the drift noise is more likely to be sufficiently reduced when the displacement data MU(k) is generated by performing high-pass filter processing on the velocity data MV(k) and then integrating the velocity data MV(k) as compared with when the displacement data MU(k) is generated by integrating the velocity data MV(k) and then performing high-pass filter processing on the velocity data MV(k). Therefore, according to the measurement method of the second embodiment, the measurement device 1 can generate the accurate correction data M_{CC}(k) based on the displacement data MU(k) in which the drift noise is sufficiently reduced.

According to the measurement method of the second embodiment, since the measurement device 1 can specify the first interval T1, the second interval T2, the third interval T3, the fourth interval T4, and the fifth interval T5, and can generate the appropriate first interval correction data M_{CC1}(k), second interval correction data M_{CC2}(k), third interval correction data M_{CC3}(k), fourth interval correction data M_{CC4}(k), and fifth interval correction data M_{CC5}(k) based on a feature of the displacement data MU(k) in which the drift noise and the vibration component is reduced, it is possible to improve the estimation accuracy of the correction data M_{CC}(k) generated by adding the first interval correction data M_{CC1}(k), the second interval correction data M_{CC2}(k), the third interval correction data M_{CC3}(k), the fourth interval correction data M_{CC4}(k), and the fifth interval correction data M_{CC5}(k). In particular, since the first line data L1(k), the second line data L2(k), and the third line data L3(k) can be generated with high accuracy, the second interval correction data M_{CC2}(k), the third interval correction data M_{CC3}(k), and the fourth interval correction data M_{CC4}(k) with high accuracy can be generated based on the first line data L1(k), the second line data L2(k), and the third line data L3(k).

According to the measurement method of the second embodiment, the measurement device 1 performs moving average processing on the velocity data MV(k) in the cycle T_{f} corresponding to the fundamental frequency F_{f}, and thereby not only the necessary calculation amount is small, but also the attenuation amount and the harmonic component of the signal component of the fundamental frequency F_{f} is very large. Therefore, the velocity data MVₛ(k) in which the vibration component is effectively reduced is obtained, so that the estimation accuracy of the correction data M_{CC}(k) can be improved by eliminating the influence of the vibration component. Alternatively, the measurement device 1 generates the velocity data MVₛ(k) by performing, on the velocity data MV(k), FIR filter processing for attenuating a signal component of a frequency equal to or higher than the fundamental frequency F_{f}, and thus the calculation amount is larger than that of the moving average processing, but since all signal components of a frequency equal to or higher than the fundamental frequency F_{f} can be attenuated, the estimation accuracy of the correction data M_{CC}(k) can be improved by eliminating the influence of the vibration component having a frequency equal to or higher than the fundamental frequency F_{f}.

According to the measurement method of the second embodiment, the measurement device 1 performs high-pass filter processing on the velocity data MVₛ(k) using a frequency lower than the fundamental frequency F_{f} as the cutoff frequency, and thus the drift noise in the velocity data MVₛ(k) that is lower than the fundamental frequency F_{f} can be reduced.

According to the measurement method of the second embodiment, the measurement device 1 performs processing of subtracting the data, that is obtained by performing moving average processing or FIR filter processing on the velocity data MVₛ(k), from the velocity data MVₛ(k) as the high-pass filter processing to be performed on the velocity data MVₛ(k), and thus the high-pass filter processing can be easily performed. Further, in the moving average processing or the FIR filter processing, since a group delay of each signal component included in the velocity data MVₛ(k) is constant, the correction data M_{CC}(k) can be estimated with high accuracy.

In the measurement method of the second embodiment, the velocity data MV(k) to be processed is data of the displacement velocity of the superstructure 7 caused by the railway vehicle 6 moving on the superstructure 7 of the bridge 5. Therefore, according to the measurement method of the second embodiment, since the measurement device 1 generates the measurement data U′(k) which is data of the displacement of the superstructure 7 caused by the movement of the railway vehicle 6 and in which the drift noise is reduced, it is possible to accurately measure the displacement of the superstructure 7 of the bridge 5.

According to the measurement method of the second embodiment, since the measurement device 1 generates the measurement data U′(k) based on the velocity data MV(k) obtained by integrating the acceleration in the direction intersecting the surface of the superstructure 7 detected by the sensor 2 installed in the superstructure 7, it is possible to accurately measure the displacement of the superstructure 7.

In the measurement method of the second embodiment, since the frequency of the drift noise included in the velocity data MV(k) is lower than the minimum value of the natural vibration frequency of the superstructure 7, the cutoff frequency of the high-pass filter processing for the velocity data MVₛ(k) can be set higher than the frequency of the drift noise of the superstructure 7 and lower than the minimum value of the natural vibration frequency. Therefore, according to the measurement method of the second embodiment, the drift noise can be reduced without reducing the signal component and the harmonic component of the natural vibration frequency of the superstructure 7 in the generated measurement data U′(k).

In the measurement method of the second embodiment, since the displacement data MU(k) includes data of a waveform that projects in the positive direction or the negative direction, for example, data of a rectangular waveform, a trapezoidal waveform, or a sine half-wave waveform, the measurement device 1 can generate more appropriate correction data M_{CC}(k) based on features of these waveforms, so that it is possible to improve the estimation accuracy of the generated correction data M_{CC}(k).

### 3. Modification

The present disclosure is not limited to the above embodiments, and various modifications can be made within the scope of the gist of the present disclosure.

In the embodiments described above, the observation data is the acceleration data Aₘ(k) output from the acceleration sensor that is the observation device, but the observation data is not limited thereto. For example, the observation data may be data observed by a contact-type displacement meter, a ring-type displacement meter, a laser displacement meter, a pressure-sensitive sensor, an image processing-based displacement measurement device, or an optical fiber-based displacement measurement device, which is the observation device. The contact-type displacement meter, the ring-type displacement meter, the laser displacement meter, the image processing-based displacement measurement device, or the optical fiber-based displacement measurement device measures a displacement of the observation point R caused by traveling of the railway vehicle 6. The pressure-sensitive sensor detects a change in stress at the observation point R caused by traveling of the railway vehicle 6. That is, the observation data may be data of displacement or stress change, and the measurement device 1 may generate the velocity data MV(k) by differentiating the data of displacement or stress change which is the observation data. For example, the observation data may be data observed by the velocity sensor which is the observation device. That is, the observation data may be velocity data, and the measurement device 1 may acquire the velocity data, which is the observation data, as the velocity data MV(k). According to the measurement methods, the measurement device 1 can accurately measure the displacement of the superstructure 7 using the data of the displacement, the stress change, or the velocity.

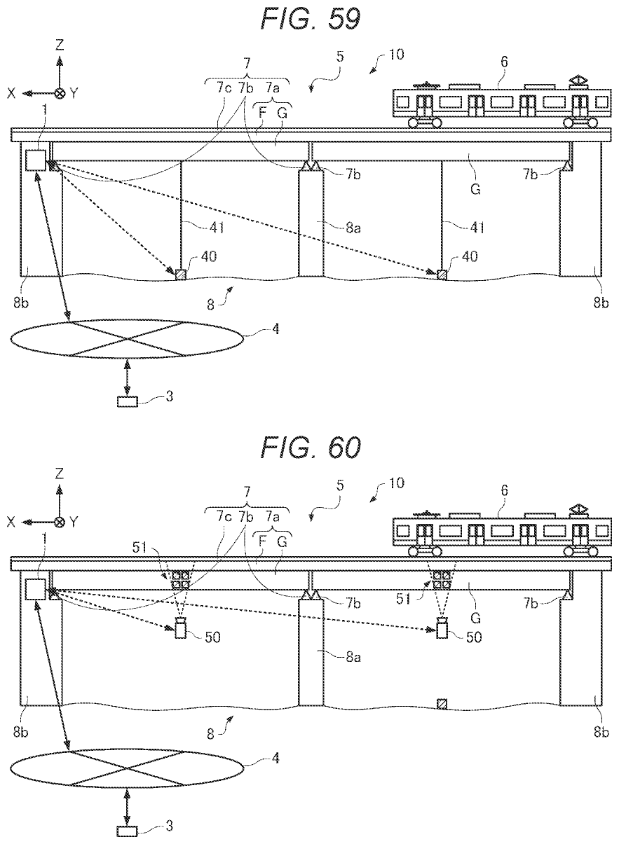

As an example, FIG. 59 shows a configuration example of the measurement system 10 using the ring-type displacement meter as the observation device. FIG. 60 shows a configuration example of the measurement system 10 using the image processing-based displacement measurement device as the observation device. In FIG. 59 and FIG. 60, the same components as those in FIG. 1 are denoted by the same reference numerals, and description thereof will be omitted. In the measurement system 10 shown in FIG. 59, a piano wire 41 is fixed between an upper surface of a ring-type displacement meter 40 and a lower surface of the main girder G immediately above the ring-type displacement meter 40, and the ring-type displacement meter 40 measures a displacement of the piano wire 41 caused by bending of the superstructure 7 and transmits the measured displacement data Uₘ(k) to the measurement device 1. The measurement device 1 differentiates the displacement data Uₘ(k) transmitted from the ring-type displacement meter to generate the velocity data MV(k), and generates measurement data in which drift noise is reduced based on the velocity data MV(k). In the measurement system 10 shown in FIG. 60, a camera 50 transmits, to the measurement device 1, an image obtained by imaging a target 51 provided on a side surface of the main girder G. The measurement device 1 processes the image transmitted from the camera 50, calculates a displacement of the target 51 caused by bending of the superstructure 7 to generate displacement data Uₘ(k), differentiates the generated displacement data Uₘ(k) to generate the velocity data MV(k), and generates measurement data in which drift noise is reduced based on the velocity data MV(k). In the example of FIG. 60, the measurement device 1 generates the displacement data Uₘ(k) as an image processing-based displacement measurement device, but a displacement measurement device (not illustrated) different from the measurement device 1 may generate the displacement data Uₘ(k) by image processing.

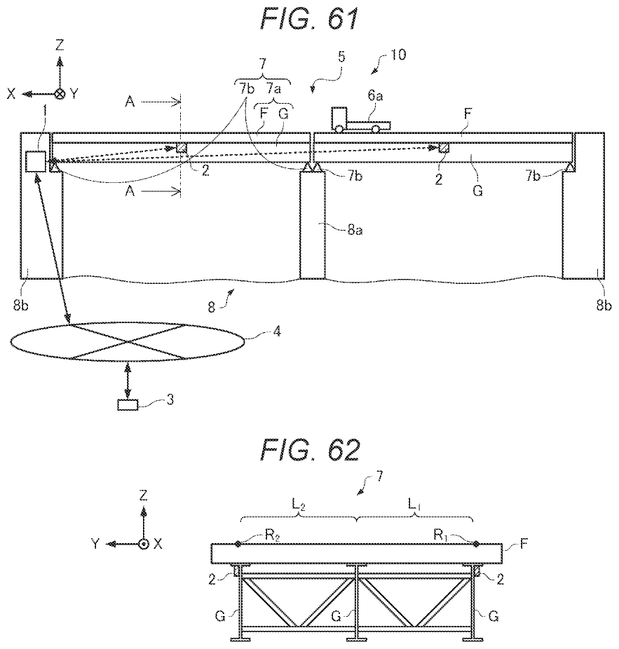

In the embodiments described above, the bridge 5 is a railroad bridge, and the moving object moving on the bridge 5 is the railway vehicle 6, but the bridge 5 may be a road bridge, and the moving object moving on the bridge 5 may be a vehicle such as an automobile, a road train, or a construction vehicle. FIG. 61 illustrates a configuration example of the measurement system 10 in a case where the bridge 5 is a road bridge and a vehicle 6a moves on the bridge 5. In FIG. 61, the same components as those in FIG. 1 are denoted by the same reference numerals. As illustrated in FIG. 61, the bridge 5, which is a road bridge, includes the superstructure 7 and the substructure 8, similarly to the railroad bridge. FIG. 62 is a cross-sectional view of the superstructure 7 taken along line A-A of FIG. 61. As shown in FIGS. 61 and 62, the superstructure 7 includes the bridge floor 7a and the support 7b, and the bridge floor 7a includes the floor plate F, the main girder G, and a cross girder which is not shown. As shown in FIG. 61, the substructure 8 includes bridge piers 8a and bridge abutments 8b. The superstructure 7 is a structure across any one of the bridge abutment 8b and the bridge pier 8a adjacent to each other, two adjacent bridge abutments 8b, and two adjacent bridge piers 8a. Both end portions of the superstructure 7 are located at positions of the bridge abutment 8b and the bridge pier 8a adjacent to each other, at positions of the two adjacent bridge abutments 8b, or at positions of the two adjacent bridge piers 8a. The bridge 5 is, for example, a steel bridge, a girder bridge, or an RC bridge.

Each sensor 2 is installed at position of a central portion of the superstructure 7 in a longitudinal direction, specifically, at a central portion of the main girder G in the longitudinal direction. Each sensor 2 is not limited to being installed at the central portion of the superstructure 7 as long as each sensor 2 can detect an acceleration for calculating the displacement of the superstructure 7. When each sensor 2 is provided on the floor plate F of the superstructure 7, the sensor 2 may be damaged due to traveling of the vehicle 6a, and the measurement accuracy may be affected by local deformation of the bridge floor 7a, so that in the example of FIGS. 61 and 62, each sensor 2 is provided at the main girder G of the superstructure 7.

As shown in FIG. 62, the superstructure 7 has two lanes L₁ and L₂ and three main girders G to which the vehicle 6a as a moving object can move. In the example of FIGS. 61 and 62, in the central portion in the longitudinal direction of the superstructure 7, the sensors 2 are provided at two main girders at both ends, an observation point R₁ is provided at a position of a surface of the lane L₁ vertically above one of the sensors 2, and an observation point R₂ is provided at a position of a surface of the lane L₂ vertically above the other of the sensor 2. That is, the two sensors 2 are observation devices for observing the observation points R₁ and R₂, respectively. Although the two sensor 2 for observing the observation points R₁ and R₂ may be provided at positions where the accelerations generated at the observation points R₁ and R₂ due to the traveling of the vehicle 6a can be detected, it is desirable that the sensors 2 are provided at positions close to the observation points R₁ and R₂. The number and installation positions of the sensors 2 are not limited to the example shown in FIGS. 61 and 62, and various modifications can be made.

The measurement device 1 calculates displacements of bending of the lanes L₁ and L₂ caused by the traveling of the vehicle 6a based on the acceleration data output from the sensors 2, and transmits information on the displacements of the lanes L₁ and L₂ to the monitoring device 3 via the communication network 4. The monitoring device 3 may store the information in a storage device (not illustrated), and may perform processing such as monitoring of the vehicle 6a and abnormality determination of the superstructure 7 based on the information, for example.

In the embodiments described above, each sensor 2 is provided at the main girder G of the superstructure 7, but the sensor may be provided on the surface of or inside the superstructure 7, at the lower surface of the floor plate F, at the bridge pier 8a, or the like. In the embodiments described above, the superstructure of the bridge is described as an example of the structure, but the present disclosure is not limited thereto, and it is sufficient that the structure is deformed due to the movement of the moving object.

A railway vehicle or a vehicle passing through a bridge is a vehicle that has a large weight and can be measured by BWIM. The BWIM is an abbreviation of bridge weigh in motion, and is a technology in which a bridge is regarded as a “scale”, deformation of the bridge is measured, and thereby the weight and the number of axles of the railway vehicle and vehicle passing through the bridge is measured. The superstructure of the bridge, which enables analysis of the weight of the railway vehicle or the vehicle, that travels on the bridge, based on a response such as deformation and strain, is a structure in which the BWIM functions. The BWIM system, which applies a physical process between an action on the superstructure of the bridge and the response, enables the measurement of the weight of the vehicle that travels on the bridge.

The embodiments and modifications described above are merely examples, and the present disclosure is not limited thereto. For example, it is also possible to appropriately combine the embodiments and modifications.

The present disclosure includes a configuration substantially the same as the configuration described in the embodiment, for example, a configuration having the same function, method and result, or a configuration having the same purpose and effect. The present disclosure includes a configuration obtained by replacing a non-essential portion of the configuration described in the embodiment. The present disclosure includes a configuration having the same operation and effect as the configuration described in the embodiment, or a configuration capable of achieving the same object. Further, the present disclosure includes a configuration in which a known technique is added to the configuration described in the embodiment.

The following contents are derived from the embodiments and modifications described above.

According to an aspect of the present disclosure, a measurement method includes: a high-pass filter processing step of performing high-pass filter processing on observation data-based velocity data including a drift noise to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the velocity data; and a measurement data generation step of generating measurement data by adding the displacement data and the correction data.

In the measurement method, the drift noise reduction data in which the drift noise is reduced is generated using the velocity data, and the correction data is estimated based on the displacement data obtained by integrating the drift noise reduction data. Further, since the correction data corresponds to the difference between the displacement data and the data obtained by removing the drift noise from the data obtained by integrating the velocity data, the correction data includes a significant signal component removed by the high-pass filter processing. Therefore, according to the measurement method, the measurement data in which the drift noise is reduced can be generated by adding the displacement data and the correction data. According to the measurement method, by generating the displacement data and the correction data using the velocity data to be processed, and adding the displacement data and the correction data, the measurement data in which the drift noise is reduced can be generated without preparing information for reducing the drift noise in advance. Therefore, by using the measurement method, accurate measurement data can be obtained regardless of a change in environment, and cost reduction can be achieved.

In the measurement method, the displacement data is generated by performing high-pass filter processing on the velocity data and then integrating the velocity data instead of being generated by integrating the velocity data and then performing high-pass filter processing on the velocity data. Since the drift noise in the velocity data has a variation amount smaller than that of the drift noise in the data obtained by integrating the velocity data, the drift noise is more likely to be sufficiently reduced when the displacement data is generated by performing high-pass filter processing on the velocity data and then integrating the velocity data as compared with when the displacement data is generated by integrating the velocity data and then performing high-pass filter processing on the velocity data. Therefore, according to the measurement method, accurate correction data can be generated based on the displacement data in which the drift noise is sufficiently reduced.

In the measurement method of the above aspect, in the high-pass filter processing step, fast Fourier transform processing may be performed on the velocity data to calculate a fundamental frequency, and the high-pass filter processing may be performed by using a frequency lower than the fundamental frequency as a cutoff frequency.

According to the measurement method, the drift noise can be reduced without reducing a signal component and a harmonic component of the fundamental frequency included in the velocity data.

In the measurement method of the above aspect, the correction data estimation step may include: an interval specifying step of calculating a first peak, a second peak, a third peak, and a fourth peak of the displacement data, and specifying a first interval before the first peak, a second interval between the first peak and the second peak, a third interval from the second peak to the third peak, a fourth interval between the third peak and the fourth peak, and a fifth interval after the fourth peak, a first interval correction data generation step of generating first interval correction data by inverting a sign of the displacement data in the first interval, a fifth interval correction data generation step of generating fifth interval correction data by inverting a sign of the displacement data in the fifth interval, a second interval correction data generation step of generating first line data which passes through a point obtained by inverting a sign of an amplitude of the first peak and which has a first-order coefficient that is the same as that of a line approximating the first interval correction data smaller than a product of a coefficient and a value obtained by inverting the sign of the amplitude of the first peak, and generating second interval correction data which is the first line data in the second interval, a fourth interval correction data generation step of generating second line data which passes through a point obtained by inverting a sign of an amplitude of the fourth peak and which has a first-order coefficient that is the same as that of a line approximating the fifth interval correction data smaller than a product of a coefficient and a value obtained by inverting the sign of the amplitude of the fourth peak, and generating fourth interval correction data which is the second line data in the fourth interval, a third interval correction data generation step of generating third interval correction data in the third interval, and a correction data generation step of generating the correction data by adding the first interval correction data, the second interval correction data, the third interval correction data, the fourth interval correction data, and the fifth interval correction data, and the third interval correction data generation step may include: generating third line data passing through a point having an amplitude that is a sum of an amplitude of the first line data and an amplitude of the displacement data at a time point of the second peak and a point having an amplitude that is a sum of an amplitude of the second line data and an amplitude of the displacement data at a time point of the third peak, calculating a first intersection point between the first line data and the third line data and a second intersection point between the third line data and the second line data, and generating the third interval correction data in the third interval by using data before the first intersection point as the first line data, data from the first intersection point to the second intersection point as the third line data, and data after the second intersection point as the second line data.

According to the measurement method, the five intervals can be specified based on a feature of the displacement data in which the drift noise is reduced, and more appropriate correction data can be generated in each interval, so that the estimation accuracy of the generated correction data can be improved. In particular, since the first line data, the second line data, and the third line data with high accuracy can be obtained by setting the coefficient to an appropriate value, the correction data with high accuracy can be generated in the second interval, the third interval, and the fourth interval.

According to another aspect of the present disclosure, a measurement method includes: a low-pass filter processing step of performing low-pass filter processing on observation data-based velocity data including a drift noise and a vibration component to generate vibration component reduction data in which the vibration component is reduced; a high-pass filter processing step of performing high-pass filter processing on the vibration component reduction data to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the vibration component reduction data; a vibration velocity component data generation step of generating vibration velocity component data by subtracting the vibration component reduction data from the velocity data; a vibration displacement component data generation step of generating vibration displacement component data by integrating the vibration velocity component data; and a measurement data generation step of generating measurement data by adding the displacement data, the correction data, and the vibration displacement component data.

According to the measurement method, the vibration component reduction data in which the vibration component is reduced and the vibration velocity component data including the vibration component are generated using the velocity data, the drift noise reduction data in which the drift noise is reduced is generated based on the vibration component reduction data, and the correction data is estimated based on the displacement data obtained by integrating the drift noise reduction data. Since the vibration component of the displacement data is reduced, the correction data estimated with high accuracy is obtained. Further, since the correction data corresponds to the difference between the displacement data and the data obtained by subtracting the drift noise from the data obtained by integrating the vibration component reduction data, the correction data includes the significant signal component removed by the high-pass filter processing. Therefore, according to the measurement method, the measurement data in which the drift noise is reduced can be generated by adding the displacement data, the correction data, and the vibration displacement component data obtained by integrating the vibration velocity component data. According to the measurement method, by generating the displacement data, the correction data and the vibration displacement component data using the velocity data to be processed, and adding the displacement data, the correction data and the vibration displacement component data, the measurement data in which the drift noise is reduced can be generated without preparing information for reducing the drift noise in advance. Therefore, by using the measurement method, accurate measurement data can be obtained regardless of a change in environment, and cost reduction can be achieved.

According to the measurement method, the displacement data is generated by performing high-pass filter processing on the velocity data and then integrating the velocity data instead of being generated by integrating the velocity data and then performing high-pass filter processing on the velocity data. Since the drift noise in the velocity data has a variation amount smaller than that of the drift noise in the data obtained by integrating the velocity data, the drift noise is more likely to be sufficiently reduced when the displacement data is generated by performing high-pass filter processing on the velocity data and then integrating the velocity data as compared with when the displacement data is generated by integrating the velocity data and then performing high-pass filter processing on the velocity data. Therefore, according to the measurement method, accurate correction data can be generated based on the displacement data in which the drift noise is sufficiently reduced.

In the measurement method of the above aspect, in the low-pass filter processing step, a fundamental frequency may be calculated by performing fast Fourier transform processing on the velocity data, and the vibration component reduction data may be generated by performing, as the low-pass filter processing, moving average processing on the velocity data at a cycle corresponding to the fundamental frequency.

According to the measurement method, in the moving average processing, not only the necessary calculation amount is small, but also an attenuation amount of the signal component and the harmonic component of the fundamental frequency is very large, so that the vibration component reduction data in which the vibration component is effectively reduced is obtained. Therefore, according to the measurement method, the estimation accuracy of the correction data can be improved by eliminating the influence of the vibration component.

In the measurement method of the above aspect, in the low-pass filter processing step, a fundamental frequency may be calculated by performing fast Fourier transform processing on the velocity data, and the vibration component reduction data may be generated by performing, as the low-pass filter processing, FIR filter processing for attenuating a signal component of a frequency equal to or higher than the fundamental frequency on the velocity data.

According to the measurement method, although the FIR filter processing has a larger calculation amount than the moving average processing, all signal components of a frequency equal to or higher than the fundamental frequency can be attenuated. Therefore, according to the measurement method, the estimation accuracy of the correction data can be improved by eliminating the influence of the vibration component equal to or higher than the fundamental frequency.

In the measurement method of the above aspect, in the high-pass filter processing step, the high-pass filter processing may be performed using a frequency lower than the fundamental frequency as a cutoff frequency.

According to the measurement method, the drift noise of a frequency lower than the fundamental frequency included in the velocity data can be reduced.

In the measurement method of the above aspect, the correction data estimation step may include: an interval specifying step of calculating a first peak and a fourth peak of the displacement data and a second peak and a third peak that are obtained by inverting a sign of the displacement data, and specifying a first interval before the first peak, a second interval between the first peak and the second peak, a third interval from the second peak to the third peak, a fourth interval between the third peak and the fourth peak, and a fifth interval after the fourth peak, a first interval correction data generation step of generating first interval correction data by inverting a sign of the displacement data in the first interval, a fifth interval correction data generation step of generating fifth interval correction data by inverting a sign of the displacement data in the fifth interval, a second interval correction data generation step of generating first line data passing through a point obtained by inverting a sign of an amplitude of the first peak and having a first-order coefficient that is a minimum value of data obtained by inverting a sign of the drift noise reduction data in the first interval, and generating second interval correction data which is the first line data in the second interval, a fourth interval correction data generation step of generating second line data passing through a point obtained by inverting a sign of an amplitude of the fourth peak and having a first-order coefficient that is a maximum value of data obtained by inverting a sign of the drift noise reduction data in the fifth interval, and generating fourth interval correction data which is the second line data in the fourth interval, a third interval correction data generation step of generating third interval correction data in the third interval, and a correction data generation step of generating the correction data by adding the first interval correction data, the second interval correction data, the third interval correction data, the fourth interval correction data, and the fifth interval correction data, and the third interval correction data generation step may include: generating third line data passing through a point having an amplitude that is a difference between an amplitude of the first line data and an amplitude of data obtained by inverting a sign of the displacement data at a time point of the second peak and a point having an amplitude that is a difference between an amplitude of the second line data and an amplitude of data obtained by inverting a sign of the displacement data at a time of the third peak, and generating the third interval correction data by adding data obtained by inverting a sign of the displacement data and the third line data in the third interval.

According to the measurement method, the five intervals can be specified based on a feature of the displacement data in which the drift noise and the vibration component are reduced, and more appropriate correction data can be generated in each interval, so that the estimation accuracy of the generated correction data can be improved. In particular, the first line data, the second line data, and the third line data can be obtained with high accuracy, so that the correction data with high accuracy can be generated in the second interval, the third interval, and the fourth interval.

The measurement method of the above aspect may further includes: a velocity data generation step of generating the velocity data by integrating the observation data when the observation data is acceleration data, generating the velocity data by differentiating the observation data when the observation data is displacement data, and setting the observation data as the velocity data when the observation data is velocity data.

In the measurement method of the above aspect, the high-pass filter processing may be processing of subtracting, from the velocity data, data obtained by performing moving average processing or FIR filter processing on the velocity data.

According to the measurement method, it is possible to easily perform high-pass filter processing, and in the moving average processing or the FIR filter processing, a group delay of each signal component included in the velocity data is constant, so that the correction data can be estimated with high accuracy.

In the measurement method of the above aspect, the velocity data may be data of a displacement velocity of the structure caused by a moving object that moves on the structure.

According to the measurement method, since the displacement data of the structure caused by the movement of the moving object is obtained as the measurement data in which the drift noise is reduced, the displacement of the structure can be measured with high accuracy.

In the measurement method of the above aspect, the structure may be a superstructure of a bridge.

According to the measurement method, it is possible to accurately measure a displacement of the superstructure of the bridge.

In the measurement method of the above aspect, a frequency of the drift noise may be lower than a minimum value of a natural vibration frequency of the superstructure.

According to the measurement method, by setting the cutoff frequency of the high-pass filter processing to be higher than the frequency of the drift noise of the superstructure and lower than the minimum value of the natural vibration frequency, the drift noise in the generated displacement data can be reduced without reducing the signal component and the harmonic component of the natural vibration frequency of the superstructure.

In the measurement method of the above aspect, the moving object may be a vehicle or a railway vehicle.

According to the measurement method, it is possible to accurately measure the displacement of the structure caused by movement of the vehicle or the railway vehicle.

In the measurement method of the above aspect, the observation data may be data observed by an acceleration sensor, a contact-type displacement meter, a ring-type displacement meter, a laser displacement meter, a pressure-sensitive sensor, an image processing-based displacement measurement device, an optical fiber-based displacement measurement device, or a velocity sensor.

According to the measurement method, it is possible to accurately measure the displacement of the structure using the data of an acceleration, a displacement, a stress change, or a velocity.

In the measurement method of the above aspect, the displacement data may include data of a waveform that projects in a positive direction or a negative direction.

According to the measurement method, since more appropriate correction data can be generated based on a feature of the waveform that projects in the positive direction or the negative direction, it is possible to improve the estimation accuracy of the generated correction data.

In the measurement method of the above aspect, the waveform may be a rectangular waveform, a trapezoidal waveform, or a sine half-wave waveform.

According to the measurement method, since more appropriate correction data can be generated based on a feature of the rectangular waveform, the trapezoidal waveform or the sine half-wave waveform, it is possible to improve the estimation accuracy of the generated correction data.

According to an aspect of the present disclosure, a measurement device includes: a high-pass filter processing unit configured to perform high-pass filter processing on observation data-based velocity data including a drift noise to generate drift noise reduction data in which the drift noise is reduced; a displacement data generation unit configured to generate displacement data by integrating the drift noise reduction data; a correction data estimation unit configured to estimate, based on the displacement data, correction data corresponding to a difference between the displacement data and data obtained by removing the drift noise from data obtained by integrating the velocity data; and a measurement data generation unit configured to generate measurement data by adding the displacement data and the correction data.

The measurement device generates the drift noise reduction data, in which the drift noise is reduced, using the velocity data, and estimates the correction data based on the displacement data obtained by integrating the drift noise reduction data. Further, since the correction data corresponds to the difference between the displacement data and the data obtained by removing the drift noise from the data obtained by integrating the velocity data, the correction data includes a significant signal component removed by the high-pass filter processing. Therefore, according to the measurement device, the measurement data in which the drift noise is reduced can be generated by adding the displacement data and the correction data. According to the measurement device, by generating the displacement data and the correction data using the velocity data to be processed, and adding the displacement data and the correction data, the measurement data in which the drift noise is reduced can be generated without preparing information for reducing the drift noise in advance. Therefore, by using the measurement device, accurate measurement data can be obtained regardless of a change in environment, and cost reduction can be achieved.

In the measurement device, the displacement data is generated by performing high-pass filter processing on the velocity data and then integrating the velocity data instead of being generated by integrating the velocity data and then performing high-pass filter processing on the velocity data. Since the drift noise in the velocity data has a variation amount smaller than that of the drift noise in the data obtained by integrating the velocity data, the drift noise is more likely to be sufficiently reduced when the displacement data is generated by performing high-pass filter processing on the velocity data and then integrating the velocity data as compared with when the displacement data is generated by integrating the velocity data and then performing high-pass filter processing on the velocity data. Therefore, according to the measurement device, accurate correction data can be generated based on the displacement data in which the drift noise is sufficiently reduced.

According to an aspect of the present disclosure, a measurement system includes: the measurement device according to the above aspect; and an observation device configured to observe an observation point, and the observation data is data observed by the observation device.

According to an aspect of the present disclosure, a non-transitory computer-readable storage medium stores a measurement program, and the measurement program causes a computer to execute: a high-pass filter processing step of performing high-pass filter processing on observation data-based velocity data including a drift noise to generate drift noise reduction data in which the drift noise is reduced; a displacement data generation step of generating displacement data by integrating the drift noise reduction data; a correction data estimation step of estimating, based on the displacement data, correction data corresponding to a difference between the displacement data and data obtained by removing the drift noise from data obtained by integrating the velocity data; and a measurement data generation step of generating measurement data by adding the displacement data and the correction data.

In the measurement program, the drift noise reduction data in which the drift noise is reduced is generated using the velocity data, and the correction data is estimated based on the displacement data obtained by integrating the drift noise reduction data. Further, since the correction data corresponds to the difference between the displacement data and the data obtained by removing the drift noise from the data obtained by integrating the velocity data, the correction data includes a significant signal component removed by the high-pass filter processing. Therefore, according to the measurement program, the measurement data in which the drift noise is reduced can be generated by adding the displacement data and the correction data. According to the measurement program, by generating the displacement data and the correction data using the velocity data to be processed, and adding the displacement data and the correction data, the measurement data in which the drift noise is reduced can be generated without preparing information for reducing the drift noise in advance. Therefore, by using the measurement program, accurate measurement data can be obtained regardless of a change in environment, and cost reduction can be achieved.

In the measurement program, the displacement data is generated by performing high-pass filter processing on the velocity data and then integrating the velocity data instead of being generated by integrating the velocity data and then performing high-pass filter processing on the velocity data. Since the drift noise in the velocity data has a variation amount smaller than that of the drift noise in the data obtained by integrating the velocity data, the drift noise is more likely to be sufficiently reduced when the displacement data is generated by performing high-pass filter processing on the velocity data and then integrating the velocity data as compared with when the displacement data is generated by integrating the velocity data and then performing high-pass filter processing on the velocity data. Therefore, according to the measurement program, accurate correction data can be generated based on the displacement data in which the drift noise is sufficiently reduced.

What is claimed is:

1. A measurement method, comprising:
a high-pass filter processing step of performing high-pass filter processing on observation data-based velocity data including a drift noise to generate drift noise reduction data in which the drift noise is reduced;
a displacement data generation step of generating displacement data by integrating the drift noise reduction data;
a correction data estimation step of estimating, based on the displacement data, correction data corresponding to a difference between the displacement data and data obtained by removing the drift noise from data obtained by integrating the velocity data; and
a measurement data generation step of generating measurement data by adding the displacement data and the correction data.

2. The measurement method according to claim 1, wherein
in the high-pass filter processing step,
fast Fourier transform processing is performed on the velocity data to calculate a fundamental frequency, and the high-pass filter processing is performed by using a frequency lower than the fundamental frequency as a cutoff frequency.

3. The measurement method according to claim 1, wherein
the correction data estimation step includes:
an interval specifying step of calculating a first peak, a second peak, a third peak, and a fourth peak of the displacement data, and specifying a first interval before the first peak, a second interval between the first peak and the second peak, a third interval from the second peak to the third peak, a fourth interval between the third peak and the fourth peak, and a fifth interval after the fourth peak,
a first interval correction data generation step of generating first interval correction data by inverting a sign of the displacement data in the first interval,
a fifth interval correction data generation step of generating fifth interval correction data by inverting a sign of the displacement data in the fifth interval,
a second interval correction data generation step of generating first line data which passes through a point obtained by inverting a sign of an amplitude of the first peak and which has a first-order coefficient that is the same as that of a line approximating the first interval correction data smaller than a product of a coefficient and a value obtained by inverting the sign of the amplitude of the first peak, and generating second interval correction data which is the first line data in the second interval,
a fourth interval correction data generation step of generating second line data which passes through a point obtained by inverting a sign of an amplitude of the fourth peak and which has a first-order coefficient that is the same as that of a line approximating the fifth interval correction data smaller than a product of a coefficient and a value obtained by inverting the sign of the amplitude of the fourth peak, and generating fourth interval correction data which is the second line data in the fourth interval,
a third interval correction data generation step of generating third interval correction data in the third interval, and
a correction data generation step of generating the correction data by adding the first interval correction data, the second interval correction data, the third interval correction data, the fourth interval correction data, and the fifth interval correction data, and
the third interval correction data generation step includes:
generating third line data passing through a point having an amplitude that is a sum of an amplitude of the first line data and an amplitude of the displacement data at a time point of the second peak and a point having an amplitude that is a sum of an amplitude of the second line data and an amplitude of the displacement data at a time point of the third peak,
calculating a first intersection point between the first line data and the third line data and a second intersection point between the third line data and the second line data, and
generating the third interval correction data in the third interval by using data before the first intersection point as the first line data, data from the first intersection point to the second intersection point as the third line data, and data after the second intersection point as the second line data.

4. A measurement method comprising:
a low-pass filter processing step of performing low-pass filter processing on observation data-based velocity data including a drift noise and a vibration component to generate vibration component reduction data in which the vibration component is reduced;
a high-pass filter processing step of performing high-pass filter processing on the vibration component reduction data to generate drift noise reduction data in which the drift noise is reduced;
a displacement data generation step of generating displacement data by integrating the drift noise reduction data;
a correction data estimation step of estimating, based on the displacement data, correction data corresponding to a difference between the displacement data and data obtained by removing the drift noise from data obtained by integrating the vibration component reduction data;
a vibration velocity component data generation step of generating vibration velocity component data by subtracting the vibration component reduction data from the velocity data;
a vibration displacement component data generation step of generating vibration displacement component data by integrating the vibration velocity component data; and
a measurement data generation step of generating measurement data by adding the displacement data, the correction data, and the vibration displacement component data.

5. The measurement method according to claim 4, wherein
in the low-pass filter processing step,
a fundamental frequency is calculated by performing fast Fourier transform processing on the velocity data, and the vibration component reduction data is generated by performing, as the low-pass filter processing, moving average processing on the velocity data at a cycle corresponding to the fundamental frequency.

6. The measurement method according to claim 4, wherein
in the low-pass filter processing step,
a fundamental frequency is calculated by performing fast Fourier transform processing on the velocity data, and the vibration component reduction data is generated by performing, as the low-pass filter processing, FIR filter processing for attenuating a signal component of a frequency equal to or higher than the fundamental frequency on the velocity data.

7. The measurement method according to claim 5, wherein
in the high-pass filter processing step,
the high-pass filter processing is performed using a frequency lower than the fundamental frequency as a cutoff frequency.

8. The measurement method according to claim 4, wherein
the correction data estimation step includes:
an interval specifying step of calculating a first peak and a fourth peak of the displacement data and a second peak and a third peak that are obtained by inverting a sign of the displacement data, and specifying a first interval before the first peak, a second interval between the first peak and the second peak, a third interval from the second peak to the third peak, a fourth interval between the third peak and the fourth peak, and a fifth interval after the fourth peak,
a first interval correction data generation step of generating first interval correction data by inverting a sign of the displacement data in the first interval,
a fifth interval correction data generation step of generating fifth interval correction data by inverting a sign of the displacement data in the fifth interval,
a second interval correction data generation step of generating first line data passing through a point obtained by inverting a sign of an amplitude of the first peak and having a first-order coefficient that is a minimum value of data obtained by inverting a sign of the drift noise reduction data in the first interval, and generating second interval correction data which is the first line data in the second interval,
a fourth interval correction data generation step of generating second line data passing through a point obtained by inverting a sign of an amplitude of the fourth peak and having a first-order coefficient that is a maximum value of data obtained by inverting a sign of the drift noise reduction data in the fifth interval, and generating fourth interval correction data which is the second line data in the fourth interval,
a third interval correction data generation step of generating third interval correction data in the third interval, and
a correction data generation step of generating the correction data by adding the first interval correction data, the second interval correction data, the third interval correction data, the fourth interval correction data, and the fifth interval correction data, and
the third interval correction data generation step includes:
generating third line data passing through a point having an amplitude that is a difference between an amplitude of the first line data and an amplitude of data obtained by inverting a sign of the displacement data at a time point of the second peak and a point having an amplitude that is a difference between an amplitude of the second line data and an amplitude of data obtained by inverting a sign of the displacement data at a time of the third peak, and
generating the third interval correction data by adding data obtained by inverting a sign of the displacement data and the third line data in the third interval.

9. The measurement method according to claim 1 further comprising:
a velocity data generation step of generating the velocity data by integrating the observation data when the observation data is acceleration data, generating the velocity data by differentiating the observation data when the observation data is displacement data, and setting the observation data as the velocity data when the observation data is velocity data.

10. The measurement method according to claim 1, wherein
the high-pass filter processing is processing of subtracting, from the velocity data, data obtained by performing moving average processing or FIR filter processing on the velocity data.

11. The measurement method according to claim 1, wherein
the velocity data is data of a displacement velocity of a structure caused by a moving object that moves on the structure.

12. The measurement method according to claim 11, wherein
the structure is a superstructure of a bridge.

13. The measurement method according to claim 12, wherein
a frequency of the drift noise is lower than a minimum value of a natural vibration frequency of the superstructure.

14. The measurement method according to claim 11, wherein
the moving object is a vehicle or a railway vehicle.

15. The measurement method according to claim 1, wherein
the observation data is data observed by an acceleration sensor, a contact-type displacement meter, a ring-type displacement meter, a laser displacement meter, a pressure-sensitive sensor, an image processing-based displacement measurement device, an optical fiber-based displacement measurement device, or a velocity sensor.

16. The measurement method according to claim 1, wherein
the displacement data includes data of a waveform that projects in a positive direction or a negative direction.

17. The measurement method according to claim 16, wherein
the waveform is a rectangular waveform, a trapezoidal waveform, or a sine half-wave waveform.

18. A measurement device, comprising:
a high-pass filter processing unit configured to perform high-pass filter processing on observation data-based velocity data including a drift noise to generate drift noise reduction data in which the drift noise is reduced;
a displacement data generation unit configured to generate displacement data by integrating the drift noise reduction data;
a correction data estimation unit configured to estimate, based on the displacement data, correction data corresponding to a difference between the displacement data and data obtained by removing the drift noise from data obtained by integrating the velocity data; and
a measurement data generation unit configured to generate measurement data by adding the displacement data and the correction data.

19. A measurement system, comprising:
the measurement device according to claim 18; and
an observation device configured to observe an observation point, wherein
the observation data is data observed by the observation device.

20. A non-transitory computer-readable storage medium storing a measurement program, the measurement program causing a computer to execute:
a high-pass filter processing step of performing high-pass filter processing on observation data-based velocity data including a drift noise to generate drift noise reduction data in which the drift noise is reduced;
a displacement data generation step of generating displacement data by integrating the drift noise reduction data;
a correction data estimation step of estimating, based on the displacement data, correction data corresponding to a difference between the displacement data and data obtained by removing the drift noise from data obtained by integrating the velocity data; and
a measurement data generation step of generating measurement data by adding the displacement data and the correction data.
